(19) United States
(12) Patent Application Publication
(10) Pub. No.: US 2026/0243398 A1
(43) Pub. Date: Aug. 20, 2026

(54) LASER-PHOSPHOR ENGINE WITH ROTATING CONVERTER

(71) Applicant: SIGNIFY HOLDING B.V., EINDHOVEN (NL)

(72) Inventors: CHRISTOPH GERARD AUGUST HOELEN, VALKENSWAARD (NL); HUGO JOHAN CORNELISSEN, ESCHAREN (NL)

(21) Appl. No.: 19/472,159

(22) PCT Filed: Mar. 25, 2024
(86) PCT No.: PCT/EP2024/057934

§ 371 Date: Oct. 3, 2025

(30) Foreign Application Priority Data
Apr. 4, 2023 (EP) 23166470.7

(51) Int. Cl. F21K 9/64; F21K 9/65; F21V 7/05; F21V 9/08; F21V 9/14; F21V 9/20; F21V 9/40; F21Y 115/10; F21Y 115/30

(52) U.S. Cl. CPC F21K 9/64; F21K 9/65; F21V 7/05; F21V 9/08; F21V 9/14; F21V 9/20; F21V 9/40; F21Y 2115/10; F21Y 2115/30

(57) ABSTRACT

The invention may provide a light generating system (1000) comprising (i) one or more light generating devices (100), (ii) a first luminescent material (210), (iii) a reflector (2510), (iv) a rotatable element (1200), (v) and a control system (300); wherein: the one or more light generating devices (100) are configured to generate device light (101); wherein the one or more light generating devices (100) comprise one or more of a laser diode and a superluminescent diode; the first luminescent material (210) is configured to convert at least part of the device light (101) received by the first luminescent material (210) into first luminescent material light (211); the reflector (2510) is configured to reflect at least part of the device light (101) received by the reflector (2510) into reflected device light (711); the rotatable element (1200) comprises a first ring-shaped section (2131), and a second a ring-shaped section (2132); the first luminescent material (210) is comprised by at least part of the first ring-shaped section (2131); and the reflector (2510) is comprised by at least part of the second ring-shaped section (2132); the light generating system (1000) is configured such that (a) in an operational mode of the light generating system (1000) the rotatable element (1200) rotates, such that over time different parts of the first ring-shaped section (2131) and/or different parts of the second ring-shaped section (2132) are irradiated by the device light (101), and (b) a distribution of the device light (101) over the first ring-shaped section (2131) and the second ring-shaped section (2132) is optically and/or mechanically controllable; and wherein the light generating system (1000) is configured to generate system light (1001) comprising one or more of the first luminescent material light (211) and the reflected device light (711); and the control system (300) is configured to control a spectral power distribution of the system light (1001) by optically and/or mechanically controlling the distribution of the device light (101) over the first ring-shaped section (2131) and the second ring-shaped section (2132).

### FIELD OF THE INVENTION

The invention relates to a light generating system. The invention further relates to a lighting device comprising such light generating system.

### BACKGROUND OF THE INVENTION

Laser-phosphor based stage lighting engines are known in the art. For instance, WO2022143318 describes a light emitting device, comprising a first light source, a second light source, a dichroic mirror, a wavelength conversion apparatus, a first light path adjusting apparatus or a second light path adjusting apparatus, and a first scattering optical system. The light mixing effect of emergent light can be improved by using the first scattering optical system. Light emitted by the first light source is all used for exciting the wavelength conversion apparatus.

US2011/149549A1 discloses a semiconductor light source apparatus that includes a radiating substrate, at least one phosphor layer disposed on the radiating substrate and a semiconductor light source. The at least one phosphor layer can include at least one of a red phosphor, a green phosphor and a blue phosphor. The light source can be located adjacent the phosphor layer so that light having high brightness emitted from the light source can be efficiently reflected on the radiating substrate via the at least one phosphor layer, that may have a cutout section, for emitting various color lights having high brightness.

US2013/021582A1 discloses an illuminating device for emitting light onto a light modulating element that forms an image in accordance with a modulation signal and irradiates a target to be illuminated with light, the illuminating device includes a substrate on which equal to or more than two phosphors that emit light with exciting light are formed in a band-like form along a predetermined direction, equal to or more than two light collecting units that are arranged for the respective equal to or more than two phosphors, and collect light components emitted from the respective equal to or more than two phosphors, and a driving unit that drives the substrate in the predetermined direction.

### SUMMARY OF THE INVENTION

High brightness light sources can be used in various applications including spots, stage-lighting, headlamps, home and office lighting, and automotive lighting. For this purpose, laser-phosphor technology can be used, wherein a laser may provide laser light and a remote phosphor converts laser light into converted light. A problem with high intensity light sources in combination with the application of luminescent materials may be the thermal stability and/or the temperature dependence of the luminescence of the luminescent material. Yet, it appears desirable to provide such tunable lighting device which is able to provide the light with a high intensity. Further, there is a desire for color tunable lighting devices and/or lighting devices.

Hence, it is an aspect of the invention to provide an alternative light generating system, which preferably further at least partly obviates one or more of above-described drawbacks. The present invention may have as an objective to overcome or ameliorate at least one of the disadvantages of the prior art, or to provide a useful alternative.

According to a first aspect, the invention may provide a light generating system (“system”) comprising (i) one or more light generating devices, (ii) a first luminescent material, (iii) a reflector (“reflective element”), (iv) a rotatable element, (v) and a control system. In embodiments, the one or more light generating devices may be configured to generate device light. Especially, in embodiments the one or more light generating devices may comprise one or more of a laser diode and a superluminescent diode. Yet, in embodiments the first luminescent material may be configured to convert at least part of the device light received by the first luminescent material into first luminescent material light. Especially, in embodiments the reflector may be configured to reflect at least part of the device light received by the reflector into reflected device light. Further, in embodiments the rotatable element may comprise a first ring-shaped section and/or a second a ring-shaped section. In specific embodiments, the first luminescent material may be comprised by at least part of the first ring-shaped section. Alternatively or additionally, in embodiments the reflector may be comprised by at least part of the second ring-shaped section. Further, in embodiments the light generating system may be configured such that (a) in an operational mode of the light generating system the rotatable element may rotate, such that over time different parts of the first ring-shaped section and/or different parts of the second ring-shaped section are irradiated by the device light. Alternatively or additionally, in embodiments the light generating system may be configured such that (b) a distribution of the device light over the first ring-shaped section and the second ring-shaped section may be optically (and/or mechanically) controllable. Yet, in embodiments the light generating system may be configured to generate system light comprising one or more of the first luminescent material light and the reflected device light. Further, in embodiments the control system may be configured to control a spectral power distribution of the system light by optically and/or mechanically controlling the distribution of the device light over the first ring-shaped section and the second ring-shaped section. Therefore, in embodiments the invention provides a light generating system comprising (i) one or more light generating devices, (ii) a first luminescent material, (iii) a reflector, (iv) a rotatable element, (v) and a control system; wherein: (A) the one or more light generating devices are configured to generate device light; wherein the one or more light generating devices comprise one or more of a laser diode and a superluminescent diode; (B) the first luminescent material is configured to convert at least part of the device light received by the first luminescent material into first luminescent material light; the reflector is configured to reflect at least part of the device light received by the reflector into reflected device light; (C) the rotatable element comprises a first ring-shaped section, and a second a ring-shaped section; the first luminescent material is comprised by at least part of the first ring-shaped section; and the reflector is comprised by at least part of the second ring-shaped section; (D) the light generating system is configured such that (a) in an operational mode of the light generating system the rotatable element rotates, such that over time different parts of the first ring-shaped section and/or different parts of the second ring-shaped section are irradiated by the device light, and (b) a distribution of the device light over the first ring-shaped section and the second ring-shaped section is optically (and/or mechanically) controllable; and wherein the light generating system is configured to generate system light comprising one or more of the first luminescent material light and the reflected device light; and (E) the control system is configured to control a spectral power distribution of the system light by optically and/or mechanically controlling the distribution of the device light over the first ring-shaped section and the second ring-shaped section.

With such system, a high power light generating system may be provided. Further, such system may allow control of spectral power distribution of the system light (of a high power system). Yet, such system may in a safe way provide high power light. The system may be relatively compact. Yet, thermal management of the luminescent material may also be provided with this system. In addition to high optical power, the system may also provide high radiance (or luminance), i.e., a high optical power density of the source. The system may be more fail-safe thanks to the reflective configuration for both the luminescent light and the diffused light, by which it can be prevented that direct laser beams emit from the system in case the luminescent component or the diffusing component would fail (e.g. break, fall off, etc.).

As indicated above, the light generating system may in embodiments comprise one or more light generating devices, (ii) a first luminescent material, (iii) a reflector, (iv) a rotatable element, (v) and a control system. Embodiments thereof will further elucidated below.

The light generating system may comprise one or more light generating devices. Especially, the one or more light generating devices may be configured to generate polarized device light having a controllable polarization and having a device light spectral power distribution. As will be further elucidated below, the controllable polarization may be obtained by one or more of (a) a controllable polarizer, and (b) two or more light generating devices configured to generate device light having different polarizations, respectively. Further, the spectral power distribution of the device light, indicates as “device light spectral power distribution” may in embodiments especially be in the blue wavelength range, see also below. The phrase “device light spectral power distribution”, and similar phrases, may indicate the spectral power distribution of the device light. Yet, as further described below, in embodiments the one or more light generating devices comprise one or more solid state light sources. More especially, the one or more light generating devices may comprise one or more of a laser diode and a superluminescent diode. Hence, the light generating device may comprise one or more laser diodes and/or one or more superluminescent diodes. Here below, some general aspects in relation to the one or more light generating devices is described.

A light generating device may especially be configured to generate device light. Especially, the light generating device may comprise a light source. The light source may especially configured to generate light source light. In embodiments, the device light may essentially consist of the light source light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In (other) specific embodiments, the term “light generating device” may also refer to a plurality of light generating devices which may provide device light having different spectral power distributions. The term “light source” may in principle relate to any light source known in the art. In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chip-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The term “light source” may also refer to a chip scaled package (CSP). A CSP may comprise a single solid state die with provided thereon a luminescent material comprising layer. The term “light source” may also refer to a midpower package. A midpower package may comprise one or more solid state die(s). The die(s) may be covered by a luminescent material comprising layer. The die dimensions may be equal to or smaller than 2 mm, such as in the range of e.g. 0.2-2 mm. Hence, in embodiments the light source comprises a solid state light source. Further, in specific embodiments, the light source comprises a chip scale packaged LED. Herein, the term “light source” may also especially refer to a small solid state light source, such as having a mini size or micro size. For instance, the light sources may comprise one or more of mini LEDs and micro LEDs. Especially, in embodiment the light sources comprise micro LEDs or “microLEDs” or “μLEDs”. Herein, the term mini size or mini LED especially indicates to solid state light sources having dimensions, such as die dimension, especially length and width, selected from the range of 100 μm-1 mm. Herein, the term p size or micro LED especially indicates to solid state light sources having dimensions, such as die dimension, especially length and width, selected from the range of 100 μm and smaller.

The light source may have a light escape surface. Referring to conventional light sources such as light bulbs or fluorescent lamps, it may be an outer surface of a glass or a quartz envelope. For LED's it may for instance be the LED die, or when a resin may be applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

A position where system light escapes from the light generating system may also be indicated as light exit. This may be a light transmissive window or an opening (in the system). The light transmissive window may in embodiments be provided by an optical component.

The term “light source” may refer to a semiconductor light-emitting device, such as a light emitting diode (LEDs), a laser diode, a resonant cavity light emitting diode (RCLED), a vertical cavity laser diode (VCSELs), an edge emitting laser (EEL), a photonic crystal surface emitting laser (PCSEL), a vertical external cavity surface emitting laser (VECSEL), etc. . . . . The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED). The term LED may also refer to a plurality of LEDs. The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs. In other embodiments, however, the light source may be configured to provide primary radiation and part of the primary radiation may be converted into secondary radiation. Secondary radiation may be based on conversion by a luminescent material. The secondary radiation may therefore also be indicated as luminescent material radiation. The luminescent material may in embodiments be comprised by the light source, such as an LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as an LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be converted by the luminescent material. In embodiments, the light generating device may (thus) comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers. The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device). The term “light source” herein may also refer to a light source comprising a solid state light source, such as an LED or a laser diode or a superluminescent diode. The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a laser diode, or a superluminescent diode. The term “laser light source” especially refers to a laser. Such laser may especially be configured to generate laser light source light having one or more wavelengths in the UV, visible, or infrared, especially having a wavelength selected from the spectral wavelength range of 200-2000 nm, such as 300-1500 nm. The term “laser” especially refers to a device that emits light through a process of optical amplification based on the stimulated emission of electromagnetic radiation. Especially, in embodiments the term “laser” may refer to a solid-state laser. In specific embodiments, the terms “laser” or “laser light source”, or similar terms, refer to a laser diode (or diode laser).

Hence, in embodiments the light source comprises a laser light source. In embodiments, the terms “laser” or “solid state laser” or “solid state material laser” may refer to one or more of cerium doped lithium strontium (or calcium) aluminum fluoride (Ce:LiSAF, Ce:LiCAF), chromium doped chrysoberyl (alexandrite) laser, chromium ZnSe (Cr:ZnSe) laser, divalent samarium doped calcium fluoride (Sm:CaF₂) laser, Er:YAG laser, erbium doped and erbium-ytterbium codoped glass lasers, F-Center laser, holmium YAG (Ho:YAG) laser, Nd:YAG laser, NdCrYAG laser, neodymium doped yttrium calcium oxoborate Nd:YCa₄O(BO₃)₃ or Nd:YCOB, neodymium doped yttrium orthovanadate (Nd:YVO₄) laser, neodymium glass (Nd:glass) laser, neodymium YLF (Nd:YLF) solid-state laser, promethium 147 doped phosphate glass (147Pm³⁺:glass) solid-state laser, ruby laser (Al₂O₃:Cr³⁺), thulium YAG (Tm:YAG) laser, titanium sapphire (Ti:sapphire; Al₂O₃:Ti³⁺) laser, trivalent uranium doped calcium fluoride (U:CaF₂) solid-state laser, Ytterbium doped glass laser (rod, plate/chip, and fiber), Ytterbium YAG (Yb:YAG) laser, Yb₂O₃ (glass or ceramics) laser, etc. For instance, including second and third harmonic generation embodiments, the light source may comprise one or more of an F center laser, an yttrium orthovanadate (Nd:YVO₄) laser, a promethium 147 doped phosphate glass (147Pm³⁺:glass), and a titanium sapphire (Ti:sapphire; Al₂O₃:Ti³⁺) laser. For instance, considering second and third harmonic generation, such light sources may be used to generated blue light. In embodiments, the terms “laser” or “solid state laser” or “solid state material laser” may refer to one or more of a semiconductor laser diodes, such as GaN, InGaN, AlGaInP, AlGaAs, InGaAsP, lead salt, vertical cavity surface emitting laser (VCSEL), quantum cascade laser, hybrid silicon laser, etc. A laser may be combined with an upconverter in order to arrive at shorter (laser) wavelengths. For instance, with some (trivalent) rare earth ions upconversion may be obtained or with non-linear crystals upconversion can be obtained. Alternatively, a laser can be combined with a downconverter, such as a dye laser, to arrive at longer (laser) wavelengths.

As can be derived from the below, the term “laser light source” may also refer to a plurality of (different or identical) laser light sources. In specific embodiments, the term “laser light source” may refer to a plurality N of (identical) laser light sources. In embodiments, N=2, or more. In specific embodiments, N may be at least 5, such as especially at least 8. In this way, a higher brightness may be obtained. In embodiments, laser light sources may be arranged in a laser bank (see also above). The laser bank may in embodiments comprise heat sinking and/or optics e.g. a lens to collimate the laser light. Hence, in embodiments lasers in a laser bank (or “laser array bank”) may share the same optics.

The laser light source is configured to generate laser light source light (or “laser light”). The light source light may essentially consist of the laser light source light. The light source light may also comprise laser light source light of two or more (different or identical) laser light sources. For instance, the laser light source light of two or more (different or identical) laser light sources may be coupled into a light guide, to provide a single beam of light comprising the laser light source light of the two or more (different or identical) laser light sources. In specific embodiments, the light source light is thus especially collimated light source light. In yet further embodiments, the light source light is especially (collimated) laser light source light. The laser light source light may in embodiments comprise one or more bands, having band widths as known for lasers. In specific embodiments, the band(s) may be relatively sharp line(s), such as having full width half maximum (FWHM) in the range of less than 20 nm at RT, such as equal to or less than 10 nm. Hence, the light source light has a spectral power distribution (intensity on an energy scale as function of the wavelength) which may comprise one or more (narrow) bands.

The beams (of light source light) may be focused or collimated beams of (laser) light source light. The term “focused” may especially refer to converging to a small spot. This small spot may be at the discrete converter region, or (slightly) upstream thereof or (slightly) downstream thereof. Especially, focusing and/or collimation may be such that the cross-sectional shape (perpendicular to the optical axis) of the beam at the discrete converter region (at the side face) is essentially not larger than the cross-section shape (perpendicular to the optical axis) of the discrete converter region (where the light source light irradiates the discrete converter region). Focusing may be executed with one or more optics, like (focusing) lenses. Especially, two lenses may be applied to focus the laser light source light. Collimation may be executed with one or more (other) optics, like collimation elements, such as lenses and/or parabolic mirrors. In embodiments, the beam of (laser) light source light may be relatively highly collimated, such as in embodiments ≤2° (FWHM), more especially ≤1 (FWHM), most especially ≤0.5° (FWHM). Hence, ≤2° (FWHM) may be considered (highly) collimated light source light. Optics may be used to provide (high) collimation (see also above).

The term “solid state material laser”, and similar terms, may refer to a solid state laser like based on a crystalline or glass body dopes with ions, like transition metal ions and/or lanthanide ions, to a fiber laser, to a photonic crystal laser, to a semiconductor laser, such as e.g. a vertical cavity surface-emitting laser (VCSEL), etc. The term “solid state light source”, and similar terms, may especially refer to semiconductor light sources, such as a light emitting diode (LED), a laser diode, or a superluminescent diode.

Instead of the term “solid state light source” also the term “semiconductor-based light source” may be applied. Hence, the term “semiconductor-based light source” may e.g. refer to one or more of a light emitting diode (LED), a laser diode, and a superluminescent diode. Hence, the light generating device may comprise one or more of a light emitting diode (LED), a laser diode, and a superluminescent diode.

A light-emitting diode (LED) is especially a semiconductor light source that emits light when current flows through it. Electrons in the semiconductor may recombine with electron holes, releasing energy in the form of photons. The color of the light (corresponding to the energy of the photons) may be determined by the energy required for electrons to cross the band gap of the semiconductor. A laser diode (or diode laser) may be a semiconductor device substantially similar to a light-emitting diode in which a diode pumped directly with electrical current can create lasing conditions at the diode's junction. This is known to a person skilled in the art.

Superluminescent diodes are known in the art. A superluminescent diode may be indicated as a semiconductor device which may be able to emit low-coherence light of a broad spectrum like an LED, while having a brightness in the order of a laser diode. US2020192017 indicates for instance that “With current technology, a single SLED is capable of emitting over a bandwidth of for example, at most 50-70 nm in the 800-900 nm wavelength range with sufficient spectral flatness and sufficient output power. In the visible range used for display applications, i.e. in the 450-650 nm wavelength range, a single SLED is capable of emitting over bandwidth of at most 10-30 nm with current technology. Those emission bandwidths are too small for a display or projector application which requires red (640 nm), green (520 nm) and blue (450 nm), i.e. RGB, emission”. Further, superluminescent diodes are amongst others described, in “Edge Emitting Laser Diodes and Superluminescent Diodes”, Szymon Stanczyk, Anna Kafar, Dario Schiavon, Stephen Najda, Thomas Slight, Piotr Perlin, Book Editor(s): Fabrizio Roccaforte, Mike Leszczynski, First published: 3 Aug. 2020 https://doi.org/10.1002/9783527825264.ch9 in chapter 9.3 superluminescent diodes. This book, and especially chapter 9.3, are herein incorporated by reference. Amongst others, it is indicated therein that the superluminescent diode (SLD) is an emitter, which combines the features of laser diodes and light-emitting diodes. SLD emitters utilize the stimulated emission, which means that these devices operate at current densities similar to those of laser diodes. The main difference between LDs and SLDs is that in the latter case, the device waveguide may be designed in a special way preventing the formation of a standing wave and lasing. Still, the presence of the waveguide ensures the emission of a high-quality light beam with high spatial coherence of the light, but the light is characterized by low time coherence at the same time” and “Currently, the most successful designs of nitride SLD are bent, curved, or tilted waveguide geometries as well as tilted facet geometries, whereas in all cases, the front end of the waveguide meets the device facet in an inclined way, as shown in FIG. 9.10. The inclined waveguide suppresses the reflection of light from the facet to the waveguide by directing it outside to the lossy unpumped area of the device chip”. Hence, an SLD may especially be a semiconductor light source, where the spontaneous emission light is amplified by stimulated emission in the active region of the device. Such emission is called “super luminescence”. Superluminescent diodes combine the high power and brightness of laser diodes with the low coherence of conventional light-emitting diodes. The low (temporal) coherence of the source has advantages that the speckle is significantly reduced or not visible, and the spectral distribution of emission is much broader compared to laser diodes, which can be better suited for lighting applications. Especially, with varying electrical current, the spectral power distribution of the superluminescent diode may vary. In this way the spectral power distribution can be controlled, see e.g. also Abdullah A. Alatawi, et al., Optics Express Vol. 26, Issue 20, pp. 26355-26364, https://doi.org/10.1364/OE.26.026355. Hence, a superluminescent diode may be indicated as a semiconductor device which may be able to emit low-coherence light of a broad spectrum like a LED, while having a brightness in the order of a laser diode. Superluminescent diodes may combine the high power and brightness of laser diodes with the low coherence of conventional light-emitting diodes. The low (temporal) coherence of the source has advantages that the speckle is significantly reduced or not visible, and the spectral distribution of emission is much broader compared to laser diodes, which can be better suited for lighting applications. Hence, in embodiments, the solid state light source may comprise a superluminescent diode. For instance, in further specific embodiments, the solid state light source may comprise a GaN-based superluminescent diode, or an InGaN-based superluminescent diode, or an AlGaN-based superluminescent diode.

Especially, in embodiments the light generating device is configured to generate device light. In specific embodiments, the device light may be blue light. The terms “blue light” or “blue emission”, and similar terms, may especially relate to light having a wavelength in the range of about 440-490 nm (including some violet and cyan hues). However, intensity at shorter wavelengths may also be possible, such as within the wavelength range of 400-440 nm. In specific embodiments, the device light may have a centroid wavelength (λ_{c1}) selected from the 400-490 nm wavelength range, more especially from the 400-480 nm wavelength range. Especially, in embodiments the device light has a peak wavelength selected from the blue wavelength range.

In embodiments, the light generating device comprises a light source selected from a laser diode and a superluminescent diode. Hence, especially the light generating device comprises a solid state light source. More especially, the device light is laser light.

Further, the light generating system may comprise one or more luminescent materials. Especially, the light generating system comprises a first luminescent material. The term “first luminescent material” may also refer to a plurality of first luminescent materials (see also below). Optionally, the light generating system may also comprise a second luminescent material. The term “second luminescent material” may also refer to a plurality of second luminescent materials (see also below). Embodiments of luminescent materials are described below.

The phrase “ . . . light received by . . . ”, and similar phrases, such as “device light received by the first luminescent material” may especially indicate that when the light is actually received by an item, an action may take place. Whether the light is received by the item, may e.g. depend upon the operational mode of the system. For instance, dependent upon the polarization of the light and/or the spectral power distribution of the light, the light may be irradiate the item, upon which the action may take place. The action may in embodiments be one or more of conversion, reflection, and transmission.

Hence, the action may also include refraction. The phrase “to convert at least part of the device light received by the first luminescent material into first luminescent material light”, and similar phrases, may thus indicate that when at least part of device light indeed irradiates the first luminescent material (in an operational mode of the light generating system), then at least part of that device light may be converted into first luminescent material light. Whether the device light may reach the first luminescent material may depend upon the polarization of the device light. Likewise, this may apply to other luminescent materials.

Especially, the first luminescent material may be operated in the reflective mode, though a transmissive mode may also be possible (see further also below).

The first luminescent material light may have a spectral power distribution with at least intensity in the visible wavelength range, see further also below.

Here below, some general aspects in relation to luminescent materials are described, which may apply to both the first luminescent material and the second luminescent material (see further below), but also to other (optional) luminescent materials (if any).

The term “luminescent material” especially refers to a material that can convert first radiation, especially one or more of UV radiation and blue radiation, into second radiation. In general, the first radiation and second radiation have different spectral power distributions. Hence, instead of the term “luminescent material”, also the terms “luminescent converter” or “converter” may be applied. In general, the second radiation has a spectral power distribution at larger wavelengths than the first radiation, which is the case in the so-called down-conversion. In specific embodiments, however the second radiation has a spectral power distribution with intensity at smaller wavelengths than the first radiation, which is the case in the so-called up-conversion. In embodiments, the “luminescent material” may especially refer to a material that can convert radiation into e.g. visible and/or infrared light. For instance, in embodiments the luminescent material may be able to convert one or more of UV radiation and blue radiation, into visible light. The luminescent material may in specific embodiments also convert radiation into infrared radiation (IR). Hence, upon excitation with radiation, the luminescent material emits radiation. In general, the luminescent material will be a down converter, i.e. radiation of a smaller wavelength is converted into radiation with a larger wavelength (λₑₓ<λₑₘ), though in specific embodiments the luminescent material may comprise up-converter luminescent material, i.e. radiation of a larger wavelength is converted into radiation with a smaller wavelength (λₑₓ>λₑₘ).

In embodiments, the term “luminescence” may refer to phosphorescence. In embodiments, the term “luminescence” may also refer to fluorescence. Instead of the term “luminescence”, also the term “emission” may be applied. Hence, the terms “first radiation” and “second radiation” may refer to excitation radiation and emission (radiation), respectively. Likewise, the term “luminescent material” may in embodiments refer to phosphorescence and/or fluorescence. The term “luminescent material” may also refer to a plurality of different luminescent materials. Examples of possible luminescent materials are indicated below. Hence, the term “luminescent material” may in specific embodiments also refer to a luminescent material composition. Instead of the term “luminescent material” also the term “phosphor” may be applied. These terms are known to the person skilled in the art.

In embodiments, luminescent materials are selected from garnets and nitrides, especially doped with trivalent cerium or divalent europium, respectively. The term “nitride” may also refer to oxynitride or nitridosilicate, etc. Alternatively or additionally, the luminescent material(s) may be selected from silicates, especially doped with divalent europium.

In specific embodiments the luminescent material comprises a luminescent material of the type A₃B₅O₁₂:Ce, wherein A in embodiments comprises one or more of Y, La, Gd, Tb and Lu, especially (at least) one or more of Y, Gd, Tb and Lu, and wherein B in embodiments comprises one or more of Al, Ga, In and Sc. Especially, A may comprise one or more of Y, Gd and Lu, such as especially one or more of Y and Lu. Especially, B may comprise one or more of Al and Ga, more especially at least Al, such as essentially entirely Al. Hence, especially suitable luminescent materials are cerium comprising garnet materials. Embodiments of garnets especially include A₃B₅O₁₂ garnets, wherein A comprises at least yttrium or lutetium and wherein B comprises at least aluminum. Such garnets may be doped with cerium (Ce), with praseodymium (Pr) or a combination of cerium and praseodymium; especially however with Ce. Especially, B may comprise aluminum (Al); however, in addition to aluminum, B may also partly comprise gallium (Ga) and/or scandium (Sc) and/or indium (In), especially up to about 20% of B, more especially up to about 10% of B (i.e. the B ions essentially consist of 90 or more mole % of Al and 10 or less mole % of one or more of Ga, Sc and In); B may especially comprise up to about 10% gallium. In another variant, B and O may at least partly be replaced by Si and N. The element A may especially be selected from the group consisting of yttrium (Y), gadolinium (Gd), terbium (Tb) and lutetium (Lu). Further, Gd and/or Tb are especially only present up to an amount of about 20% of A. In a specific embodiment, the garnet luminescent material comprises (Y₁₋ₓLuₓ)₃B₅O₁₂:Ce, wherein x is equal to or larger than 0 and equal to or smaller than 1. The term “:Ce”, indicates that part of the metal ions (i.e. in the garnets: part of the “A” ions) in the luminescent material is replaced by Ce. For instance, in the case of (Y₁₋ₓLuₓ)₃Al₅O₁₂:Ce, part of Y and/or Lu is replaced by Ce. This is known to the person skilled in the art. Ce will replace A in general for not more than 10%; in general, the Ce concentration will be in the range of 0.1 to 4%, especially 0.1 to 2% (relative to A). Assuming 1% Ce and 10% Y, the full correct formula could be (Y_{0.1}Lu_{0.89}Ce_{0.01})₃Al₅O₁₂. Ce in garnets is substantially or only in the trivalent state, as is known to the person skilled in the art.

In embodiments, the luminescent material (thus) comprises A₃B₅O₁₂ wherein in specific embodiments at maximum 10% of B—O may be replaced by Si—N.

In specific embodiments the luminescent material comprises (Yₓ₁A′ₓ₂Ceₓ₃)₃(Al_{y1}B′_{y2})₅O₁₂, wherein x1+x2+x3=1, wherein x3>0, wherein 0≤x2+x3≤0.2, wherein y1+y2=1, wherein especially 0≤y2≤0.2, wherein A′ comprises one or more elements selected from the group consisting of lanthanides, and wherein B′ comprises one or more elements selected from the group consisting of Ga, In and Sc. In embodiments, x3 is selected from the range of 0.001-0.1. In the present invention, especially x1>0, such as >0.2, like at least 0.8. Garnets with Y may provide suitable spectral power distributions.

In specific embodiments at maximum 10% of B—O may be replaced by Si—N. Here, B in B—O refers to one or more of Al, Ga, In and Sc (and O refers to oxygen); in specific embodiments B—O may refer to Al—O. As indicated above, in specific embodiments x3 may be selected from the range of 0.001-0.04. Especially, such luminescent materials may have a suitable spectral distribution (see however below), have a relatively high efficiency, have a relatively high thermal stability, and allow a high CRI (optionally in combination with (the) light of other sources of light as described herein). Hence, in specific embodiments A may be selected from the group consisting of Lu and Gd. Alternatively or additionally, B may comprise Ga. Hence, in embodiments the luminescent material comprises (Yₓ₁(Lu,Gd)ₓ₂Ceₓ₃)₃(Al_{y1}Ga_{y2})₅O₁₂, wherein Lu and/or Gd may be available. Even more especially, x3 is selected from the range of 0.001-0.1, wherein 0<x2+x3≤0.1, and wherein 0≤y2≤0.1. Further, in specific embodiments, at maximum 1% of B—O may be replaced by Si—N. Here, the percentage refers to moles (as known in the art); see e.g. also EP3149108. In yet further specific embodiments, the luminescent material comprises (Yₓ₁Ceₓ₃)₃Al₅O₁₂, wherein x1+x3=1, and wherein 0<x3≤0.2, such as 0.001-0.1.

In specific embodiments, the light generating device may only include luminescent materials selected from the type of cerium comprising garnets. In even further specific embodiments, the light generating device includes a single type of luminescent materials, such as (Yₓ₁A′ₓ₂Ceₓ₃)₃(Al_{y1}B′_{y2})₅O₁₂. Hence, in specific embodiments the light generating device comprises luminescent material, wherein at least 85 weight %, even more especially at least about 90 wt. %, such as yet even more especially at least about 95 weight % of the luminescent material comprises (Yₓ₁A′ₓ₂Ceₓ₃)₃(Al_{y1}B′_{y2})₅O₁₂. Here, wherein A′ comprises one or more elements selected from the group consisting of lanthanides, and wherein B′ comprises one or more elements selected from the group consisting of Ga, In and Sc, wherein x1+x2+x3=1, wherein x3>0, wherein 0<x2+x3≤0.2, wherein y1+y2=1, wherein 0≤y2≤0.2. Especially, x3 is selected from the range of 0.001-0.1. Note that in embodiments x2=0. Alternatively or additionally, in embodiments y2=0.

In specific embodiments, A may especially comprise at least Y, and B may especially comprise at least Al.

Alternatively or additionally, the luminescent material may comprise a luminescent material of the type A₃Si₆N₁₁:Ce³⁺, wherein A comprises one or more of Y, La, Gd, Tb and Lu, such as in embodiments one or more of La and Y.

In embodiments, the luminescent material may alternatively or additionally comprise one or more of MS:Eu²⁺ and/or M₂Si₅N₈:Eu²⁺ and/or MAlSiN₃:Eu²⁺ and/or Ca₂AlSi₃O₂N₅:Eu²⁺, etc., wherein M comprises one or more of Ba, Sr, and Ca, especially in embodiments at least Sr. Hence, in embodiments, the luminescent may comprise one or more materials selected from the group consisting of (Ba,Sr,Ca)S:Eu, (Ba,Sr,Ca)AlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation; its presence will especially be in the range of about 0.5 to 10%, more especially in the range of about 0.5 to 5% relative to the cation(s) it replaces. The term “:Eu”, indicates that part of the metal ions is replaced by Eu (in these examples by Eu²⁺). For instance, assuming 2% Eu in CaAlSiN₃:Eu, the correct formula could be (Ca_{0.98}Eu_{0.02})AlSiN₃. Divalent europium will in general replace divalent cations, such as the above divalent alkaline earth cations, especially Ca, Sr or Ba. The material (Ba,Sr,Ca)S:Eu can also be indicated as MS:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Further, the material (Ba,Sr,Ca)₂Si₅N₈:Eu can also be indicated as M₂Si₅N₈:Eu, wherein M is one or more elements selected from the group consisting of barium (Ba), strontium (Sr) and calcium (Ca); especially, M comprises in this compound Sr and/or Ba. In a further specific embodiment, M consists of Sr and/or Ba (not taking into account the presence of Eu), especially 50 to 100%, more especially 50 to 90% Ba and 50 to 0%, especially 50 to 10% Sr, such as Ba_{1.5}Sr_{0.5}Si₅N₈:Eu (i.e. 75% Ba; 25% Sr). Here, Eu is introduced and replaces at least part of M, i.e. one or more of Ba, Sr, and Ca). Likewise, the material (Ba,Sr,Ca)AlSiN₃:Eu can also be indicated as MAlSiN₃:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Eu in the above indicated luminescent materials is substantially or only in the divalent state, as is known to the person skilled in the art.

Eu in the above indicated luminescent materials is substantially or only in the divalent state, as is known to the person skilled in the art.

The term “luminescent material” herein especially relates to inorganic luminescent materials. Alternatively or additionally, also other luminescent materials may be applied. For instance quantum dots and/or organic dyes may be applied and may optionally be embedded in transmissive matrices like e.g. polymers, like PMMA, or polysiloxanes, etc. etc.

Different luminescent materials may have different spectral power distributions of the respective luminescent material light. Alternatively or additionally, such different luminescent materials may especially have different color points (or dominant wavelengths).

As indicated above, other luminescent materials may also be possible. Hence, in specific embodiments the luminescent material is selected from the group of divalent europium containing nitrides, divalent europium containing oxynitrides, divalent europium containing silicates, cerium comprising garnets, and quantum structures. Quantum structures may e.g. comprise quantum dots or quantum rods (or other quantum type particles) (see above). Quantum structures may also comprise quantum wells. Quantum structures may also comprise photonic crystals.

In embodiments, the luminescent material may at least comprise a luminescent material of the type A₃B₅O₁₂:Ce, wherein A comprises one or more of Y, La, Gd, Tb and Lu, and wherein B comprises one or more of Al, Ga, In and Sc.

In specific embodiments, the luminescent material may comprise at least two different luminescent materials configured to provide luminescent material light having different spectral power distributions. As can be derived from the above, the term “different luminescent materials” may refer to luminescent materials that are different, or to two compositions, each including at least one luminescent material in common, but wherein the compositions differ. For instance, a first luminescent material comprising luminescent materials A and B, and a second luminescent material comprising only A or only B, or comprising both A and B, but in a different weight ratio. Such first luminescent material and second luminescent material may have different spectral power distributions of their respective luminescent material light.

Further examples of luminescent materials are described below in relation to the second luminescent material.

The luminescent material may be configured in the system such that, optionally together with optics, device light may reach the luminescent material, though this may depend (also) on the polarization of the device light.

In embodiments, the luminescent material may have an excitation band, especially in the blue wavelength range, at least partly overlapping with a device light emission band. This may apply to essentially any luminescent material used herein, though embodiments wherein one luminescent material is excited by the emission of another luminescent material are not excluded.

Hence, in embodiments the first luminescent material may be configured to convert at least part of the device light received by the first luminescent material into first luminescent material light. The first luminescent material light may have a first luminescent material light spectral power distribution (i.e. the spectral power distribution of the first luminescent material light).

Further, the light generating system may comprise a reflector. Especially, the reflector may be configured to reflect at least part of the device light received by the reflector into reflected device light. The reflector may especially be a diffuse reflector (see further also below). Hence, in embodiments the reflector may be configured to diffuse at least part of the device light received by the reflector thereby providing diffused reflected device light.

Yet, in embodiments the system may comprise a rotatable element. In embodiments, the rotatable element may comprises a first ring-shaped section, and a second a ring-shaped section. Especially, in embodiments the first luminescent material may be comprised by at least part of the first ring-shaped section. Alternatively or additionally, in embodiments the reflector may be comprised by at least part of the second ring-shaped section. Especially, the second a ring-shaped section is (thus) different from the first ring-shaped section. Note that is herein not excluded that a reflector supports the luminescent material. In this way, the first ring-shaped section is configured on the reflector, and where the first ring-shaped section is not available, the second ring-shaped section is available.

In embodiments, more than one rotatable element, configured to support luminescent material and/or a reflector element may be available. Especially, however, herein in embodiments a single rotatable element may be applied, at least comprising the first luminescent material and the reflector.

In embodiments, the ring-shaped sections may be on an outer face of the rotatable element or may be a recessed part in the outer face of the rotatable element. When the rotatable element comprises a cylindrical shape, the radii of the ring-shaped sections may be identical. The radii may e.g. also be different, e.g. in embodiments wherein the rotatable element comprises a conical shape. When the rotatable element comprises a disc-like shape, the radii of the ring-shaped sections may be different. Hence, in embodiments the rotatable element may comprise a disc-like shape, such as a disc. In such embodiments, the luminescent material and the reflector may be available as rings on a (planer) face of a disc. Hence, in (other) embodiments the rotatable element may comprise a cylindrical shape, such as a cylinder (or a cone). In such embodiments, the luminescent material and the reflector may be available as rings on (or in) the curved face of the cylinder. Herein, the term cylinder, in relation to the rotatable element, may refer to a hollow cylinder as well as a cylindrical (non-hollow) body, such as a rod. Likewise, this may apply to the cone, which may be hollow or may be a solid body. Other embodiments, however, may also be possible. Other embodiments, however, may also be possible. Each of the disc-like shape, a cylindrical shape, or a conical shape may have an axis of rotation (or symmetry axis), about which the rotational element may be rotated.

The first ring-shaped section may be adjacent to the second ring-shaped section. There may be one or more first ring-shaped sections and/or there may be one or more second ring-shaped sections. In embodiments, the rotatable element may comprise a single first ring-shaped section and a single second ring-shaped section. In other embodiments, the rotatable element two first ring-shaped sections, and a single second ring-shaped section, wherein the second ring-shaped section is configured between the two first ring-shaped sections (ABA configuration). In other embodiments, there may be two second ring-shaped sections, and a single first ring-shaped section, wherein the first ring-shaped section is configured between the two second ring-shaped sections (BAB configuration). In embodiments, the second ring-shaped section may be configured on a broader first ring-shaped section (which may in specific embodiments lead to the afore-mentioned ABA configuration). In other embodiments, the first ring-shaped section may be configured on a broader second ring-shaped section (which may in specific embodiments lead to the afore-mentioned BAB configuration).

In embodiments, the first ring-shaped section may comprise the first luminescent material over an entire perimeter. Hence, the first luminescent material may be configured in a ring-shape (i.e. over 360°). In other embodiments, the first ring-shaped section may over part of the entire perimeter comprise the first luminescent material (i.e. over less than 360°), such as over 90-270°, or a plurality of parts of the first ring-shaped section. Note that in embodiments the first ring-shaped section may comprise a single first luminescent material, and in other embodiments the first ring-shaped section may comprise two or more different first luminescent materials (configured at different parts of the first ring-shaped section).

In embodiments, the second ring-shaped section may comprise the reflector over an entire perimeter. Hence, the reflector may be configured in a ring-shape (i.e. over 360°). In other embodiments, the second ring-shaped section may over part of the entire perimeter comprise the reflector (i.e. over less than 360°), such as over 90-270°, or a plurality of parts of the second ring-shaped section. Note that in embodiments the second ring-shaped section may comprise a reflector, and in other embodiments the second ring-shaped section may comprise two or more different reflectors (configured at different parts of the second ring-shaped section).

Hence, a single rotatable element may comprise the first ring-shaped section and the second ring-shaped section. The mutual distance may in embodiments essentially be zero. However, for the dual beam configurations, see also below, the mutual distance may be larger, as different ring-shaped sections may be addressed by different beams, especially larger than a full width half maximum spot size of the device light on the rotatable element, such as at least twice as large.

Therefore, in embodiments the first ring-shaped section may have a first width (d1), the second ring-shaped section may have a second width (d2), and the first ring-shaped section and the second ring-shaped section have a mutual distance (d3) (which may be zero or non-zero, see also below).

Hence, in embodiments, especially in embodiments wherein the beam of device light may be mechanically moved relative to the first luminescent material and the reflector, d3/d1≤0.5 and/or d3/d2≤0.5 may apply. Alternatively or additionally, d3 may be at minimum 0.5 mm. This may facilitate generating system light wherein the contributions of the reflected device light and the first luminescent material light are controllable. Therefore, especially embodiments wherein the distribution of the device light over the first ring-shaped section and second ring-shaped section is mechanically controllable, a singe beam may be used to irradiate the first ring-shaped section and/or second ring-shaped section.

In embodiments, especially in embodiments wherein one or more beams of device light may be optically controlled relative to the first luminescent material and reflector, d3/d1>0.5 and/or d3/d2>0.5 may apply. Alternatively or additionally, d3 may be at equal to or larger than 0.5 mm, such as at least about 1 mm. This may facilitate generating reflected device light, with substantially no first luminescent material light, as well as generating first luminescent material light, with substantially no reflected device light (as the beam of device light addressing the reflector may essentially not address the first luminescent material, and as the beam of device light addressing the first luminescent material may essentially not address the reflector). In this way, there may be a better control of the contributions of the reflected device light and first luminescent material light to the system light. Therefore, especially embodiments wherein the distribution of the device light over the first ring-shaped section and second ring-shaped section is optically controllable, a multiple beam (solution), such as a dual beam (solution) may be used to irradiate the first ring-shaped section and/or second ring-shaped section.

By rotating the rotatable element, the device may (alternatingly) irradiate the reflector and the first luminescent material (and the optional second luminescent material). When the rotational frequency is at least about 40 Hz, such as at least about 50 Hz, then the human eye may not see the sequential generation. An actuator may be used to control the rotatable element. With high power irradiation of the luminescent material, the thermal load may become critical. Hence, in embodiments the luminescent material may be configured to extend in a circular configuration, such as on a disc, and may be rotated during operation of the system. In this way, the luminescent material is only temporarily heated, and is allowed to cool during a (short) time before it is again irradiated. Hence, in embodiments the system may comprise a rotatable element, wherein the rotatable element comprises the luminescent material; wherein during operation of the light generating system (in the first operational mode) the rotatable element rotates, such that over time different parts of the luminescent material are irradiated by the device light. Likewise, this may apply to the diffuser element. Hence, in embodiments the system may comprise a rotatable element, wherein the rotatable element comprises the diffuser element; wherein during operation of the light generating system (in the first operational mode) the rotatable element rotates, such that over time different parts of the diffuser element are irradiated by the second device light. Rotational frequencies may e.g. be selected from the range of 40-300 Hz, like at least 50 Hz, though other rotational frequencies may also be possible. Hence, typically, the duration of irradiating the luminescent material is much shorter (≥10×, more commonly ≥50×) than the duration of not irradiating the luminescent material. In embodiments, the rotatable element may be provided as wheel or disc. Hence, in embodiments the rotatable element may comprise a phosphor wheel. However, rotating rods may also be applied.

Hence, the system may comprise a rotatable element, wherein the rotatable element comprises the luminescent material. Especially, during operation of the light generating system (in an operational mode) the rotatable element rotates, such that over time different parts of the luminescent material are irradiated by the device light. Yet, in specific embodiments the rotatable element also comprises the diffuser element (spatially separated from the luminescent material). Especially, during operation of the light generating system (in an operational mode) the rotatable element rotates, such that over time different parts of the diffuser element are irradiated by the device light. Note that the reflector may (thus) especially be a diffuser element. Hence, the system may further comprise an actuator configured to rotate the rotatable element. The control system may control the actuator (and thereby the rotational frequency).

Further, the system may comprise a control system. In embodiments, the control system may control the rotation of the rotatable element. In specific embodiments, the rotational frequency of the rotatable element may essentially be constant during operation of the light generating system.

The control system may be configured to have the first ring-shaped section and the second ring-shaped section receive device light in different ratios in dependence of one or more of a user interface, a sensor signal (of a sensor), and a timer. In this way, the spectral power distribution of the system light may be controlled. In embodiments, the control system may do so via a controllable mechanical change. In other embodiments, the control system may do so via a controllable optical change. Note that the herein described control of polarization by rotation of a polarization control element (see below), can be considered both. However, as effectively the polarization is influenced, it is herein especially considered an optical control option. Rotation of the polarization control element may be executed with an actuator (which may be controlled by the control system).

Hence, in a first operational mode of the light generating system, a first ratio R1 of spectral power of the device light received by the first-ring shaped section to the spectral power of the device light received by the second ring-shaped section, may differ from a second ratio R2 of spectral power of the device light received by the first-ring shaped section to the spectral power of the device light received by the second ring-shaped section in a second operational mode of the light generating system. In embodiments, R1/R2≥1.1, such as R1/R2≥1.5, or, R1/R2≤0.9, such as R1/R2≤0.7. Especially, in embodiments 1.1≤R1/R2≤1000 or 0.001≤R1/R2≤0.7. Other values, however, may also be possible. In specific embodiments, light generating system may be configured such that in a first operational mode the first ring-shaped section receives X1% of the spectral power of the system light and the second ring-shaped section receives Y1% of the spectral power of the system light, and in a second operational mode the first ring-shaped section receives X2% of the spectral power of the system light and the second ring-shaped section receives Y2% of the spectral power of the system light, wherein X1>X2 and wherein Y1<Y2. In embodiments, the ratio of the radiant flux of the device light on the luminescent material and the radiant flux of the device light on the reflector may be selected such, that the percentage of the radiant flux of the device light in system light is selected from the range of about 0.5-40%. For relatively low correlated color temperatures (CCTs), the percentage may be below 5%; for relatively high CCTs, the percentage may be at least 10%, such as at least 15%. Hence, in embodiments wherein the control system may be configured to control a spectral power distribution of the system light, more especially a correlated color temperature of the system light, by controlling a relative intensity of the device light on the first ring-shaped section and the second ring-shaped section.

Hence, in embodiments the light generating system may be configured such that (a) in an operational mode of the light generating system the rotatable element may rotate, such that over time different parts of the first ring-shaped section and/or different parts of the second ring-shaped section are irradiated by the device light. Alternatively or additionally, in embodiments the light generating system may be configured such that (b) a distribution of the device light over the first ring-shaped section and the second ring-shaped section may be optically (and/or mechanically) controllable. Further, the light generating system may be configured to generate system light comprising one or more of the first luminescent material light and the reflected device light. Hence, especially the light generating system may be configured such that (a) in an operational mode of the light generating system the rotatable element rotates, such that over time different parts of the first ring-shaped section and/or different parts of the second ring-shaped section are irradiated by the device light, and (b) a distribution of the device light over the first ring-shaped section and the second ring-shaped section is optically (and/or mechanically) controllable; and wherein the light generating system may be configured to generate system light comprising one or more of the first luminescent material light and the reflected device light. Especially, the control system may (thus) be configured to control a spectral power distribution of the system light by optically and/or mechanically controlling the distribution of the device light over the first ring-shaped section and the second ring-shaped section.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc., Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme. In specific embodiments, inputs for such a control system may be, next to target setting signals or boundary signals, sensor signals, such as temperature-correlated signals, optical flux correlated signals, and/or optical flux ratio or color point correlated signals, etc.

As indicated above, the term “first luminescent material” may refer to one or more first luminescent materials. Further, optionally one or more second luminescent materials (“second luminescent material”) may be available. Embodiments thereof are described below.

In embodiments, the light generating system may comprises at least two different first luminescent materials, configured at different parts of the first ring-shaped section. The at least two different first luminescent materials may especially be configured to convert at least part of the device light received by the (respective) first luminescent material into first luminescent material light. The (respective) first luminescent material light of the at least two different first luminescent materials may have different spectral power distributions. Especially, the first luminescent material(s) may provide spectral power in one or more of the green wavelength range, yellow wavelength range, orange wavelength range, and red wavelength range. Hence, the at least two different luminescent material may differ in one or more of color point of the luminescent material light, centroid wavelength of the luminescent material light, and correlated color temperature of the luminescent material light. Note that the first luminescent material may especially be colored light, having a color selected from green, yellow, orange, and red. Hence, the at least two different luminescent material may e.g. have different color points. Note that when different luminescent materials are configured in the first ring-shaped section, the human eye may perceive essentially only the combination of the luminescent material light of the different luminescent materials, due to the rotation of the rotatable element.

In specific embodiments, colors or color points of a first type of light and a second type of light may be different when the respective color points of the first type of light and the second type of light differ with at least 0.01 for u′ and/or with at least 0.01 for v′, even more especially at least 0.02 for u′ and/or with at least 0.02 for v′. In yet more specific embodiments, the respective color points of first type of light and the second type of light may differ with at least 0.03 for u′ and/or with at least 0.03 for v′. Here, u′ and v′ are color coordinates of the light in the CIE 1976 UCS (uniform chromaticity scale) diagram. Spectral power distributions of different sources of light having centroid wavelengths differing at least 10 nm, such as at least 20 nm, or even at least 30 nm may be considered different spectral power distributions, e.g. different colors. In general, the differences in centroid wavelengths will not be larger than about 400 nm, such as not more than 350 nm.

Herein, the terms “violet light” or “violet emission”, and similar terms, may especially relate to light having a wavelength in the range of about 380-440 nm. In specific embodiments, the violet light may have a centroid wavelength in the 380-440 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “orange light” or “orange emission”, and similar terms, may especially relate to light having a wavelength in the range of about 590-620 nm. In specific embodiments, the orange light may have a centroid wavelength in the 590-620 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The terms “amber light” or “amber emission”, and similar terms, may especially relate to light having a wavelength in the range of about 585-605 nm, such as about 590-600 nm. In specific embodiments, the amber light may have a centroid wavelength in the 585-605 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range. Here, the term “green-red wavelength range” may especially refer to the entire wavelength range green and red, and all wavelengths in between, i.e. 490-780 nm. Especially, the luminescent material may have a centroid wavelength selected from the green-red wavelength range.

It is e.g. (also) possible that a reflector in a second ring-shaped section is configured between two different luminescent materials in two (adjacent) first ring-shaped sections. By controlling the distribution of the spectral power to first ring-shaped sections and the second ring-shaped section, for instance one or more of CCT, color point, and CRI may be controlled. For instance, (in embodiments) relatively more spectral power to one of the first ring-shaped sections than to the other one may provide system light with a lower CCT, and relatively more spectral power to the other one of the first ring-shaped sections than to the one may provide system light with a higher CCT.

Alternatively or additionally, the second ring-shaped section may not only comprise the reflector, but may also comprise a second luminescent material. Hence, the second ring-shaped section may comprise one or more parts comprising the reflector(s), and one or more parts comprising the second luminescent material. As the second ring-shaped section may especially be the source of light having a violet-cyan wavelength, the second luminescent material may especially be a luminescent material that absorbs the device light and provides emission with a relatively small Stokes-shift. Note that when a second luminescent material and a (diffusive) reflector are configured in the second ring-shaped section, the human eye may perceive essentially only the combination of the second luminescent material light and the (diffused) reflected device light, due to the rotation of the rotatable element.

Therefore, in embodiments the light generating system may comprise a second luminescent material, wherein the second luminescent material and the reflector are configured in different parts of the second ring-shaped section. Especially, in embodiments the device light may has a device light centroid wavelength λ_{cd}, and the second luminescent material light has a second luminescent material light centroid wavelength λ_{c2}, wherein (λ_{cd}+10 nm)≤λ_{c2}. Further, in embodiments the device light centroid wavelength λ_{cd} may be selected from the wavelength range of 400-480 nm, and the second luminescent material light centroid wavelength λ_{c2} may be selected from the wavelength range of 450-520 nm. More especially, the device light has a device light centroid wavelength λ_{cd}, the first luminescent material light has a first luminescent material light centroid wavelength λ_{c1}, and the second luminescent material light has a second luminescent material light centroid wavelength λ_{c2}, wherein (λ_{cd}+10 nm)≤λ_{c2}≤(λ_{c1}−10 nm); wherein device light centroid wavelength λ_{cd} is selected from the wavelength range of 400-480 nm, the first luminescent material light centroid wavelength λ_{c1} is selected from the wavelength range of 490-780 nm, the second luminescent material light centroid wavelength λ_{c2} is selected from the wavelength range of 450-520 nm

Further, in (other) embodiments the device light may comprise one or more of polarized light having a p polarization and polarized light having an s polarization. Hence, in specific embodiments the device light may be elliptically polarized. When mechanically controlling the spectral power distribution, it may—in first approximation—not be relevant whether or not the device light is polarized. However, in specific embodiments of the embodiments wherein mechanically controlling is applied, there may be options where polarization is relevant. For the relevance of polarization, especially embodiments further described below may be considered.

Optionally, the polarization of the device light may be controllable, such as using one or more of (i) polarization control optics, and (ii) using two or more light generating devices generating device light having different (linear or elliptical) polarizations. Embodiments will further be described below.

The one or more light generating devices are configured to generate polarized device light having a controllable polarization. When the polarization of the device light is controllable, the system may especially comprise central optics. The central optics may be configured to transmit and/or reflect at least part of the (reflected) device light in dependence of its polarization and/or transmit and/or reflect at least part of the (reflected) device light, at least part of the first luminescent material light, and optionally at least part of the second luminescent material light, in dependence of their spectral power distributions. Therefore, the light generating system may further comprise central optics, wherein the central optics may comprise (i) a central optics polarizing beam splitter, and (ii) a central optics dichroic beam splitter; wherein: (a) the central optics polarizing beam splitter is configured to transmit and/or reflect at least part of the (reflected) device light in dependence of its polarization, and (b) the central optics dichroic beam splitter is configured to transmit and/or reflect at least part of the (reflected) device light, at least part of the first luminescent material light, and optionally at least part of the second luminescent material light, in dependence of their spectral power distributions.

Note that the central optics herein are also described in relation to the second luminescent material light. Note however that the presence of this light is optional, as the second luminescent material is optional.

In this way, the system may allow that (a) at least part of the device light, when having a first polarization, propagates from the one or more light generating devices via the central optics to the first ring-shaped section to provide the first luminescent material light, (b) at least part of the device light, when having a second polarization, different from the first polarization, propagates from the one or more light generating devices via the central optics to the second ring-shaped section to provide the reflected device light and/or optionally second luminescent material light, and (c) at least part of the first luminescent material light generated by the first luminescent material, at least part of the reflected device light generated at the reflector and/or and optionally at least part of the second luminescent material light generated by the second luminescent material, escape from the light generating system via the central optics.

In the light generating system, the one or more light generating devices are configured to generate polarized device light having a controllable polarization, the central optics comprises (i) a central optics polarizing beam splitter, and (ii) a central optics dichroic beam splitter; wherein: the central optics polarizing beam splitter is configured to transmit and/or reflect at least part of the device light in dependence of its polarization; the central optics dichroic beam splitter is configured to transmit and/or reflect at least part of the device light, at least part of the first luminescent material light, and optionally at least part of the second luminescent material light, in dependence of their spectral power distributions; the light generating system is configured such that (a) at least part of the device light, when having a first polarization, propagates from the one or more light generating devices via the central optics to the first ring-shaped section to provide the first luminescent material light, (b) at least part of the device light, when having a second polarization, different from the first polarization, propagates from the one or more light generating devices via the central optics to the second ring-shaped section to provide the reflected device light and/or optionally second luminescent material light, and (c) at least part of the first luminescent material light generated by the first luminescent material, at least part of the reflected device light generated at the reflector and/or and optionally at least part of the second luminescent material light generated by the second luminescent material, may escape from the light generating system via the central optics; the control system is configured to control the polarization of the device light; and the light generating system is configured to generate system light comprising one or more of (i) the first luminescent material light, and (ii) the reflected device light and/or optionally the second luminescent material light.

Hence, in embodiments the invention provides a tunable beam combining laser phosphor engine comprising central optics, wherein the central optics may have at least a polarizing beam splitter function and a dichroic beam splitter function. Therefore, amongst others in embodiments a laser phosphor engine with partial polarizing beam splitter and tunable color point with reduced offset from BBL is provided. Note that instead of lasers, also other light sources may be applied.

The system may (thus) comprise optics. Especially, the system may at least comprises central optics. In embodiments, the central optics may (thus) comprise (i) a central optics polarizing beam splitter, and (ii) a central optics dichroic beam splitter. In embodiments, the central optics polarizing beam splitter may be configured to transmit and/or reflect at least part of the device light in dependence of its polarization. Especially, for device light with one of the polarizations (like p or s) may apply that its transmission by the central optics polarizing beam splitter is higher than the transmission for device light having another polarization (like s or p), whereas also for device light with the one of the polarizations (like p or s) may apply that its reflection by the central optics polarizing beam splitter is lower than the reflection for device light having another polarization (like s or p) (see further also below). Especially, the central optics polarizing beam splitter may be selected such that the first luminescent material light and/or the optional second luminescent material light are substantially transmitted. Note that the first luminescent material light and/or the optional second luminescent material light may be substantially unpolarized light. In embodiments, the central optics dichroic beam splitter may be configured to transmit and/or reflect at least part of the device light, at least part of the reflected device light, at least part of the first luminescent material light, and at least part of the optional second luminescent material light in dependence of their (respective) spectral power distributions.

In embodiments, the central optics may have a polarizing beam splitting function for both polarizations for a first wavelength range, like comprising at least part of the blue wavelength range, such that the light having a wavelength in the first wavelength range comprising a first polarization is reflected or transmitted, and light also having a wavelength in the first wavelength but comprising a second polarization is transmitted or reflected, whereas for a second wavelength range, for instance comprising at least part of the yellow wavelength range, the central optics may be reflective or transmissive for both polarizations, such that for light comprising one of the first polarization and the second polarization applies that the central optics is reflective or transmissive over both wavelength ranges, and for light comprising the other one of the first polarization and the second polarization applies that only in the first wavelength range the central optics has a polarizing beam splitting function and not in the second wavelength range. Such embodiments of the central optics may especially be relevant when the system is configured in such a way that the central optics should be transmissive for the first luminescent material light. However, in embodiments wherein the central optics should be reflective for the first luminescent material light, also other type of central optics may be applied (e.g. wherein the central optics may be reflective or transmissive for both polarizations, such that for light comprising one of the first polarization and the second polarization applies that the central optics is reflective or transmissive over both wavelength ranges, and for light comprising the other one of the first polarization and the second polarization applies that the central optics is reflective or transmissive over both wavelength ranges). In these ways, the central optics may (also) provide a polarizing beam splitting functions and dichroic beam splitting function.

Hence, in embodiments the central optics may be configured such that: (a) first light having a wavelength in a first wavelength range comprising the first polarization is reflected or transmitted; (b) second light having a second wavelength in the first wavelength range and comprising a second polarization is transmitted or reflected; (c) third light having a third wavelength in a second wavelength range is transmitted or reflected, like one of the first light and the second light, irrespective whether the third light comprises the first polarization or the second polarization; especially in embodiments wherein the central optics is configured to transmit at least part of the first luminescent material light.

Especially, for the first luminescent material light and the optional second luminescent material may apply that either (a) the transmission of the first luminescent material light at the central optics dichroic beam splitter is higher than its reflection at the central optics dichroic beam splitter, and the reflection of the optional second luminescent material light at the central optics dichroic beam splitter is higher than its transmission at the central optics dichroic beam splitter, or (b) the transmission of the first luminescent material light at the central optics dichroic beam splitter is lower than its reflection at the central optics dichroic beam splitter, and the reflection of the optional second luminescent material light at the central optics dichroic beam splitter is lower than its transmission at the central optics dichroic beam splitter.

The term “central optics” may be applied as essentially all light, i.e. the reflected device light, the first luminescent material light, and the optional second luminescent material light may only escape from the system via the central optics. Further, the device light may only reach the reflector, the first luminescent material and the optional second luminescent material via the central optics. Hence, the term “central optics polarizing beam splitter” may refer to a polarizing beam splitter comprised by the central optics. Likewise, the term “central optics dichroic beam splitter” may refer to a dichroic beam splitter comprised by the central optics.

In embodiments, the light generating system may be configured such that at least part of the device light, when having a first polarization (such as p or s), may propagate from the one or more light generating devices via the central optics to the first luminescent material to provide the first luminescent material light. Alternatively or additionally in embodiments, the light generating system may be configured such that at least part of the device light, when having a second polarization (such as s or p), (i.e. thus) different from the first polarization, may propagate from the one or more light generating devices via the central optics to the reflector (and optional second luminescent material) to provide the reflected device light and the optional second luminescent material light. Yet alternatively or additionally in embodiments, the light generating system may be configured such that at least part of the first luminescent material light generated by the first luminescent material, at least part of the optional second luminescent material light generated by the second luminescent material, and at least part of the reflected device light generated at the reflector, may escape from the light generating system via the central optics.

The above, such as especially the phrase “at least part of the first luminescent material light generated by the first luminescent material, at least part of the second luminescent material light generated by the second luminescent material, and at least part of the reflected device light generated at the reflector, escape from the light generating system via the central optics” does not necessarily imply that at the same time first luminescent material light, the optional second luminescent material light, and reflected device light escape from the system. Whether or not first luminescent material light and optional second luminescent material light, and reflected device light, are generated may depend upon the polarization of the device light. By controlling its polarization, the device light may be distributed over different routes (within the system), one to the first luminescent material (arrangement), and/or another one to reflector (and the optional) the second luminescent material (arrangement).

Hence, in embodiments the light generating system may comprise a first luminescent material arrangement comprising a first luminescent material. The first luminescent material arrangement may at least comprise the first luminescent material, but may in embodiments comprise one or more other elements (for instance a rotatable element, a heat sink, a reflector, one or more lenses, etc.). Especially, the first luminescent material may be configured to convert at least part of the device light received by the first luminescent material into first luminescent material light (having a first luminescent material light spectral power distribution). Alternatively or additionally, in embodiments the light generating system may comprise a second luminescent material arrangement comprising a second luminescent material. The second luminescent material arrangement may at least comprise the second luminescent material, but may in embodiments comprise one or more other elements (for instance a rotatable element, a heat sink, a reflector, one or more lenses, etc.). Especially, the second luminescent material may be configured to convert at least part of the device light received by the second luminescent material into second luminescent material light (having a second luminescent material light spectral power distribution (i.e. the spectral power distribution of the second luminescent material light)).

Therefore, especially the control system may be configured to control the polarization of the device light (see further also below).

Hence, in specific embodiments, the central optics polarizing beam splitter may be configured to transmit and/or reflect at least part of the device light in dependence of its polarization. Further, in specific embodiments the central optics dichroic beam splitter may be configured to (a) to transmit or reflect at least part of the first luminescent material light, (b) to reflect or transmit at least part of the optional second luminescent material light, and (c) to reflect or transmit at least part of the reflected (diffused) device light (in dependence of its polarization). Especially, the central optics polarizing beam splitter, and the central optics dichroic beam splitter are configured such that at least part of the first luminescent material, at least part of the optional second luminescent material light, and at least part of the reflected device light reaching the central optics, may escape from the system in essentially the same directions. Especially, this may imply that one of (a) the first luminescent material light and (b) the reflected device light and the optional second luminescent material light is transmitted by the central optics and the other one of (a) the first luminescent material light and (b) the reflected device light and the optional second luminescent material light is reflected by the central optics. Hence, the system may especially be configured such that first luminescent material light propagating to the central optics on the one hand, and reflected device light and optional second luminescent material light propagating to the central optics on the other hand have a mutual angle of (about) 90°.

In specific embodiments, the central optics dichroic beam splitter is designed for 45° angle of incidence of the device light. Examples of such dichroic beam splitter are e.g. a short-pass cut-off dichroic plate, or a long-pass cut-off dichroic plate. Yet, in specific embodiments, the central optics polarizing beam splitter is designed for 45° angle of incidence of the device light. Note that the central optics dichroic beam splitter and the central optics polarizing beam splitter may also be an integrated device, especially designed for 45° angle of incidence of the device light.

Note, however, that common dichroic beam splitters may work for essentially all polarizations while herein desirably one polarization direction of the device light may undergo transmission or reflection by the central optics just as the luminescent material light may do. In view thereof, there may be two distinct situations: (A) when the central optics may be reflective for the (first) luminescent material light, then the dichroic beam splitter function may be transmissive for all polarization directions of the device light, because it may be the polarizing beam splitter that may split the device light that is not further impacted by the dichroic beam splitter; and (B) when the central optics is transmissive for the (first) luminescent material light, then the full dichroic beam splitter function may only be in place for the s-polarization, because at least part of the p-polarized device light needs to be transmitted as well (or the other way around, would the device light be s polarized). In this case, the central optics may just comprise a polarizing beam splitter for the device light that needs to be transmissive for (all polarizations of) the (longer wavelength) luminescent material light. A dichroic beam splitter functionality that would reflect device light may only be acceptable for device light reflectance and transmittance values as requested by the configuration, e.g. 40% transmittance of p-polarized light, i.e., 60% reflectance of p-polarized light. In such case, the polarizing beam splitter may be a 100% polarizing beam splitter, as the partial split-off of device light may be realized by the dichroic beam splitter. Combinations of polarizing beam splitter and dichroic beam splitter reflectance values for p-polarized device light may be used to achieve a desired value.

Hence, the central optics may comprise at least two different functionalities, which may e.g. be realized by using two optical components, or by using a single optical component with two different functional layers (or sets of layers)(e.g. surface configurations or coatings/dichroic layer stacks; or by integration of both functions in a single surface layer or coating (stack of dichroic layers)). Therefore, in embodiments, the central optics may comprise a single optical component having polarizing beam splitting functionality and dichroic beam splitting functionality, or comprises two optical components, one having polarizing beam splitting functionality and one having dichroic beam splitting functionality.

In embodiments the light generating system may be configured to generate system light comprising one or more of the first luminescent material light, the reflected device light, and the optional second luminescent material light. As the device light may, dependent upon its polarization, propagate in embodiments to the second ring-shaped section, the generation of optional second luminescent material light and reflected device light may be dependent in the same way on the polarization of the device light. Therefore, in embodiments the light generating system may be configured to generate system light comprising one or more of (i) the first luminescent material light and (ii) the reflected device light and the optional second luminescent material light.

Especially, herein the reflector may comprise a diffuse reflector. Further, the reflector may thus especially be operated in the reflective mode. Alternative to a diffuse reflector, a transmissive diffusor may be applied. This embodiment is herein further not described.

Hence, in embodiments the reflector may be configured to diffuse at least part of the device light received by the reflector thereby providing diffused reflected device light. More especially, the reflector may be configured to diffuse at least part of the device light received by the reflector thereby providing diffused reflected device light while maintaining at least part of the polarization of the device light. Hence, the reflector may be a diffuser element operated in the reflective mode. Further, in embodiments the reflector may also be indicated as “diffuser element”. Especially, in embodiments at least part of the polarization may be maintained. An example of such diffuser element is a metallic coated glass diffuser showing 95-98% reflectance. In embodiments, the diffuser element may be selected such and the light generating system may be configured such that the depolarization of the diffuser is at maximum 50%, such as at maximum about 25%. In embodiments, the depolarization of reflected device light (relative to the device light irradiating the diffuser element) may be not more than about 20%, such as not more than about 10%.

An evaluation of polarization of reflected device light may e.g. be done by irradiating the diffuser with the polarized device light through a quarter wave retarder and measuring the reflected power in dependence of the orientation of the quarter wave plate.

Especially, the polarized light is incident on the quarter waveplate after passage through a polarizing beam splitter via a first optical path (either reflected or transmitted at the polarizing beam splitter), and the returned (diffused) light may be measured after passage through the polarizing beam splitter via a second optical path (either transmitted or reflected at the polarizing beam splitter).

In specific embodiments, a polarization changing element may be configured between the central optics and the reflector (especially the diffuser element). Especially, the polarization changing element may be configured to change s-polarized light or p-polarized light to circular polarized light. The reflector may change the direction of the polarized light, but the circular polarized light may essentially stay circular polarized light. However, it may change from left to right, or from right to left polarized light at the reflector. At least part of the diffused light, having circular polarization, will propagate from the reflector to the polarization changing element, and then be converted to (diffused) s-polarized light and/or (diffused) p-polarized light, which may further propagate to the central optics. Therefore, in embodiments the polarization changing element may comprise a λ/4 waveplate. In embodiments, the system may (thus) comprise a polarization changing element, wherein the polarization changing element is especially configured in an optical path of the device light between the central optics and the reflector. In this way, p-polarized light can be converted in diffused s-polarized light, and s-polarized light can be converted in diffused p-polarized light. Especially, the polarization changing element may be an element that induces a 90° phase shift between the two orthogonal linear polarization components (s and p) of the light. The most common way is to use birefringent material (birefringent rotators), such as a quarter-wave plate. An alternative may be to use the Faraday effect, in which case the phase shift is caused by an applied magnetic field (Faraday rotators).

As indicated above, the propagation of the device light within the system may depend upon its polarization. To control the polarization, several options may be possible. In embodiments, a polarization control element may be applied, which may control the polarization of the device light. In other embodiments, two or more light generating devices may be applied, which are configured to provide device light having different polarizations, respectively. By controlling the two or more light generating devices, the polarization of the device light may be controlled.

Hence, in embodiments the light generating system may further comprise a polarization control element, wherein the polarization control element may be configured to control polarization of the device light received by the polarization control element. In embodiments, the polarization changing element comprises a λ/2 waveplate. Especially, the polarization control element may be configured between at least one of first light generating devices and the central optics. Further, in embodiments the control system may be configured to control the polarization control element. Hence, in this way the polarization of the device light may be controllable.

Therefore, downstream of the light generating device, the polarization control may be configured. With the polarization control element, the polarization of the device light may be controlled. For instance, with a (rotatable) λ/2 retarder (see also below), in embodiments polarizations between fully s polarization and fully p polarization may be chosen. In this way, the ratio between the device light that is directed via the central optics to the first luminescent material and device light that is directed via the central optics to the reflector (and optional second luminescent material) may be controlled. Note that in embodiments in some operational modes, essentially all device light may be directed via the central optics to the first luminescent material. In embodiments, in some other operational modes, essentially all device light may be directed via the central optics to the reflector (and optional second luminescent material). Yet, in embodiments in other operational modes, part of the device light may be directed via the central optics to first luminescent material and part of the device light may be directed via the central optics to the reflector (and optional second luminescent material). Hence, (a) the polarization control element may be used to control the ratio of the polarizations of the device light, and (downstream thereof) the central optics routes, dependent upon the polarization of the device light, the further propagation of the device light (see further also below).

Hence, in embodiments the polarization control element may especially be configured to control polarization of the device light. In embodiments, the polarization control element may especially be configured to control a degree of polarization of the polarized light.

Especially, in embodiments the degree of polarization may be defined as a percentage of the p-polarized light or the s-polarized light relative to the total of s-polarized light and p-polarized light. For determining the percentages, the angular luminance of the device light having s polarization and the angular luminance of the device light having p polarization may be applied. For instance, the device light, downstream of the polarization control element, may have 20% s polarization and 80% p polarization. For the angular luminance, see e.g. Blom, S. et al., Towards a polarized light-emitting backlight: Micro-structured anisotropic layers, DOI—10.1889/1.1827869, Journal of the Society for Information Display, September 2002, p. 209-213. Instead of the angular luminance, also the luminance may be applied.

Yet, (in general) the term “degree of polarization” is known in the art. Especially, in embodiments the degree of polarization may be defined as a percentage of the p-polarized light and/or the s-polarized light relative to the total of p-polarized light and s-polarized light. Measurement of the degree of polarization is known in the art, and may be based on Stokes parameters.

In embodiments, by rotating the polarization control element the polarization of the device light may be controlled. As indicated herein, especially the device light, upstream of the polarization control element, may be linearly polarized, like s-polarized or p-polarized. Optionally, the device light may be a combination of s-polarized light and p-polarized light. For instance, with the polarization control element (by rotation the polarization control element), the combination of polarization control element and second source may provide device light, downstream of the polarization control element, having at least two polarizations selected from: essentially p-polarized, essentially s-polarized, and a combination of p-polarized and s-polarized. Note that in embodiments by rotating the polarization control element, a ratio between p-polarized and s-polarized may be controlled. For instance, would the device light be p-polarized light, by rotating the polarization control element, the contribution of p-polarized light may be reduced and the contribution of s-polarized may be increased, until essentially s-polarized light is obtained. Hence, in dependence of the rotational angle, the polarization of the device light may be controlled. In embodiments, a degree of polarization of the device light may be controlled by the polarization control element. The system may comprise an actuator configured to control the polarization control element. The control system may control the actuator for controlling the polarization control element. In embodiments, the afore-mentioned angle may be fixed during operation (i.e. not controllable during operation), and in other embodiments, this angle may be controlled (by the control system). Especially, herein the polarization of the device light propagating to the central optics is controllable (with the polarization control element). Especially, rotation of the polarization control element may imply rotation of the rotator axis. As further indicated below, the polarization control element may comprise a birefringent rotator.

Hence, in embodiments, the polarization control element may comprise a rotatable birefringent rotator. More especially, the (rotatable) birefringent rotator comprises a λ/2 waveplate. However, other phase-shift inducing components for the two linear orthogonal polarization components which can change the ratio of transmitted versus reflected light may also be applied. With a half-wavelength plate, s-polarized light can be transformed for 0-100% into p-polarized light. With a quarter-wavelength plate that may be only 0-50%. With a ⅜th-wavelength plate 0-75%, and with a ⅛th-wavelength plate 0-25%. So, a half-wavelength plate may give full flexibility (and independence of the actual polarization direction of the source), while the other options may give more limitations, both in terms of the fraction of light that can be transformed into required polarized components and in terms of the orientation of the polarization direction of the source.

In specific embodiments, the polarization control element may be configured fixed. In such embodiments, essentially only a (single) first operational mode may be available, unless other parameters are variable (like the radiant flux of the first device light, and/or the radiant flux of the second device light (see below)). In other embodiments, the polarization control element may be configured controllable, especially rotatable. In such embodiments, by rotating the polarization control element, the spectral power distribution of the system light may be controlled. In such embodiments, a plurality of first operational modes may be available, with different spectral power distributions.

Especially, instead of the term “s-polarized light”, and similar terms, also the term “linear s-polarized light” may be applied. Further, especially, instead of the term “p-polarized light”, and similar terms, also the term “linear p-polarized light” may be applied.

Alternatively or additionally, in embodiments the one or more light generating devices may comprise two different types of light generating devices, differing in the type of polarization of the device light they generate; wherein the light generating system further comprises a first polarizing beam splitter, wherein the first polarizing beam splitter is configured downstream of the two different types of light generating devices and upstream of the central optics; and wherein the first polarizing beam splitter is configured to transmit (at least part of the) s-polarized light or p-polarized light, and to reflect (at least part of the) p-polarized light or (at least part of the) s-polarized light. Especially, the control system may be configured to control the two different types of light generating devices.

In order to further increase input power and/or to provide a further control options, more than one type of light generating device may be applied, wherein at least two types differ in the polarized light they provide. For instance, in embodiments one of the types may e.g. have primarily s-polarized light, and another one of the types may e.g. have primarily p-polarized light. A polarizing beam splitter may be used to combine the beams of the two types of light generating devices. Hence, the term light generating device may also refer to one or more primary light generating device and one or more secondary light generating devices. Therefore, in embodiments the system may comprise a primary light generating device and a secondary light generating device, wherein the device light of one of the primary light generating device and the secondary light generating device, comprises more s-polarized than the other one of the primary light generating device and the secondary light generating device, wherein the light generating system further comprises second optics, configured downstream of the primary light generating device and the secondary light generating device, and configured upstream of the first optics, wherein the second optics comprises a first polarizing beam splitter, wherein the first polarizing beam splitter is configured to transmit (at least part of the) s-polarized light or p-polarized light, and to reflect (at least part of the) p-polarized light or (at least part of the) s-polarized light. For instance, in embodiments the device light of the other one of the primary light generating device and the secondary light generating device, comprises more p-polarized than the one of the primary light generating device and the secondary light generating device.

In embodiments, the first polarizing beam splitter may be configured to reflect at least 80% of (first) device light, having a first polarization, of a first type of light generating devices, and transmit at least 80% of (second) device light, having a second polarization, of a second type of light generating devices. Especially, the first device light and second device light may thus have—in embodiments—different polarizations (and optionally also different spectral power distributions), like having first device light having s polarization or p polarization, and the second device light having p polarization or s polarization (i.e. the polarization chosen different from the first polarization). More especially, in embodiments the first polarizing beam splitter may be configured to reflect at least 90% of (first) device light, having a first polarization, of a first type of light generating devices, and transmit at least 90% of (second) device light, having a second polarization, of a second type of light generating devices. Percentages may be based on energy (Watt).

One or more primary light generating devices, especially a plurality of primary light generating device, may be configured in a laser bank, wherein the primary light generating devices comprise laser diodes. Alternatively or additionally, one or more secondary light generating devices, especially a plurality of secondary light generating device may be configured in a laser bank, wherein the secondary light generating devices comprise laser diodes. The laser banks may be different laser banks, though a configuration in the same laser bank may also be possible.

Alternatively or additionally, in order to further increase input power and/or to provide a further control options, more than one type of light generating device may be applied, wherein at least two types differ in the spectral power distribution they provide. One of the types may have a different wavelength than the other one, such as a different peak wavelengths, and a dichroic beam splitter may be used to combine the beams of the two types of light generating devices. When using a (simple) cut-on or cut-off dichroic pass filter, in combination with a polarizing beam splitter (PBS) e.g. up to four light source beams may be combined within the same etendue (i.e., may be projected within the same spot and angular range on the phosphor). Especially, for the type of light generating devices having device light with the largest peak wavelength this largest peak wavelength is the first peak wavelength as described herein. Any further type of light generating device may generate first device light have the same peak wavelength or a peak wavelength at smaller wavelengths. Further, for all types of light generating devices may the conditions apply as described herein in relation to the light generating device.

Therefore, in (other) embodiments, the one or more light generating devices may comprise two different types of light generating devices, differing in a spectral power distribution of the device light they generate, wherein the light generating system may further comprises a first dichroic beam splitter, wherein the first dichroic beam splitter may be configured downstream of the two different types of light generating devices and upstream of the central optics, wherein the first dichroic beam splitter may be configured (a) to transmit or reflect at least part of the device light of a first type, and (b) to reflect or transmit at least part of the device light of a second type. Especially, the control system may be configured to control the two different types of light generating devices.

In embodiments, the first dichroic beam splitter may be configured to reflect at least 80% of (first) device light of a first type of light generating devices, and transmit at least 80% of (second) device light of a second type of light generating devices. Especially, the first device light and second device light may thus have—in embodiments—different spectral power distributions (and optionally also different polarizations), like having centroid wavelengths differing at least 10 nm, such as at least about 15 nm. More especially, in embodiments the first dichroic beam splitter may be configured to reflect at least 90% of (first) device light of a first type of light generating devices, and transmit at least 90% of (second) device light of a second type of light generating devices. Percentages may be based on energy (Watt).

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

Hence, in embodiments the one or more light generating devices may comprise a first light generating device and a second light generating device. The first light generating device may be configured to generate first device light having a first centroid wavelength. The second light generating device may be configured to generate second device light having a second centroid wavelength. Especially, both the first centroid wavelength and the second centroid wavelength may be is selected from the wavelength range of 400-480 nm. In specific embodiments, the first device light may be blue light. Yet, in specific embodiments, the second device light may be blue light.

Especially, the first device light may have a first peak wavelength kl. In specific embodiments, the first peak wavelength λ1 is selected from the blue wavelength range. Further, especially, the second device light has a second peak wavelength λ2. In specific embodiments, the second peak wavelength λ2 is selected from the blue wavelength range.

In embodiments the first device light may comprise one or more of polarized light having a p polarization and polarized light having an s polarization. Hence, in embodiments the first device light may be elliptically polarized. Optionally, the polarization of the first device light may be controllable, such as using one or more of (i) polarization control optics, and (ii) using two or more first light generating devices generating device light having different (linear or elliptical) polarizations. However, as indicated below, the polarization may especially (also) be controlled by the polarization control element. In embodiments, the first light generating device comprises a first light source selected from a laser diode and a superluminescent diode. Hence, especially the first light generating device comprises a solid state light source. More especially, the first device light is laser light. Herein, especially the first device light comprises-polarized light, whereas the first device light may comprise polarized light. Hence, the first device light as generated by the first light generating device may especially have a net polarization.

In embodiments the second device light may comprise one or more of polarized light having a p polarization and polarized light having an s polarization. Hence, in embodiments the second device light may be elliptically polarized. Optionally, the polarization of the second device light may be controllable, such as using one or more of (i) polarization control optics, and (ii) using two or more second light generating devices generating device light having different (linear or elliptical) polarizations. However, as indicated below, the polarization may especially (also) be controlled by the polarization control element. In embodiments, the second light generating device comprises a second light source selected from a laser diode and a superluminescent diode. Hence, especially the second light generating device comprises a solid state light source. More especially, the second device light is laser light. Herein, especially the second device light comprises-polarized light, whereas the first device light may comprise polarized light. Hence, the second device light as generated by the second light generating device may especially have a net polarization.

In embodiments, |λ1−λ2|≥3 nm, such as |λ1−λ2|≥4 nm|, more especially λ1−λ2|≥5 nm. More especially, |λ1−λ2|≥10 nm, or even |λ1−λ2|≥15 nm. Yet, in embodiments 10 nm≤|λ₁−λ2|≤50 nm. In specific embodiments, the first peak wavelength may be selected at a spectral position of maximum absorption of the luminescent material, and the second peak wavelength thus at a position of at least 5 nm, more especially at least 10 nm, blue shifted or red shift, especially red shifted. Hence, in embodiments λ2>λ1. This may be useful in view of the use of the dichroic beam splitter used in the central optics (see also below). In other embodiments, the first peak wavelength and the second peak wavelength may both be selected at a spectral position offset from maximum absorption of the luminescent material. For instance, one may be a blue shifted relative to the maximum absorption and the other one may be red shifted relative to the maximum absorption.

Assuming the use of laser, the difference between first peak wavelength and the second peak wavelength may be relatively small. Especially, the first peak wavelength and the second peak wavelength, and the first optics, may be selected such that the two peak wavelengths are spectrally positioned at two opposite sides of a cut-on/cut-off wavelength of a dichroic filter comprised by the first optics. Hence, the first peak wavelength and the second peak wavelength, and the first optics may be selected such, that the first optics may spectrally separate them, and essentially transmit one and essentially reflect the other.

Hence, the first device light and second device light may have different spectral power distributions and/or different color points. Note that for the first device light and the second device light, the differences in centroid wavelengths may be relatively small, such as selected from the range of 3-50 nm, such as selected from the range of 5-50 nm, like selected from the range of 5-40 nm. Hence, in embodiments the difference in centroid wavelength of the first device light and second device light herein may in embodiments be no larger than about 50 nm.

When using two or more different types of light generating devices differing in spectral power distribution of the respective device light, the polarizations of the respective device light may be the same. With the polarization control element, the polarization can be controlled (see also above). However, as indicated above, in other embodiments two or more different types of light generating devices differing in respective polarizations of the device light (and not necessarily also differing in spectral power distribution of the respective device light) may be applied. Then, a polarization control element is not necessarily used, as the via power control, the polarization of the device light can be controlled. However, it is of course also possible to use two or more different light generating devices, with device light differing in spectral power distribution and polarization. Optionally, a polarization control element may be applied.

When increasing the device light power by using two (or more) light generating devices of which the device light differ in polarization, this may be indicated as polarization multiplexing. In such embodiments, a polarizing beam splitter may be applied to combine the beams of device light having different polarizations. Further polarization control downstream of the polarizing beam splitter, such as via a polarization rotator (like a ½λ waveplate) may not be necessary, but is herein also not excluded. When increasing the device light power by using two (or more) light generating devices of which the device light differ in spectral power distribution, this may be indicated as dichroic multiplexing. In such embodiments, a dichroic beam splitter may be applied to combine the beams of device light having different spectral power distributions. Further polarization control downstream of the polarizing beam splitter, such as via a polarization rotator (like ½λ waveplate) may then be necessary desirable. Note that also a combination of dichroic and polarizing multiplexing may be applied, where downstream of the polarizing beam splitter or the dichroic beam splitter, used to combine the two (or more beams), a polarization rotator (like a ½λ waveplate) may (optionally) be configured. The polarization rotator allows (further) control of (effectively) the spectral power distribution of the system light. An embodiment of the polarization rotator is (thus) a birefringent rotator.

Here below, some further embodiments in relation to the central optics are described.

Especially, in embodiments, device light reaching the central optics may be reflected and/or transmitted by the central optics polarizing beam splitter. Especially, (a) the polarization of the device light and (b) the central optics polarizing beam splitter may be configured such that (i) at least part of the device light propagates to the first luminescent material, and (ii) at least part of the first luminescent material light may escape from the system via the central optics. Alternatively or additionally, especially, (a) the polarization of the device light and (b) the central optics polarizing beam splitter may be configured such that (i) at least part of the device light propagates to the reflector (and optional second luminescent material), and (ii) at least part of the diffused device light (and at least part of optional the second luminescent material light and) may escape from the system via the central optics. This may e.g. imply that the central optics polarizing beam splitter may at least partially be transmissive for a first polarization and at least partially reflective for a second polarization, or, the other way around, this may e.g. imply that the central optics polarizing beam splitter is at least partially transmissive for a second polarization and at least partially transmissive for a second polarization.

As indicated above, the system may especially be configured such that diffused device light propagating to the central optics and first luminescent material light propagating to the central optics have a mutual angle of (about) 90°. Hence, in embodiments first luminescent material light reaching the central optics may be reflected or transmitted at the central optics dichroic beam splitter. The central optics dichroic beam splitter may be configured such that (a) diffused device light may be reflected at the central optics dichroic beam splitter when the central optics dichroic beam splitter is configured to transmit the first luminescent material light, and/or (b) diffused device light may be transmitted at the central optics dichroic beam splitter when the central optics dichroic beam splitter is configured to reflect the first luminescent material light. Therefore, in embodiments the system may especially be configured such that diffused device light and first luminescent material light propagating orthogonal to the central optics may escape (in the same direction) from the system via the central optics to provide system light comprising the diffused device light and first luminescent material light. System light may escape from a light exit of the system (see also above).

Especially, (a) the centroid wavelength and/or peak wavelength of the device light, and the centroid wavelength of the optional second luminescent material light and (b) the centroid wavelength of the first luminescent material may be selected such that the peak wavelength and/or centroid wavelength of the device light and the centroid wavelength of the optional second luminescent material light on the one hand and the centroid wavelength of the first luminescent material light on the other hand are spectrally positioned at two opposite sides of a cut-on/cut-off wavelength of a dichroic filter comprised by the central optics. Hence, the peak wavelength and/or centroid wavelength of the device light, as well as the centroid wavelength of the optional second luminescent material light on the one hand, and the centroid wavelength of the first luminescent material on the other hand, may be selected such, that the central optics dichroic beam splitter may spectrally substantially separate them, and essentially transmit one and essentially reflect the other.

Further, in embodiments, the central optics dichroic beam splitter may be configured (a) to transmit or reflect at least 70% of the device light received by the central optics dichroic beam splitter, more especially at least 80%, such as at least 90% (like even at least about 95%). Alternatively or additionally, the central optics dichroic beam splitter may be configured (b) to reflect or transmit at least 70% of the first luminescent material light received by the central optics dichroic beam splitter, more especially at least 80%, such as at least 90% (like even at least about 95%). Yet, in embodiments, the central optics dichroic beam splitter may be configured (c) to transmit or reflect at least 70% of the reflected device light and optional second luminescent material light received by the central optics dichroic beam splitter, more especially at least 80%, such as at least 90%. Note that when the central optics dichroic beam splitter is configured to reflect at least part of the device light and at least part of the reflected device light and at least part of the optional second luminescent material light, it may also be configured to transmit at least part of the first luminescent material light. Likewise, when the central optics dichroic beam splitter is configured to transmit at least part of the device light and at least part of the reflected device light and at least part of the optional second luminescent material light, it may also be configured to reflect at least part of the first luminescent material light. Hence, a condition of (λ_{cd}+10 nm)≤λ_{c2}≤(λ_{c1}−10 nm), such that the dichroic beam splitter splits somewhere between λ_{c2} and λ_{c1}, may apply.

The polarizing beam splitter comprised by the central optics may be configured to transmit part of the s-polarized light and reflect part of the s-polarized light. Likewise, it may be configured to reflect at least part of the p-polarized light and transmit at least part of the p-polarized light. The percentage of transmission and reflection for the respective polarization may be defined by the polarizing beam splitter.

Basically, there may be two types of embodiments of the polarizing beam splitter comprised by the central optics.

In first embodiments, the polarizing beam splitter comprised by the central optics may be configured to transmit essentially all device light having a first polarization and reflect essentially all device light having a second polarization (i.e. thus the polarizing beam splitter may also be configured in (other/equivalent) embodiments to reflect essentially all device light having a first polarization and transmit essentially all device light having a second polarization.

In second embodiments, the polarizing beam splitter comprised by the central optics may be configured to transmit essentially all device light having a first polarization, transmit part of the light having a second polarization, and reflect part of the device light having the second polarization. In (other) second embodiments, the polarizing beam splitter comprised by the central optics may be configured to reflect essentially all device light having a first polarization, reflect part of the light having a second polarization, and transmit part of the device light having the second polarization. Further note that first and second are only used to indicate that there are different polarizations. Would the first polarization be s polarization, the second polarization is p polarization. However, would the first polarization be selected to be p polarization, the second polarization is s polarization. Such polarizing beam splitter comprised by the central optics according to the second embodiments may also be indicated as partially polarizing beam splitters.

An example of such partially polarizing beam splitter is e.g. a broadband partially polarizing beam splitter that at 450 nm transmits about 77% of p-polarized light and substantially no s-polarized light, while it may reflect ca. 10% of p-polarized light and 86% of s-polarized light.

Especially, in embodiments the central optics polarizing beam splitter may be configured such that for one polarization the transmittance is not complete, and thus may be partly reflected, whereas for the other polarization, the reflectance may be relatively high, and thus may have a small transmission or essentially no transmission. However, this may also be the other way around.

In specific embodiments, the central optics polarizing beam splitter may be configured to transmit x % of light having p polarization and reflect y % of light having s polarization, wherein one of x % and y % is selected from the range of 15-80%, and the other one of x % and y % is selected from the range of 85-100%. However, other embodiments are herein not excluded.

In specific embodiments, the central optics polarizing beam splitter may be configured to reflect x1% of light having first polarization, reflect y1% of light having a second polarization, and transmit z1% of light having the second polarization. In embodiments, x1 may be selected from the range of at least 80% (such as at least 90%, like in embodiments (essentially) 100%), y1 is selected from the range of 0-95%, and z1 is selected from the range of 5-100%. In specific embodiments, y1 is selected from the range of 0-90%, and z1 is selected from the range of 10-100%. In more specific embodiments, x1 may be selected from the range of at least 80%, y1 is selected from the range of 20-90%, and z1 is selected from the range of 10-80%. In yet more specific embodiments, x1 may be selected from the range of at least 85%, y1 is selected from the range of 25-90%, and z1 is selected from the range of 10-75%. In yet more specific embodiments, x1 may be selected from the range of at least 90%, y1 is selected from the range of 30-90%, and z1 is selected from the range of 10-70% (more especially at least 20%). Hence, 100%−x1 of the light having the first polarization may be transmitted. In embodiments, the first polarization is s polarization and the second polarization is p polarization (in aforementioned examples).

Hence, in embodiments the central optics polarizing beam splitter may be configured to transmit a larger part of the p-polarized light than a part of the s-polarized that is reflected. In other embodiments, the central optics polarizing beam splitter may be configured to transmit a larger part of the s-polarized light than a part of the p-polarized that is reflected. In yet other embodiments, the central optics polarizing beam splitter may be configured to reflect a larger part of the s-polarized light than a part of the p-polarized that is transmitted. In yet other embodiments, the central optics polarizing beam splitter may be configured to reflect a larger part of the p-polarized light than a part of the s-polarized that is transmitted. Hence, the central optics polarizing beam splitter may especially be a partially polarizing beam splitter.

Especially, in embodiments (the central optics, more especially) the central optics polarizing beam splitter, may be configured to (a) reflect at least 90% device light when having a first polarization, (b) reflect selected from the range of 20-80% device light when having a second polarization, and (c) transmit selected from the range of 80-20% device light when having the second polarization. As indicated above, in embodiments the first polarization may in embodiments be s or p polarization, and the second polarization may be p or s polarization. However, other embodiments may also be possible.

Yet, in embodiments the central optics may be configured to reflect or transmit at least part of the device light having a first polarization and to transmit or reflect at least part of the diffused device light having a second polarization.

As indicated above, in embodiments the system may also comprises a second luminescent material. Especially, the second luminescent material may be configured to convert at least part of the device light received by the second luminescent material into second luminescent material light having a second luminescent material light spectral power distribution. The phrase “to convert at least part of the device light received by the second luminescent material into second luminescent material light” may thus indicate that when at least part of device light indeed irradiates the second luminescent material (in an operational mode of the light generating system), then at least part of that device light may be converted into second luminescent material light. Whether the device light may reach the second luminescent material may depend upon the polarization of the device light.

In embodiments, the second luminescent material may be operated in the reflective mode. In other embodiments, however, the second luminescent material may be operated in a transmissive mode (see further also below). Other luminescent materials may in embodiments also be operated in the reflective mode (or in other embodiments in the transmissive mode).

In embodiments, the second luminescent material light spectral power distribution may be different from the first luminescent material light spectral power distribution (and also different from the device light). Hence, none of the first spectral power distribution and the spectral power distribution may fully overlap the other. Especially, the color points may differ. Hence, in embodiments also the centroid wavelengths may differ. Hence, the first luminescent material light, the second luminescent material light, and the device light may have mutually different spectral power distributions.

In embodiments, wherein the device light has a device light centroid wavelength λ_{cd}, the first luminescent material light has a first luminescent material light centroid wavelength λ_{c1}, and the second luminescent material light has a second luminescent material light centroid wavelength λ_{c2}, especially (λ_{cd}+5 nm)≤_{c2}≤(λ_{c1}−5 nm), more especially (λ_{cd}+10 nm)≤λ_{c2}≤(λ_{c1}−10 nm). Yet, in embodiments wherein (λ_{cd}+15 nm)≤λ_{c2}≤(λ_{c1}−50 nm). Further, in embodiments the device light centroid wavelength λ_{cd} may be selected from the wavelength range of 400-480 nm. Alternatively or additionally, in embodiments the first luminescent material light centroid wavelength λ_{c1} may be selected from the wavelength range of 490-780 nm. Yet alternatively or additionally, in embodiments the second luminescent material light centroid wavelength λ_{c2} may be selected from the wavelength range of 450-520 nm. Hence, the device light may in embodiments especially be selected from the violet-blue wavelength range. For instance, at least 80% of the spectral power distribution of the device light may be in the violet-blue wavelength range. Further, the first luminescent material light may essentially have intensity in the entire visible wavelength range above about 450 nm. For instance, at least 80% of the spectral power distribution of the first luminescent material light may be in the wavelength range of 450-780 nm. However, especially any luminescent material that may qualify as first luminescent material may provide (first) luminescent material light having a first centroid wavelength larger than the second centroid wavelength of (second) luminescent material light of any luminescent material that may qualify as second luminescent material. As indicated above, in embodiments λ_{c2}≤(λ_{c1}−10 nm), more especially λ_{c2}≤(λ_{c1}−50 nm). The first luminescent material light may (thus) in embodiments emit in the green-red wavelength range. The second luminescent material may emit in about the blue-cyan wavelength range, especially in the 450-520 nm wavelength range. For instance, at least 80% of the spectral power distribution of the second luminescent material light may be in the wavelength range of 450-520 nm. Even though the wavelength range for the second luminescent material light may overlap with the wavelength range for the second luminescent material light, the luminescent materials may especially be selected such that there may be no full overlap. For that reason, the centroid wavelengths are also chosen differently. The first luminescent material light may have a centroid wavelength that is (substantially) larger than the second luminescent material light. Further, in embodiments (λ_{cd}+20 nm)≤λ_{c2}, or even (λ_{cd}+20 nm)≤)λ_{c2}. For instance, the device light may be blue light, the second luminescent material light may be cyan light, and the first luminescent material may consist of one or more of green light, yellow light, orang light, and red light.

In specific embodiments, the first luminescent material may at least comprise a luminescent material of the type A₃B₅O₁₂:Ce, wherein A comprises one or more of Y, La, Gd, Tb and Lu, and wherein B comprises one or more of Al, Ga, In and Sc. Alternatively or additionally, in embodiments the second luminescent material may at least comprise one or more of Na_{0.5}K_{0.5}Li₃SiO₄:Eu²⁺, MSi₂O₂N₂:Eu²⁺, wherein M comprises one or more of Ba, Sr, and Ca (especially wherein M at least comprises Sr), Sr[Be₆ON₄]:Eu²⁺, and MAl₂O₄:Eu²⁺, wherein M comprises one or more of Ba, Sr, and Ca (especially wherein M at least comprises Sr). In embodiments, the second luminescent material may comprise MBe_{6-y-z}Mg_{y}Al_{z}O_{1-z}N_{4+z}:RE, wherein M comprises one or more of Ba, Sr, and Ca (especially wherein M at least comprises Sr), and wherein RE comprises one or more of Eu²⁺ and Ce³⁺, and wherein 0≤y≤2; 0≤z≤1, of which Sr[Be₆ON₄]:Eu²⁺ is an example.

The second luminescent material may be comprised by the second ring-shaped section.

With respect to the second ring-shaped section, several options may be possible.

In embodiments, the reflector and the second luminescent material may be configured adjacent to each other. At least part of the device light that propagates in the direction of the second ring-shaped section may be received by both the reflector and the second luminescent material (i.e. part may be received by the reflector and part may be received by the second luminescent material).

The reflector may comprise one or more reflector parts and/or the second luminescent may be configured in one or more second luminescent material parts. Hence, the reflector and luminescent material may be configured in a 1D (or 2D) array of reflector parts second luminescent material parts. Therefore, in embodiments the second ring-shaped section may comprise an array of alternating reflectors and second luminescent material areas comprising the second luminescent material. At least part of the device light that propagates in the direction of the second ring-shaped section may be received by a plurality of reflectors and by a plurality of and second luminescent material areas (i.e. part may be received by a plurality of reflectors and part may be received by a plurality of and second luminescent material areas). The dimensions, such as length or width of the alternating reflectors and second luminescent material areas may be selected from the range of about 0.01-1 mm, such as 0.05-0.5 mm.

In embodiments, the second luminescent material may be configured on the reflector, with the second luminescent material at least partly being transmissive for the device light that reaches the luminescent material and/or the second luminescent comprising openings. Therefore, in embodiments the second luminescent material may be configured on at least part of the (diffusive) reflector, wherein one or more of the following may apply: (i) the luminescent material only partly covers the reflector, and (ii) the luminescent material is (also) configured to transmit part of the device light received by the luminescent material.

Further, in embodiments the luminescent material may be configured in thermal contact with a thermally conductive material. For instance, the luminescent material may be configured in thermal contact with a thermally conductive element.

A thermally conductive element may especially comprise thermally conductive material. A thermally conductive material may especially have a thermal conductivity of at least about 20 W/(m*K), like at least about 30 W/(m*K), such as at least about 100 W/(m*K), like especially at least about 200 W/(m*K). In yet further specific embodiments, a thermally conductive material may especially have a thermal conductivity of at least about 10 W/(m*K). In embodiments, the thermally conductive material may comprise one or more of copper, aluminum, silver, gold, silicon carbide, aluminum nitride, boron nitride, aluminum silicon carbide, beryllium oxide, a silicon carbide composite, aluminum silicon carbide, a copper tungsten alloy, a copper molybdenum carbide, carbon, diamond, and graphite. Alternatively, or additionally, the thermally conductive material may comprise or consist of aluminum oxide. In embodiments, the thermally conductive element may comprise one or more of a heatsink, a heat spreader, and a two-phase cooling device. In yet other embodiments, the thermally conductive element may be configured in thermal contact with one or more of a heatsink, a heat spreader, and a two-phase cooling device, and may e.g. transfer heat to such heatsink, heat spreader, or two-phase cooling device, via another thermally conductive element.

An element may be considered in “thermal contact” with another element if it can exchange energy through the process of heat. Hence, the elements may be thermally coupled. In embodiments, thermal contact can be achieved by physical contact. In embodiments, thermal contact may be achieved via a thermally conductive material, such as a thermally conductive glue (or thermally conductive adhesive). Thermal contact may also be achieved between two elements when the two elements are arranged relative to each other at a distance of equal to or less than about 10 μm, though larger distances, such as up to 100 μm may be possible. The shorter the distance, the better the thermal contact. Especially, the distance is 10 μm or less, such as 5 μm or less, such as 1 μm or less. The distance may be the distanced between two respective surfaces of the respective elements. The distance may be an average distance. For instance, the two elements may be in physical contact at one or more, such as a plurality of positions, but at one or more, especially a plurality of other positions, the elements are not in physical contact. For instance, this may be the case when one or both elements have a rough surface. Hence, in embodiments in average the distance between the two elements may be 10 μm or less (though larger average distances may be possible, such as up to 100 μm). In embodiments, the two surfaces of the two elements may be kept at a distance with one or more distance holders. When two elements are in thermal contact, they may be in physical contact or may be configured at a short distance of each other, like at maximum 10 μm, such as at maximum 1 mm. When the two elements are configured at a distance from each other, an intermediate material may be configured in between, though in other embodiments, the distance between the two elements may filled with a gas, liquid, or may be vacuum. When an intermediate material is available, the larger the distance, the higher the thermal conductivity may be useful for thermal contact between the two elements. However, the smaller the distance, the lower the thermal conductivity of the intermediate material may be (of course, higher thermal conductive materials may also be used).

In specific embodiments, the rotatable element may comprise a thermally conductive material, like a thermally conductive disc or thermally conductive cylinder (or a thermally conductive cone).

Especially, in specific embodiments the light generating system may be configured to provide system light comprising one or more of diffused device light, first luminescent material light and optional second luminescent material light. In embodiments, the system light may comprise essentially no device light that has not been reflected at the reflector. Hence, in specific embodiments the system light may essentially not comprise non-diffused device light.

In embodiments, the device light may have a wavelength selected from the blue wavelength range (see also above), more especially have peak wavelengths selected from the blue wavelength range, and in further specific embodiments the first luminescent material light has a wavelength selected from the green-red wavelength range, the optional second luminescent material light is selected from the blue-green wavelength range, and in yet further specific embodiments the system light in the first operational mode is white light.

Especially, the control system may be configured to control a spectral power distribution of the system light. By controlling the polarization of the device light, a ratio of one the one hand the (diffused) reflected device light and the optional second luminescent material light in the system light, and on the other hand the first luminescent material light in the system light may be controlled. Hence, also in this way the spectral power distribution, such as in specific embodiments CCT, may be controlled. In other embodiments, as indicated above, by mechanically controlling where the device light irradiates the rotatable element, a ratio of one the one hand the (diffused) reflected device light and the optional second luminescent material light in the system light, and on the other hand the first luminescent material light in the system light may be controlled.

In specific embodiments, the system light may be white light. Hence, in embodiments, when controlling the polarization control element, the spectral power distribution of the (white) system light may be controlled. In specific embodiments, when controlling one or more of (i) the polarization control element, (ii) a radiant flux of the first device light, and optionally (iii) a radiant flux of the second device light, the spectral power distribution of the (white) system light may be controlled. Therefore, in specific embodiments the correlated color temperature of the system light may be controlled. Yet, in further specific embodiments the control system is configured to control a correlated color temperature of the system light in dependence of one or more of a user interface, a sensor signal, and a timer.

The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL. In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70. In an embodiment, the light source may also provide light source light having a correlated color temperature (CCT) between about 5000 and 20000 K, e.g. direct phosphor converted LEDs (blue light emitting diode with thin layer of phosphor for e.g. obtaining of 10000 K). Hence, in a specific embodiment the light source is configured to provide light source light with a correlated color temperature in the range of 5000-20000 K, even more especially in the range of 6000-20000 K, such as 8000-20000 K. An advantage of the relative high color temperature may be that there may be a relatively high blue component in the light source light.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

Here below, some further embodiments are described.

In embodiments, laser banks may be applied. Laser banks may also be used to boast the input power. Therefore, in embodiments the system may comprise a plurality of light generating devices configured in a laser bank. A laser bank may comprise a light emitting arrangement comprising an (2D) array of a plurality of laser diodes arranged on a thermally conductive carrier and a (lens array having a) plurality of collimator lenses corresponding to the laser diodes such that each laser diode of the plurality of laser diodes comprises a collimator lens for collimating laser light emitted by the laser diode. The arrangement may comprise a package architecture or a canned architecture. In case of the package architecture a laser diode chip array is arranged on the thermally conductive carrier. A plurality of electrodes may be present for electrically connecting the plurality of laser diodes.

Further, the system may in embodiments comprise further optics then described above. The term “optics” may especially refer to (one or more) optical elements. Hence, the terms “optics” and “optical elements” and “optical component” may refer to the same items. The optics may include one or more or mirrors, reflectors, collimators, lenses, prisms, diffusers, phase plates, polarizers, diffractive elements, gratings, dichroics, arrays of one or more of the afore-mentioned, etc. Alternatively or additionally, the term “optics” may refer to a holographic element or a mixing rod. In embodiments, the optics may include one or more of beam expander optics and zoom lens optics. See further above for examples of optics. In embodiments, the optics may comprise an integrator, like a “Koehler integrator” (or “Kohler integrator”). In specific embodiments, the system may further comprise one or more of integrating optics, collimation optics, and homogenization optics. One or more of them are also depicted in the accompanying drawings.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In yet a further aspect, the invention also may provide a lamp or a luminaire comprising the light generating system as defined herein. The luminaire may further comprise a housing, optical elements, louvres, etc. etc. . . . . The lamp or luminaire may further comprise a housing enclosing the light generating system. The lamp or luminaire may comprise a light window in the housing or a housing opening, through which the system light may escape from the housing. In yet a further aspect, the invention also may provide a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also may provide a lighting device selected from the group of a lamp, a luminaire, a projector device, a disinfection device, a photochemical reactor, and an optical wireless communication device, comprising the light generating system as defined herein. The lighting device may comprise a housing or a carrier, configured to house or support, one or more elements of the light generating system. For instance, in embodiments the lighting device may comprise a housing or a carrier, configured to house or support one or more of the first light generating device, second light generating device, and one or more of the afore-mentioned optics. The lighting device may also be an automotive lighting device, such as a headlamp (or headlight) of a motorized vehicle (like a car, a truck, a bus, a coach, a tractor, a boat, an airplane, etc.).

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to visible light.

The term “centroid wavelength”, also indicated as kc, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=Σλ*I(λ)/(ΣI(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depict some embodiments and aspects of the (embodiments of) the light generating system;

FIGS. 2a-2b schematically depict some (other) embodiments and (other) aspects of the (embodiments of) the light generating system;

FIG. 3 shows a possible spectral power distribution;

FIGS. 4 and 5a-5b schematically shows some variants;

FIGS. 6a-6f schematically depict some (other) embodiments and (other) aspects of the (embodiments of) the light generating system; and

FIG. 7 schematically shows a further variant.

FIG. 8 schematically depicts some application embodiments.

The schematic drawings are not necessarily to scale.

### DETAILED DESCRIPTION OF THE EMBODIMENTS

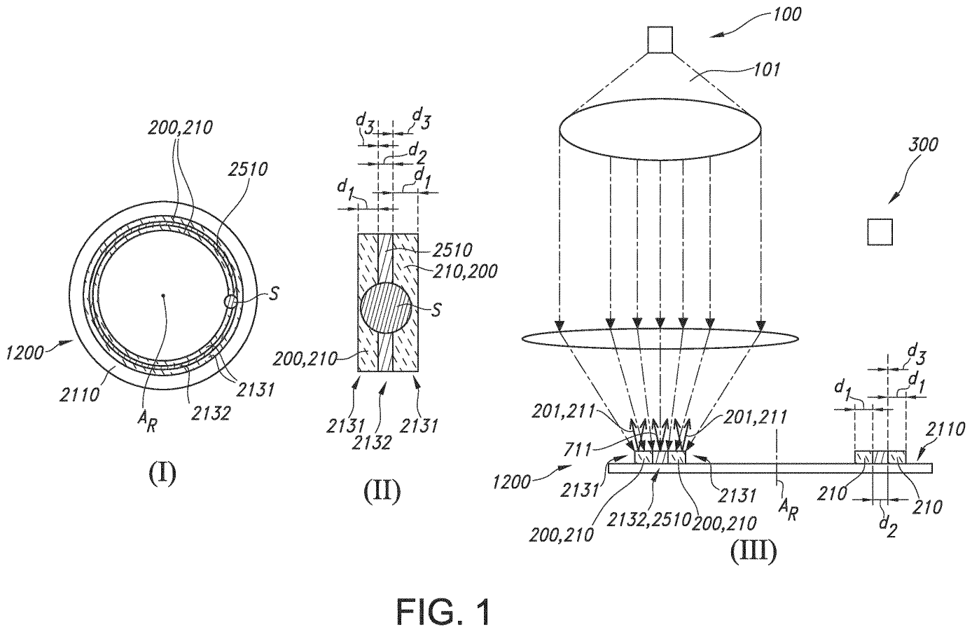

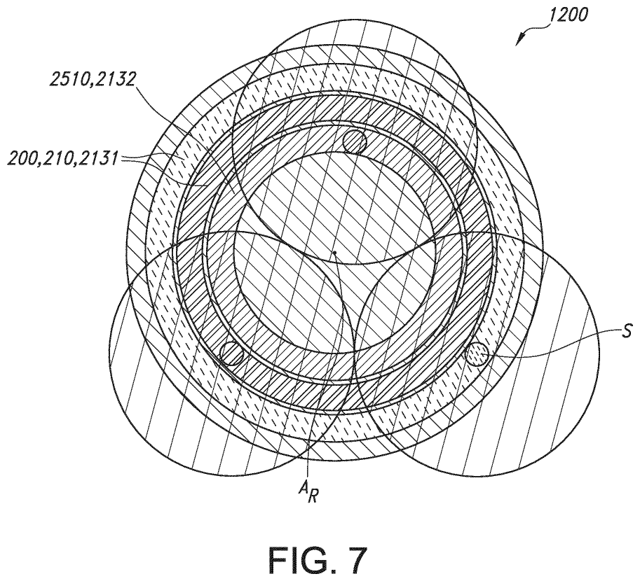

Referring to FIGS. 1-7 embodiments of and variants on elements of the light generating system, herein indicated with reference 1000, are schematically depicted.

In specific embodiments the light generating system 1000 comprises (i) one or more light generating devices 100, (ii) a first luminescent material 210, (iii) a reflector 2510, (iv) a rotatable element 1200, (v) and a control system 300. Luminescent material as such is indicated with reference 200; the first luminescent material is indicated with reference 210; the optional second luminescent material (see below) is indicated with reference 220.

The one or more light generating devices 100 are configured to generate device light 101. The one or more light generating devices 100 may comprise one or more of a laser diode and a superluminescent diode. The first luminescent material 210 may be configured to convert at least part of the device light 101 received by the first luminescent material 210 into first luminescent material light 211. The reflector 2510 may be configured to reflect at least part of the device light 101 received by the reflector 2510 into reflected device light 711.

The rotatable element 1200 may comprise a first ring-shaped section 2131 (at an outer face 2110 of the rotatable element 1200), and a second a ring-shaped section 2132 (also at the outer face 2110 of the rotatable element 1200). The first luminescent material 210 may be comprised by at least part of the first ring-shaped section 2131. The reflector 2510 may be comprised by at least part of the second ring-shaped section 2132.

The light generating system 1000 may be configured such that (a) in an operational mode of the light generating system 1000 the rotatable element 1200 rotates, such that over time different parts of the first ring-shaped section 2131 and/or different parts of the second ring-shaped section 2132 are irradiated by the device light 101, and (b) a distribution of the device light 101 over the first ring-shaped section 2131 and the second ring-shaped section 2132 may be optically and/or mechanically controllable. Further, the light generating system 1000 may be configured to generate system light 1001 comprising one or more of the first luminescent material light 211 and the reflected device light 711. Especially, the control system 300 may be configured to control a spectral power distribution of the system light 1001 by optically and/or mechanically controlling the distribution of the device light 101 over the first ring-shaped section 2131 and the second ring-shaped section 2132. Reference S especially indicates the full width half maximum spot size.

In embodiments the rotatable element 1200 may comprise a disc-like shape (see e.g. FIG. 1) or the rotatable element 1200 may comprise a cylindrical shape.

FIG. 1, embodiment I schematically depicts a top view. By way of example, the second ring-shaped section 2132 is enclosed by two first ring-shaped sections 2131. In this way, the reflector 2510 is enclosed between two rings of first luminescent material 210. Embodiment II schematically depicts a detail. The circle in embodiments I and II schematically depicts the spot of the device light 101, such as a laser beam spot. The spot size may be defined by the full width half maximum. Embodiment III schematically depicts part of the system in a side view. Embodiments I and II of FIG. 1 shows that the first luminescent material 210 and the (diffusive) reflector 2510 may essentially be spatially separated.

Reference d1 refers to the width of the first ring-shaped section 2131, more especially the width of the first luminescent material 210 therein. References d2 refers to the width of the second ring-shaped section 2132, more especially of the reflector 2510 (and/or option second luminescent material) therein. Reference d3 refers to the distance between the first ring-shaped section 2131 and the second first ring-shaped section 2132 (more especially between the first luminescent material 210 and the reflector 2510 (or second luminescent material). Especially, d1 and/or d2 may be selected from the range of about 0.02-10 mm, such as 0.5-5.0 mm. Further, d3 may be selected from the range of about 0-0.5 mm, such as 0-0.05 mm. Especially, d3<d1 and d3<d2. In other embodiments, however, there may be a gradual cross-over between (first) luminescent material and reflector 2510.

In embodiments, the second ring-shaped section 2132 may comprise an (1D or 2D) array of alternating reflectors 2510 and second luminescent material areas 2220 comprising the second luminescent material 220. Other embodiments are also possible (see below). Characteristic dimensions for 1D or 2D array-type configurations, including regular as well as random patterns, may be in the range of 0.01-1 mm, such as 0.05-0.5 mm. Phosphor material 200 may be printed (e.g. via screen printing or jetting) on a reflector 2510, where the reflector may e.g. be a metallized surface textured glass component.

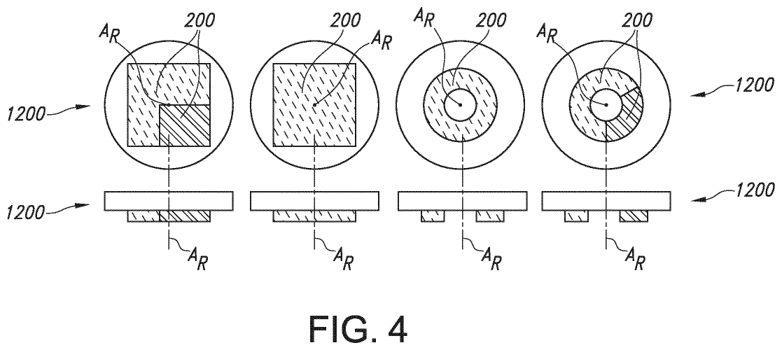

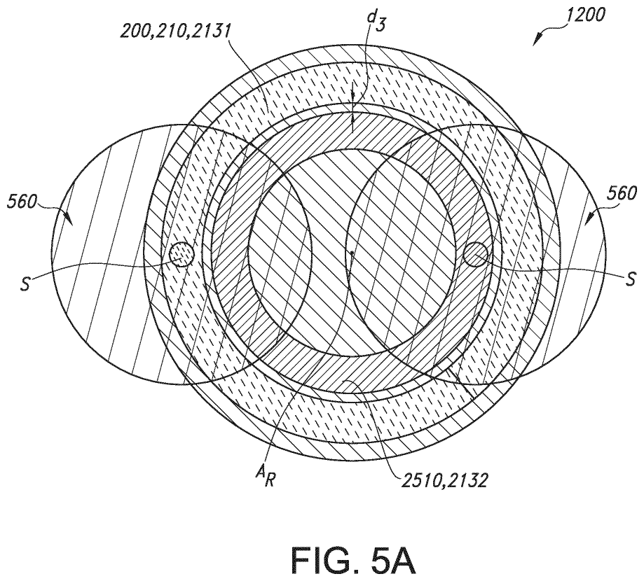

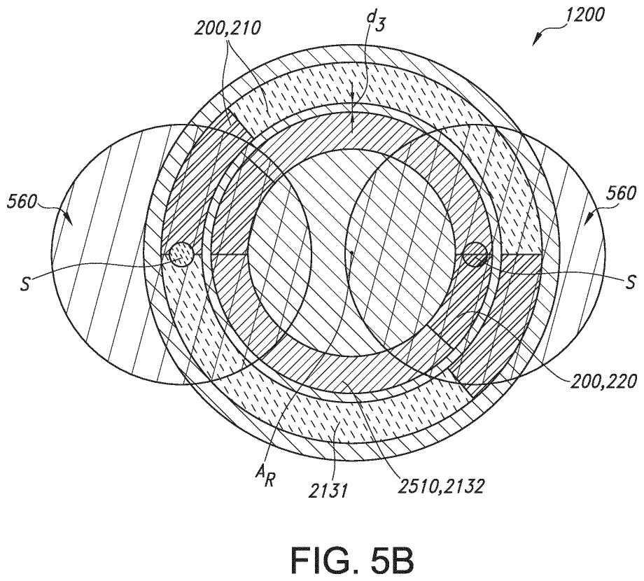

Referring to e.g. FIGS. 1 and 5b, but see also FIGS. 4, 5a, and FIG. 7, in embodiments the light generating system 1000 may comprise at least two different first luminescent materials 210, configured at different parts of the first ring-shaped section 2131. The at least two different first luminescent materials 210 may be configured to convert at least part of the device light 101 received by the (respective) first luminescent materials 210 into first luminescent material light 211. The (respective) first luminescent material light 211 of the at least two different first luminescent materials 210 may have different spectral power distributions. Alternatively or additionally, the light generating system 1000 may comprise a second luminescent material 220. The second luminescent material 220 and the reflector 2510 may be configured in different parts of the second ring-shaped section 2132.

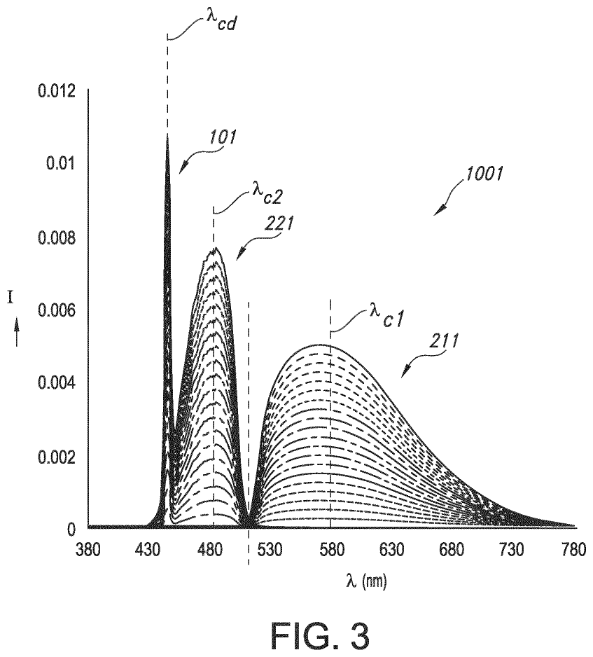

Referring also to FIG. 3, the device light 101 may have a device light centroid wavelength λ_{cd}, the first luminescent material light 211 may have a first luminescent material light centroid wavelength λ_{c1}, and the second luminescent material light 221 has a second luminescent material light centroid wavelength λ_{c2}, wherein (λ_{cd}+10 nm)≤λ_{c2}<(λ_{c1}−10 nm) may apply. In embodiments the device light centroid wavelength λ_{cd} may be selected from the wavelength range of 400-480 nm, the first luminescent material light centroid wavelength λ_{c1} may be selected from the wavelength range of 490-780 nm, the second luminescent material light centroid wavelength λ_{c2} may be selected from the wavelength range of 450-520 nm.

Especially, the reflector 2510 may be configured to diffuse at least part of the device light 101 received by the reflector 2510 thereby providing diffused reflected device light 711.

In specific embodiments, the light generating system 1000 may comprise an actuator 1800 configured to actuate with an actuation the rotatable element 1200. The actuation action may especially be a rotating. Especially, the control system 300 may be configured to control the actuator 1800. Rotation may be about rotational axis A_{R}.

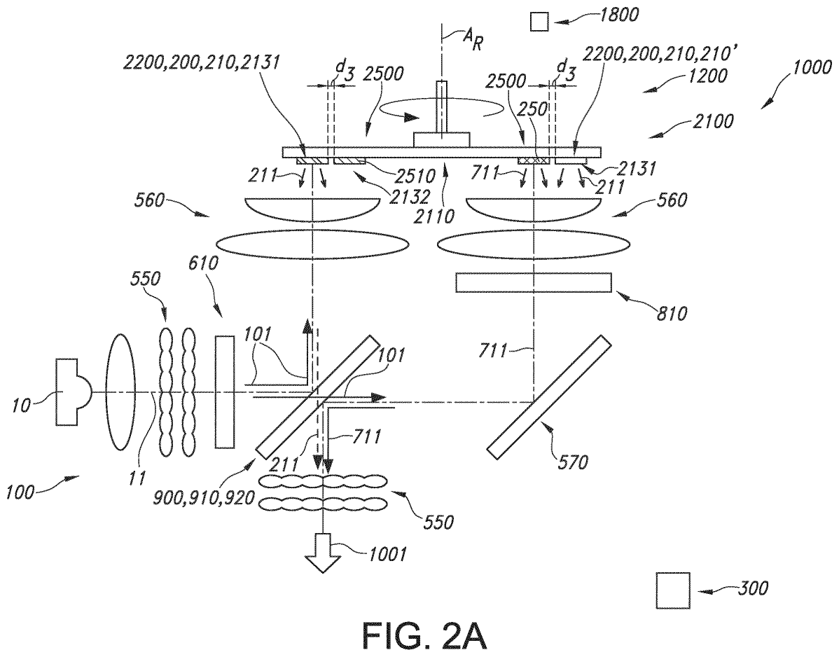

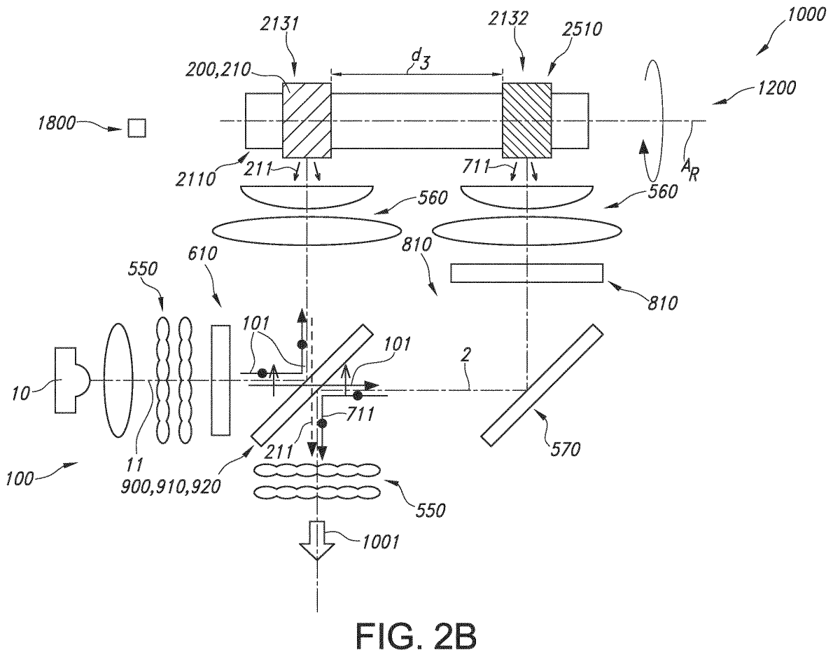

Referring to especially FIGS. 2a-2b, 3-5b, and especially also 6a-6e, in specific embodiments the light generating system 1000 may further comprise central optics 900. Especially, the central optics 900 may have at least a polarizing beam splitter function and a dichroic beam splitter function. Especially, in embodiments the one or more light generating devices 100 are configured to generate polarized device light 101 having a controllable polarization. In specific embodiments, the central optics 900 may comprise (i) a central optics polarizing beam splitter 910, and (ii) a central optics dichroic beam splitter 920. In further specific embodiments, the central optics polarizing beam splitter 910 may be configured to transmit and/or reflect at least part of the device light 101 in dependence of its polarization. In yet further specific embodiments, the central optics dichroic beam splitter 920 may be configured to transmit and/or reflect at least part of the device light 101, at least part of the first luminescent material light 211, and optionally at least part of the second luminescent material light 221, in dependence of their spectral power distributions. Further, the light generating system 1000 may be configured such that (a) at least part of the device light 101, when having a first polarization, propagates from the one or more light generating devices 100 via the central optics 900 to the first ring-shaped section 2131 to provide the first luminescent material light 211, (b) at least part of the device light 101, when having a second polarization, different from the first polarization, propagates from the one or more light generating devices 100 via the central optics 900 to the second ring-shaped section 2132 to provide the reflected device light 711 and/or optionally second luminescent material light 211, and (c) at least part of the first luminescent material light 211 generated by the first luminescent material 210, at least part of the reflected device light 711 generated at the reflector 2510 and/or and optionally at least part of the second luminescent material light 221 generated by the second luminescent material 221, escape from the light generating system 1000 via the central optics 900.

Note that the central optics polarizing beam splitter 910 and/or the central optics dichroic beam splitter may be configured to transmit and/or reflect at least part of the (reflected) device light 711.

Especially, the control system 300 may be configured to control the polarization of the device light 101. Further, in embodiments the light generating system 1000 may be configured to generate system light 1001 comprising one or more of (i) the first luminescent material light 211, and (ii) the reflected device light 711 and/or optionally the second luminescent material light 221. Control of the polarization of the device light may in embodiments via one or more of (a) controlling the radiant flux of two or more light generating devices generating device light having different polarizations and (b) controlling (a rotation of) a polarization control element, such as by controlling a rotation of a birefringent rotator (whereby the polarization can be controlled).

In specific embodiments, the reflector 2510 may be configured to diffuse at least part of the device light 101 received by the reflector 2510 thereby providing the diffused reflected device light 711 while maintaining at least part of the polarization of the device light 101.

In specific embodiments, the light generating system 1000 further may comprise a polarization changing element 810 configured in an optical path of the device light 101 between the central optics 900 and the reflector 2510. In specific embodiments, the polarization changing element 810 may comprise one or more of λ/4 waveplate and a Faraday rotator. Starting with linear s-polarized light, it may be converted by the λ/4 element into e.g. right-handed circular pol. Light, which is converted by the polarization maintaining reflective diffuser into left-handed circular polarized light, which now is converted by the λ/4 element into linear p-polarized light. Likewise, p-polarized light may be converted into diffused s-polarized light. Hence, device light may pass the polarization changing element twice, one time propagating from the central optics to the reflector (diffuser) element, and having a first polarization, and one time propagating from the reflector (diffuser) element to the central optics, being diffused at the reflector (diffuser) element and obtaining a second polarization when passing the polarization changing element (in the direction of the central optics).

Further, in embodiments the light generating system 1000 further may comprise a polarization control element 610. The polarization control element 610 may be configured to control the polarization of the device light 101 received by the polarization control element 610. Especially, the control system 300 may be configured to control the polarization control element 610. In embodiments, the polarization control element 610 may be configured between at least one of the light generating devices 100 and the central optics 900.

Referring to FIG. 2a, the rotatable element comprises a single first ring-shaped section 2131 and a single second ring-shaped section 2132. The first ring-shaped section 2131 comprises luminescent material 200. Here, by way of example two different first luminescent materials 210 are applied, indicated with references 210 and 210′. For instance, the first ring-shaped section 2131 may comprise two or more sections, wherein one or more sections comprising a first luminescent material 210 of a first type (indicated with reference 210) and one or more sections comprising a first luminescent material 210 of another type (indicated with reference 210′). The luminescent material light 211 may have different spectral power distributions for the different types of first luminescent materials 210. Note however, that this embodiment may also be applied with a single luminescent materials 200 applied over 360°. Reference 1800 indicates an actuator, which may rotate the rotatable element 1200. FIG. 2b schematically depicts a similar embodiment as schematically depicted in FIG. 2a. However, FIG. 2a schematically depicts a disc as rotatable element 1200 and FIG. 2b schematically depicts a cylindrical rotatable element 1200. See further also below.

Reference 10 refers to a solid state light source. Especially, this may be a laser diode (or superluminescent diode). The solid state light source may generate polarized light. However, the desired polarization of the light source light of the solid state light source may also be imposed with e.g. a polarized. The device light 101 may essentially consist of the light source light of the light source 10. The polarization of the device light 101 may in embodiments be controlled, such as with the polarizer. In other embodiments, the polarization of the device light 101 is not controlled. The light source light of the solid state light sources 10 is indicated with reference 11. Hence, in embodiments the device light 101 may essentially consist of light source light 11 (especially in embodiments laser light).

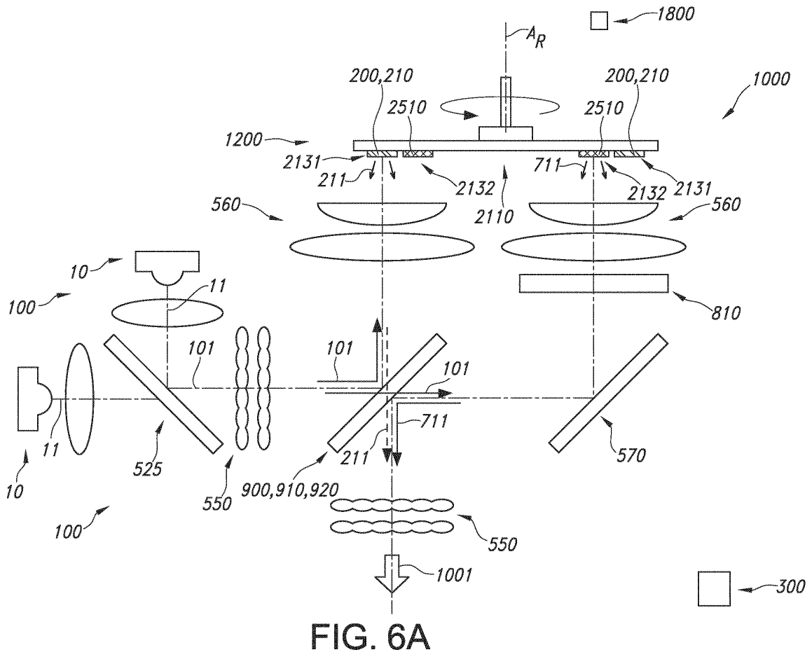

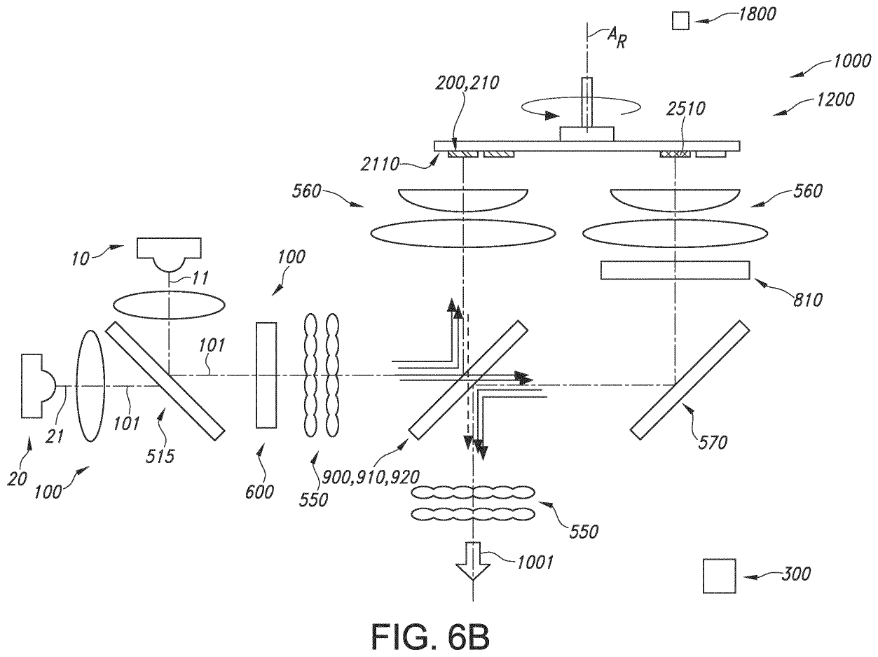

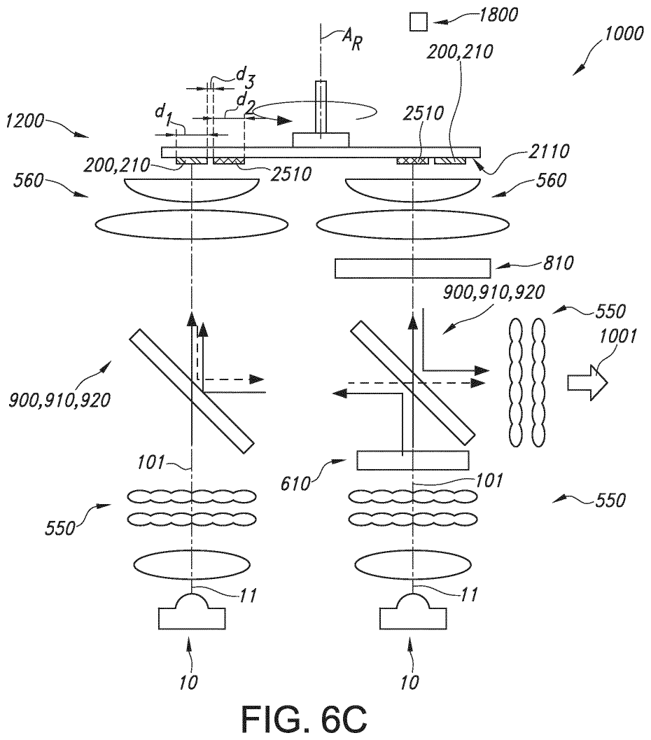

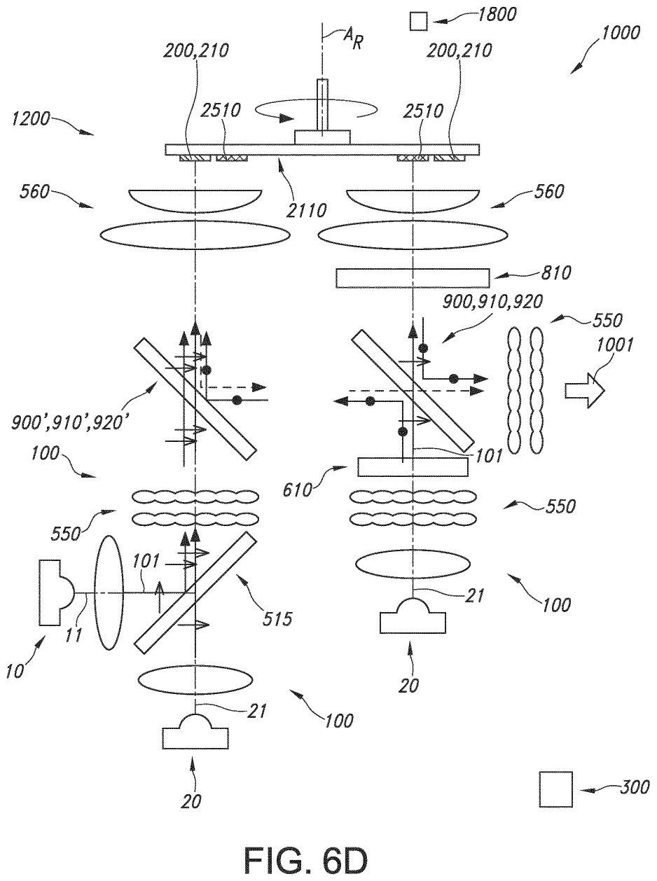

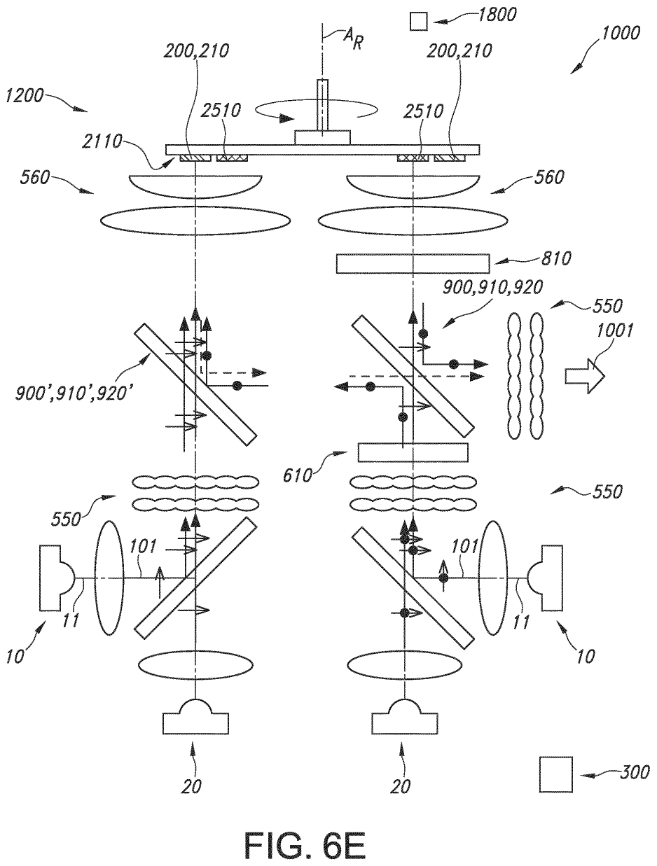

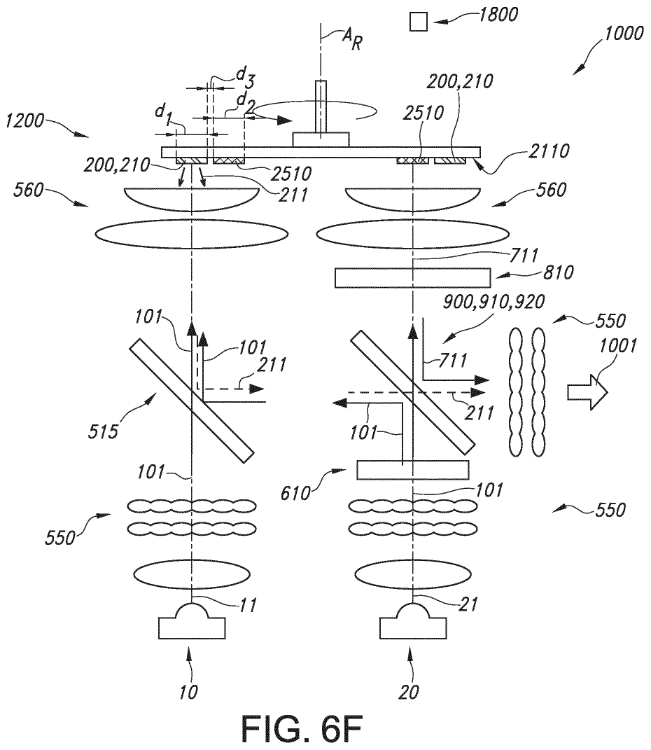

FIG. 2a schematically depicts a basic embodiments, with FIG. 2b showing a variant thereon. FIGS. 6a-6b show further variations on FIG. 2a, all in relation to a disc-like rotatable element 1200, but equally well cylindrical or conical rotatable elements may be chosen.

FIGS. 6a and 6b show variants wherein a kind of multiplexing may be applied, using a plurality of light generating devices 100, wherein combination of the device light is based on (a) using differently polarized device light and combining these with a polarizing beams splitter (e.g. FIG. 6a), or (b) using device light with different spectral power distributions and combining these with a dichroic beam splitter (e.g. FIG. 6b). In FIG. 6a, references 10 may refer to essentially the same type of solid state light sources, but their light source light 11 may differ in polarization (optionally using a polarizer). In FIG. 6b, references 10,20 may refer to solid state light sources configured to generate light source light having different spectral power distributions.

Referring to FIG. 6a, the one or more light generating devices 100 comprise two different types of light generating devices 100, differing in the type of polarization of the device light 101 they generate. The light generating system 1000 further may comprise a first polarizing beam splitter 525. The first polarizing beam splitter 525 may be configured downstream of the two different types of light generating devices 100 and upstream of the central optics 900. The first polarizing beam splitter 525 may be configured to transmit s-polarized light or p-polarized light, and to reflect p-polarized light or s-polarized light. The control system 300 may be configured to control the two different types of light generating devices 100. Especially, the light generating devices 100 may comprise solid state light sources 10. These may provide light source light having different polarizations (but may especially have essentially the same spectral power distributions). In other embodiments, these may, together with polarization optics (not depicted) provide light source light having different polarizations. The device light 101 of the light generating devices 100 may comprise the polarized light source light of the respective solid state light sources 10,10. The polarization of the light source light of the light sources 10,10 may differ, such as reflect p-polarized light or s-polarized light.

Referring to FIG. 6b, the one or more light generating devices comprise two different types of light generating devices 100, differing in a spectral power distribution of the device light 101 they generate. The light generating system 1000 further may comprise a first dichroic beam splitter 515. The first dichroic beam splitter 515 may be configured downstream of the two different types of light generating devices 100 and upstream of the central optics 900. The first dichroic beam splitter 515 may be configured (a) to transmit or reflect at least part of the device light 101 of a first type, and (b) to reflect or transmit at least part of the device light 101 of a second type. The control system 300 may be configured to control the two different types of light generating devices 100.

Especially, the light generating devices 100 may comprise solid state light sources 10,20. These may provide light source light having different spectral power distributions (and may have different or the same polarizations). In other embodiments, these may, together with polarization optics (not depicted) provide light source light having different or the same polarizations. The device light 101 of the light generating devices 100 may comprise the light source light of the respective solid state light sources 10,20.

When using two different blue wavelengths, a polarization control element 610, such as a polarization rotator or half-wave plate may, alternatively, be applied downstream of the first dichroic beam splitter 515 and upstream of the central optics. In the configuration as shown in FIG. 6b the polarization rotator, is indicated with reference 600. Further, the combination of dichroic mixing (FIG. 6b) and polarization mixing (FIG. 6a) is possible as well.

Referring to FIGS. 6a-6f, in (specific) embodiments the central optics polarizing beam splitter 910 may in embodiments be configured to (a) reflect at least 90% device light 101 when having a first polarization, (b) transmit at least 90% device light 101 when having a second polarization. However, in other embodiments the central optics polarizing beam splitter 910 may be configured to (a) reflect at least 90% device light 101 when having a first polarization, (b) reflect selected from the range of 20-80% device light 101 when having a second polarization, and (c) transmit selected from the range of 80-20% device light 101 when having the second polarization. Hence, in embodiments the central optics 900 may be configured to reflect or transmit at least part of the device light 101 having a first polarization and to transmit or reflect at least part of the diffused device light 711 having a second polarization.

In embodiments, the control system 300 may be configured to control one or more of color rendering index and correlated color temperature of the system light 1001. In a controlling mode of the light generating system 1000 the system light 1001 has one or more of (a) a color rendering index of at least 60, such as at least 65, like in specific embodiments at least 80, and a correlated color temperature selected from the range of 3000-8500 K. Higher CRIs may especially be obtained when e.g. more than type of luminescent material is applied.

Note that the first luminescent material may in specific embodiments comprise a combination of two or more different first luminescent materials. Likewise, the optional second luminescent material may in specific embodiments comprise a combination of two or more different second luminescent materials.

In embodiments, the (first and/or second) luminescent material may be configured in thermal contact with a thermally conductive material.

The light generating system 1000 may comprise a plurality of light generating devices 100 configured to generate the device light 101. Two or more of the light generating devices 100 comprise laser light sources configured in a laser bank.

Further, in specific embodiments the light generating system 1000 may in addition comprise one or more of integrating optics, collimation optics, and homogenization optics. For instance, reference 560 refers to lenses, especially used for collimation of light. Reference 550 refers to integrators, which may especially be used to beam shape and homogenize light. However, further optics than schematically depicted may be available.

Herein, reference 550 may refer to one or more of fly-eye lens array pairs (such as schematically depicted), light pipes, volume diffusers, surface diffusers, volume holograms, and surface diffractive elements, which may all be used for homogenization and/or beam shaping.

Laser diode (LD) banks are typically being offered with a center wavelength (WL) of 455 nm or 465 nm. Although the longer wavelength blue LD's show a somewhat lower external quantum efficiency (EQE), or wall plug efficiency (WPE), and optical output power (Pₒₚₜ), the luminous equivalence (LE) is significantly higher thanks to the larger overlap with the eye sensitivity curve. While for a 455 nm line emitter the LE is just below 33 lm/Wₒₚₜ, at 465 nm this is 50 lm/Wₒₚₜ, so this outperforms the difference in EQE. Furthermore, with a longer wavelength blue primary in the overall spectrum the cyan gap as typically present in a laser-phosphor (or LED-phosphor) output spectrum is reduced and with that the CRI is increased. Therefore it is advantageous to use the longer wavelength blue where possible as the blue contribution in the white output light of a light engine. Thanks to the very small etendue of the LDs the laser beams can be collimated very well, and thanks to the narrow spectral width of LDs of only a few nm, dichroic beam splitting and combining is possible for such beams with quite small difference in wavelength of these beams. This may enable configurations in which the longer WL is substantially used as a contribution in the white output light as well as (partly) used for pumping one or more luminescent material 200s. Thanks to the typically quite broad absorption spectra of e.g. garnet or nitride phosphors, these materials can be excited with both the longer and the shorter blue WL laser beams.

Thanks to the application of a birefringent rotator, the color temperature of the output light can be adjusted without substantially changing the light engine output power while keeping the input power constant. Thanks to the use of a partially polarizing beam splitter, the light engine shows high efficiency. Thanks to the configuration that is based purely on diffuse reflected laser light, a light engine with high robustness concerning eye safety may be realized. The use of a dichroic beam splitter in combination with the combined polarizing beam splitter-dichroic beam splitter (PBS-DBS) may enable further increased light engine output flux and radiance.

Hence, amongst others herein in embodiments a color tunable high brightness and high flux light source based on laser phosphor conversion at two different spots and splitting of a blue laser beam by a partially polarizing beam splitter is proposed. Thanks to the use of shifted color primaries towards cyan for the short wavelength primary and towards orange for the long wavelength primary) the color points achieved by the combination are for a larger CCT range close to the BBL, while also the color quality is improved. The blue source may comprise laser diode (LD) or super luminescent diode (SLD) emitters. The system may further be based on diffuse (partial) reflection of blue light, dichroic mixing of at least two spectrally different light beams, an adjustable ratio of two polarization directions of the LD- or SLD-generated light, and an especially (at least partly) polarization maintaining diffuser. With light engine configurations proposed herein, highly efficient collection of the various spectral contributions to the output light may be realized in a compact configuration while the color point of the (white) output light is easily tunable over a relatively large color temperature range of interest with reduced deviation from the BBL and with improved color quality.

Amongst others, herein a light engine architecture is described for providing high flux high brightness speckle-free (white) light that may enable easy factory-calibration with respect to the requested color point and/or easy color point adjustment by the user, where the color point deviation from the BBL may be limited thanks to the chosen color primaries. Color tunability is provided along a line in the chromaticity diagram that is substantially parallel to the black body locus (BBL) in at least the color temperature range of primary interest. The proposed configuration may provide highly efficient collection of all the spectral contributions to the output light, resulting in a high efficiency high brightness light engine. In addition, configurations are provided by which the output flux of the system can be further increased.

High brightness light sources based on blue laser diodes and phosphor wheel have been developed for digital projection lighting and might also be used for (general) lighting applications where high intensity light sources are needed. In such an application a rotating phosphor wheel is used for converting blue laser light to other colors. For example, blue light may be converted to green and red light using corresponding phosphors on the wheel. However, improvements are desired, such as with respect to controllability and intensity. In embodiments, for e.g. producing a white light source based on laser pumped rotating phosphor wheels, we suggest placing the phosphor side by side with a reflective metallic beam shaping (RBS) track. We further suggest placing the RBS between two phosphor tracks such that most of the blue light focused onto RBS are at a normal incidence to this track. In this way after reflection from RBS blue light remains circularly polarized and only the sense of the polarization is altered. In this way white light can be produced with high efficiency.

Amongst others, herein a light generating system comprising a single rotating wheel that provides white light, a dichroic splitter with an additional polarization splitting functionality for blue light, and a source of blue radiation such as a laser diode array, and where the phosphor is placed side by side with a diffuse blue light reflecting polarization conserving track and the combination of these colors produce high quality white light without artifacts and with high efficiency. For the reflective diffusor the use of a reflective metallic beam shaping (RBS) element may be suggested. Such a metallic beam shaping element conserves the polarization state to a large extent and upon reflection reflected blue light can be efficiently combined with converted light to produce white light. In FIG. 1 schematically shows a configuration where the RBS is used with a yellow phosphor side by side in/on a rotating phosphor wheel for producing white light continuously. The RBS may work better when the light falling onto it is not very divergent. Therefore a configuration is suggested wherein the RBS is placed between two phosphor lines. In this way central rays going to fall onto the phosphor for better performance as shown in FIG. 1.

With the proposed phosphor wheel configuration, an attractively simple way to fine-tune the color point may be enabled, i.e. the exact ratio between the blue light and the converted light in the outgoing beam. This is a highly appreciated feature due to e.g. variations in pump wavelength or variations in preferred CCT values in different application segments. For this color point tuning it is herein suggested to enable shifting the position of the rotating disk. In this way the position of the laser spot can be shifted for changing the color temperature. It can be seen that the color temperature of the generated white light increases as it shifts from a first position to a second position, which may correspond with an increase in the relative blue contribution to the outgoing beam.

In alternative embodiments, see also FIG. 4, 5a, 5b, and 7, multiple concentric phosphor rings (first ring-shaped section(s)) may be applied in combination with one or more concentric substantially polarization maintaining (blue) reflector rings (second ring-shaped section(s)). This enables further color point tuning and light quality selection, e.g. by using cyan, green, yellow, orange, and/or red phosphor rings. A further advantage of such application of separate phosphor areas is that this minimizes cross talk and therefor re-absorption, which in phosphor mixtures is a well-known origin of conversion efficiency decrease.

Further, also a basic configuration with multiple derivatives for a compact laser-phosphor light engine providing high flux and high luminance speckle-free output light with a tunable/adjustable color point, all comprising a single spinning component comprising two or more tracks on which corresponding laser spots are projected to convert and to reflect blue light, is herein suggested. Although the sources may be described as laser sources or laser diodes, also super luminescent or other light emitting diodes may be applied. Although there are many different types of laser diodes, such as edge emitting laser diodes, vertical cavity surface emitting laser diodes, and many others, they all may be applied, either as individual emitter or as array(s) of emitters.

FIGS. 2a-2b schematically depict two basic configuration using polarized device light 101. In the spinning wheel configuration, a rotating wheel is used to provide, at a first distance from the axis of rotation, a high brightness full conversion luminescent emission and on a second location, at a different, second distance from the axis of rotation, a high brightness diffused blue light. The blue laser light is condensed to these spots by respective condenser lenses that also collect the emitted/reflected light. The optical axis of the birefringent rotator (also known as retarder or waveplate) is set such that a required ratio of s-polarized and p-polarized light is created with reference to the combined PBS&DBS components, resulting in the required relative optical powers in the two spots on the rotating tracks. The PBS in this basic configuration reflects basically all s-polarized light and transmits all p-polarized light. In variants, partially polarizing splitters may be used. The transmitted p-polarized blue light is (preferably) converted into circular polarized light by a λ/4 plate. The (preferably) polarization maintaining diffuser reflects the blue light, which is collected by the optics and (preferably) converted by the λ/4 plate into linear, s-polarized, light that subsequently is reflected by the PBS. The non-diffused reflected s-polarized blue light is converted by the luminescent material into luminescent light that is collected by the collection optics. Via the combined PBS&DBS the luminescent light and the diffused blue light are combined into white output light. In the spinning rod configuration, the principles are largely the same as for the spinning wheel configuration, but the laser beams are projected on cylindrical tracks on a rod rather than on (concentric) rings on a wheel.

Referring to FIGS. 2a-2b, some basic configurations of a compact light engine providing speckle-free high brightness high flux white light with an adjustable color point, based on projection of multiple blue spots on respective rotating tracks where the incident light is converted and/or reflected is schematically depicted. Polarization is indicated with reference to incidence on the PBS&DBS component; s-polarization is indicated by a dot and p-polarization indicated by an arrow. FIG. 2a schematically shows that via rotation of a birefringent rotator waveplate, the ratio of s- and p-polarized light originating from a blue laser diode (array) entering a (partially) polarizing beam splitter is selected and splits the blue laser light into two beams. Both beams are projected on a spinning wheel that comprises a luminescent material ring and a diffuse reflector ring. Both rings are concentric. The luminescent light is combined with the diffused blue light by the combined polarizing (for blue) and dichroic (for yellow vs p-polarized blue) beam splitter into white output light. FIG. 2b schematically shows identical principles as in FIG. 2a, but the spinning wheel is replaced by a rotating cylinder with two different tracks for the luminescent converter and for the diffuser.

In the spinning wheel configuration, a rotating wheel is used to provide, at a first distance from the axis of rotation, a high brightness full conversion luminescent emission and on a second location, at a different, second distance from the axis of rotation, a high brightness diffused blue light. The blue laser light is condensed to these spots by respective condenser lenses that also collect the emitted/reflected light. The optical axis of the birefringent rotator (also known as retarder or waveplate) is set such that a required ratio of s-polarized and p-polarized light is created with reference to the combined PBS&DBS components, resulting in the required relative optical powers in the two spots on the rotating tracks. The PBS in this basic configuration reflects basically all s-polarized light and transmits all p-polarized light. In variants, partially polarizing splitters may be used. The reflected s-polarized light is projected onto the luminescent material and converted by the latter into luminescent light that is collected by the collection optics and via the combined PBS&DBS contributes to the output white light. The transmitted p-polarized blue light is (preferably) converted into circular polarized light by λ/4 plate (or other polarization changing element 810). The (preferably) polarization maintaining diffuser reflects the blue light, which is collected by the optics and (preferably) converted by the λ/4 plate into linear, s-polarized, light that subsequently is reflected by the PBS. The non-diffused reflected s-polarized blue light is converted by the luminescent material into luminescent light that is collected by the collection optics. Via the combined PBS&DBS the luminescent light and the diffused blue light are combined into (white) output light. The output light is also indicated as system light 1001.

In the spinning rod configuration, the principles are largely the same as for the spinning wheel configuration, but the laser beams are projected on cylindrical tracks on a rod rather than on (concentric) rings on a wheel.

Working principles of this configuration with reference to the spinning wheel: 1. Blue light is projected on more than one spot on a spinning wheel, from which at least one provides (partial) light conversion, enabling further miniaturization of the light engine; 2. Thanks to the fast movement of material in the blue spots, thermal dissipation is spread over a much larger area than for a (fully) static configuration and any laser speckle in reflected blue light is made non-visible; 3 With setting the optical axis of an (optional) birefringent rotator relative to the (main) polarization axis of the blue light the ratio of blue in the different branches is set, enabling fine-tuning of the resulting (white) output color point; 4 Two or more rings on a spinning wheel are used to project the blue light on (at a certain fixed point in space); these comprise one or more rings with luminescent conversion material; different rings provide different spectral responses; 5 The luminescent material generating the highest dissipative (thermal) power density or showing the highest optical impact (deviation from linear response such as thermal quenching, optical bleaching, optical saturation, or thermally or optically induced irreversible modification/damage) upon irradiation with the requested blue irradiance is preferably applied in the outer ring to provide the best cooling and/or the lowest time-average irradiance of the material; 6 The rings may be segmented, comprising spectrally different responses in the different segments (see for more details one of the variants described later).

Referring to FIG. 2a, a basic spinning wheel configuration is schematically depicted. Via rotation of the birefringent waveplate, the ratio of s- and p-polarized light originating from a laser diode (array) entering a (partially) polarizing beam splitter is selected and splits the blue laser light into two beams. Both beams are projected on a spinning wheel that comprises a luminescent material ring and a diffuse reflector ring. Both rings are concentric. The luminescent light is combined with the diffused blue light by the combined polarizing (for blue) and dichroic (for yellow vs p-polarized blue) beam splitter. Referring to FIG. 2a, in the central optics 900 may be configured such that: (a) first light having a wavelength in a first wavelength range comprising the first polarization is reflected or transmitted; (b) second light having a second wavelength in the first wavelength range and comprising a second polarization is transmitted or reflected; (c) third light having a third wavelength in a second wavelength range is transmitted or reflected, like one of the first light and the second light, irrespective whether the third light comprises the first polarization or the second polarization; and wherein the central optics 900 is configured to transmit at least part of the first luminescent material light 211. Hence, in the first wavelength range, light may either be substantially reflected or substantially transmitted, dependent upon the polarization (and independent upon the wavelength within the first wavelength range), whereas in the second wavelength range, essentially irrespective of the wavelength within that second wavelength range the third light may either be reflected or transmitted like the first light, or be transmitted or reflected like the second light. Likewise this may apply to other configurations where the central optics are configured to transmit at least part of the first luminescent material light 211 (and optionally also to configurations where the central optics are configured to reflect at least part of the first luminescent material light 211).

In FIGS. 2a-2b, schematically it is depicted that a first polarization is transmitted and a second polarization is reflected. However, it can also be the other way around.

Further, note that in embodiments for at least one polarization direction (especially when the central optics is transmittant for first luminescent light, may not be (fully) reflective for all device light, as this may only be the case for one of the polarization directions; the other polarization may still be transmitted.

Referring to FIG. 5a, a schematical view on an embodiment of the spinning wheel showing the concentric luminescent and diffuse reflective rings as well as the location of the condensing lenses and the projected blue laser spots is depicted. The first luminescent material 210 is configured in an outer first ring-shaped section 2131, and the reflector 2510 is configured in an inner second ring-shaped section 2132. As indicated above, in specific embodiments the first ring-shaped section 2131 may comprise two (or more) different first luminescent materials. This is not further indicated in FIG. 5a. Reference S especially indicates the full width half maximum spot size. FIG. 5b schematically depicts an embodiment wherein different first luminescent material 210 are configured in an outer first ring-shaped section 2131, and the reflector 2510 is configured in an inner second ring-shaped section 2132, but in combination with a second luminescent material 220.

Further, referring to FIG. 2b, a basic spinning rod configuration is schematically depicted. Via rotation of the birefringent waveplate, the ratio of s- and p-polarized light originating from a laser diode (array) entering a (partially) polarizing beam splitter is selected and splits the blue laser light into two beams. Both beams are projected on a spinning rod that comprises a cylindrical luminescent material track and a cylindrical diffuse reflector track. The tracks are co-axial and located at a certain axial distance from each other. The luminescent light is combined with the diffused blue light by the combined polarizing (for blue) and dichroic (for yellow vs p-polarized blue) beam splitter.

These principles of these configurations were explained in the previous section already. The spinning wheel has a diameter that is larger than the sum of the radii of the condenser lenses in both optical branches. The traces may be adjacent to each other. Preferably the two projected laser spots are located opposite of each other with respect to the wheel's axis of rotation. This enables a very compact configuration providing speckle-free blue light that can easily be combined with the luminescent light. For the spinning rod the tracks are typically spaced at a distance that is larger than the sum of the radii of the condenser lenses in both optical branches, assuming irradiation in a plane and from the same side. For out of plane irradiating optical branches or for irradiation from opposite sides, the tracks on the spinning rod in principle may be spaced at any distance from each other. Thanks to the birefringent rotator (also referred to as retarder or waveplate), which may be realized, e.g., as a λ/2 wave plate (resulting in maximum color tunability) or a λ/4 plate (resulting in a more limited range of color tunability), the color point of the white output light can be tuned along the phosphor load line (i.e., the line in the chromaticity diagram connecting the blue light color point and the luminescent emission color point). Typically, a range of up to a few thousand Kelvin in color temperature can be achieved in this way with (depending on the application) acceptable distance of the color points from the black body locus.

In the following section a series of variants is described with reference to the spinning wheel configuration. Most of these options are equally applicable to the spinning rod configuration, without explicitly mentioning this.

In an alternative embodiment the basic principles are essentially the same as described above in relation to FIGS. 2a-2b, but the characteristics of the PBS&DBS component may be different, which may result in a somewhat different configuration of the various building blocks. In this variant, the PBS&DBS may split the at least partly polarized blue incident light into two beams and reflects the luminescent light. PBS=Polarizing Beam Splitter (blue): >90% s-pol. reflectance, >90% p-pol. transmittance; DBS=Dichroic Beam Splitter (blue/yellow): >90% yellow reflectance.

Hence: 1 The basic principles are essentially the same as described above in relation to FIGS. 2a-2b, but, except for the PBS/DBS characteristics and related input/output beams; 2. Here the PBS reflects the s-pol. blue light towards the diffuser ring and transmits the p-pol. blue light to the luminescent converter ring; 3. The DBS function reflects the (yellow) luminescent light.

A further variant using a PBS/DBS component with high reflectance for the luminescent light is basically just a geometric variation of the previous embodiment. The PBS&DBS splits the at least partly polarized blue incident light into two beams and reflects the luminescent light. Compared to the configuration in the previous variant, the orientation of the input and output beams may have changed relative to the orientation of the spinning wheel. PBS=Polarizing Beam Splitter (blue): >90% s-pol. reflectance, >90% p-pol. transmittance; DBS=Dichroic Beam Splitter (blue/yellow): >90% yellow reflectance. Referring also to FIG. 5a, which schematically depicts a top view on the rotating wheel comprising the two concentric rings comprising the luminescent material (outer ring) and the diffuse reflecting material (inner ring). This Figure also indicates the locations of the two projected laser spots via the indicated condenser lenses.

Hence: 1. Rotator axis set to achieve the required ratio of hor. and vert. polarizations; 2. PBS reflects all s-polarized blue light and transmits all p-polarized blue light; 3. The reflected s-polarized blue light is converted into circular polarized light by λ/4 plate; 4. The polarization maintaining diffuser ring on the spinning wheel reflects the blue light; 5. The reflected diffused blue light is converted into linear (p−) pol. light by the λ/4 plate; 6. The diffused blue light is transmitted by the PBS; 7. The non-diffused transmitted p-pol. blue light is converted by the luminescent material into luminescent light; 8. The (reflection mode) luminescent light is reflected by the DBS and with that combined with the diffused blue light into white output light.

In a further embodiment the ratio of s- versus p-polarized blue light is adjusted by controlling two different laser sources independently and that are combined via a PBS. This is schematically visualized in FIG. 6a. Here, color temperature tuning via relative power setting of two laser sources that are combined via a PBS and split via a PBS&DBS component into a luminescent conversion branch and a diffused blue light branch is possible. A dual-ring reflective mode phosphor/diffuser wheel may be used for the luminescent conversion and diffusion of blue laser light. Via the same PBS&DBS the luminescent light and diffused blue light beams are combined into white output light. PBS=Polarizing Beam Splitter (blue): >90% s-pol. reflectance and >90% p-pol. transmittance of blue light; DBS=Dichroic Beam Splitter (blue/yellow): >90% yellow transmittance.

Hence: 1. The light beams of two blue lasers or laser arrays with opposite polarization are combined via a first PBS; 2. The required ratio of hor. and vert. polarization (or left- vs right-handed polarization; in that case for each laser(array) also a λ/4 plate is used) is set via the ratio of powers to the lasers (or laser arrays); 3. An integrator is applied to remove the hot spots and to homogenize the blue beam; 4. The PBS in the combined PBS/DBS plate reflects all s-pol. blue light and transmits all p-pol. blue light; 5 The transmitted p-pol. Blue light is converted into circular polarized light by a λ/4 plate; 6. Pol. Maintaining diffuser reflects the blue light; 7. The reflected diffused blue light is converted into linear (s-) pol. light by the λ/4 plate; 8. The diffused blue light is reflected by the PBS; 9. The non-diffused reflected s-pol. Blue light is converted by the luminescent material into luminescent light; 10. The luminescent light is transmitted by the DBS and with that combined with the diffused blue light into white light; and 11. An optional integrator is used to further homogenize the white light beam.

In a further embodiment, see also FIG. 6b the ratio of s- versus p-polarized blue light is adjusted by controlling again the axis orientation of the birefringent rotator, but two different wavelength laser (array) sources are combined via a first DBS and used as input blue beam. In this way the polarization of the combined beam can still be present and thus an increased engine flux and radiance can be realized while enabling selection of the color temperature via the rotator. Is both sources are configured to provide somewhat different polarization, then also via the power ratio of the sources some color temperature tuning is possible. However, for maximum tuning range the polarizations should be equal. This configuration is visualized in FIG. 6b. In FIG. 6b, it is schematically depicted that two different wavelength laser (array) sources are combined via a dichroic beam splitter into a light beam that is at least partly polarized. This beam is split via a PBS&DBS into two branches for reflective luminescent conversion and diffusion on two spots on, respectively, two concentric luminescent and diffusing rings on a spinning wheel. The orientation of the rotator determines the color point of the output white light. DBS1=Dichroic Beam Splitter (blue-blue): >90% long WL blue transmittance, >90% short WL blue reflectance; PBS=Polarizing Beam Splitter (blue); >90% s-pol. reflectance, >90% p-pol. transmittance; DBS=Dichroic Beam Splitter (blue-yellow); >90% yellow transmittance.

Hence: 1. The light beams of two blue lasers or laser arrays with different emission wavelength and substantially overlapping polarization are combined dichroically; 2. The required ratio of s- vs p-polarization is set via the ratio of powers to the laser sources or via the birefringent rotator; 3. The PBS in the combined PBS/DBS plate reflects all s-pol. Blue light and transmits all p-pol. blue light; 4. The transmitted p-pol. blue light is converted into substantially circular polarized light by a λ/4 plate (optimized for the average wavelength); 5. Pol. Maintaining diffuser reflects the blue light; 6. The reflected diffused blue light is converted into substantially linear (s-) pol. light by the λ/4 plate; 7. The diffused blue light is reflected by the PBS; 8. The non-diffused reflected s-pol. Blue light is converted by the luminescent material into luminescent light; 9. The luminescent light is transmitted by the DBS and with that combined with the diffused blue light into white light.

In a further embodiment the ratio of s- versus p-polarized blue light in the output beam of a first blue laser source is adjusted by controlling again the orientation of the optical axis of a birefringent rotator, but in this configuration two laser light sources are applied such that any (selectable) fraction of a first source can be directed to the diffuser ring on the rotating wheel while the remainder, together with the output of the second blue laser source, is directed to the luminescent converter ring. This configuration is visualized in FIG. 6c. In FIG. 6c, it is schematically depicted that part of the output of a first blue laser source, selectable via a birefringent rotator, is transmitted to the diffuser ring while the remainder is projected, together with the output of a second blue laser source, onto a luminescent converter ring on a rotating wheel. The engine output white light color temperature is tunable via the birefringent rotator. PBS1=Polarizing Beam Splitter (blue); >90% s-pol. refl., >90% p-pol. transm.; DBS1=Dichroic Beam Splitter (blue-yellow); >90% yellow reflectance; PBS2=Polarizing Beam Splitter (blue); >90% s-pol. refl., >90% p-pol. transm.; DBS2=Dichroic Beam Splitter (blue-yellow); >90% yellow transmittance.

Hence: 1. A first blue (p-pol.) beam from a first laser (array) transmits through a blue PBS (and blue/yellow DBS) to be projected onto a spinning wheel track comprising a luminescent material; 2. A second blue beam from a second laser (array) is split via a birefringent rotator into two polarizations, one of which (p-pol.) is transmitted through a second blue PBS (and blue-yellow DBS) to a diffusing track on the spinning wheel, and the other (s-pol.) is reflected towards the first PBS & DBS (to be there reflected to the luminescent converter as well); 3. The rotator axis is set to achieve the required ratio of the two polarized beams from the second laser (array) by which the color point of the resulting (white) output light is finetuned; 4. Additionally, the relative laser source powers can be adjusted to control the color point of the output white light; 5. The (p-pol.) Blue light transmitted through the second PBS&DBS is converted by λ/4 plate (into circularly pol. light); 6. The pol. maintaining diffuser on the spinning wheel reflects the blue light; 7. The reflected (circularly polarized) diffused blue light is converted by the λ/4 plate into (s-pol.) light; 8. The diffused blue light is now reflected by the second PBS&DBS to the output; 9. The non-diffused reflected (s-pol.) blue light is reflected by the first PBS (and blue-yellow DBS) towards the luminescent material track on the spinning wheel; 10. The blue light projected onto the luminescent material, comprising the (p-pol.) blue light from the first laser (array) and the (s-pol.) blue light from the second laser (array), is substantially converted into luminescent light; 11. The luminescent light is reflected by the first (blue PBS and) blue-yellow DBS; 12. Upon transmission of the luminescent light by the second (blue PBS and) blue-yellow DBS, it is combined with the diffused blue light into (white) output light; 13. An optional integrator is used to further homogenize the white light beam.

In a further embodiment, two blue laser light sources are combined via a dichroic beam splitter, while polarizing beam splitters with additional dichroic beam splitting functionality, as presented already in FIG. 6c, are used for the further beam splitting and combining. This has the advantage of a further increased light engine luminance and total luminous flux, while in addition the longer wavelength blue is used as the diffused blue light contribution to the white output light that enables higher color quality (CRI) as well as a selectable color point variation that is more parallel to the BBL (at least in the targeted range of color temperatures). This configuration is presented in FIG. 6d. Here, DBS0=Dichroic Beam Splitter (blue-blue): >90% short WL blue reflectance; DBS0 is indicated as dichroic beam splitter 515. >90% long WL blue transmittance; PBS1=Polarizing Beam Splitter (blue) (reference 910′); >90% s-pol. reflectance, >90% p-pol. transmittance; DBS1=Dichroic Beam Splitter (blue-yellow) (reference 920′); >90% yellow reflectance; PBS2=Polarizing Beam Splitter (blue) (reference 910); >90% s-pol. reflectance and >90% p-pol. transmittance; DBS2=Dichroic Beam Splitter (blue-yellow) (reference 920); >90% yellow transmittance. The central optics closest to a light exit of the light generating system 1000 is indicated with reference 900. Optics 900′ is configured upstream thereof, and also comprises a (central optics) dichroic beam splitter, indicated with reference 920′, and a polarizing beam splitter, indicated with reference 910′.

Hence: 1. Comparable working principles as in previous configuration, except that PBS1&DBS1 transmits two different wavelengths of p-polarized blue light; 2. This dual-wavelength p-polarized blue light comprises the output light of two laser sources that are configured to provide, relative to the PBS1&DBS1 component, p-polarized light; these laser beams are dichroically combined via a Dichroic Beam Splitter DBS0; 3. As a consequence, for the color point of the output white light to remain in the preferred range of color temperatures, the transmittance of PBS2 for blue light needs to be higher; for a PBS2 with >90% transmittance of p-pol blue light this may be acceptable for special cases that focus on lower color temperature ranges.

In a further embodiment, in both laser source branches two different blue wavelength sources may be applied. This enables even further increased light engine output luminance and flux. The configuration is indicated in FIG. 6e. In FIG. 6e, two laser beams with different wavelength are dichroically combined into input beams, both for PBS1&DBS1 and PBS2&DBS2, are schematically depicted. Further beam splitting and combining is the same as in the configuration of FIG. 6c. DBS0=Dichroic Beam Splitter (blue-blue): >90% short WL blue reflectance. >90% long WL blue transmittance; PBS1=Polarizing Beam Splitter (blue); >90% s-pol. refl., >90% p-pol. transm.; DBS1=Dichroic Beam Splitter (blue-yellow); >90% yellow reflectance; PBS2=Polarizing Beam Splitter (blue); >90% s-pol. refl., >90% p-pol. transm.; DBS2=Dichroic Beam Splitter (blue-yellow); >90% yellow transmittance.

Hence: 1. Comparable working principles as in a previous configuration, except that here in both branches two blue wavelength sources are combined; 2. In the branch with the birefringent rotator these blue sources are preferably configured to emit the same polarization (referred to PBS2) but there is no further requirement to this as the rotator can make any requested ratio of s/p polarization; in the other branch, both blue sources are configured to emit blue light with p-polarized light referred to PBS1; 3. As a consequence, for the output while light color point to remain in the preferred range of color temperatures, the transmittance of PBS2 for blue light is comparable as in the configuration with, in total, only 2 laser sources.

Referring to FIG. 6f, a variant may be using different solid state light sources 10,20, differing in the spectral power distributions of the respective light source light 11,21. Downstream of one of the type of light sources 10,20, here the type indicated with reference 10, a dichroic beam splitter (“DBS1”), indicated with reference 515, is configured (see e.g. also FIG. 6b). Hence, in a further embodiment, the redirection of the luminescent light out of the exciting blue light path of the first laser source and the combination of the beams from two laser sources is realized may not via a polarizing beam splitter as used in the previous embodiments but via a dichroic beam splitter. This may require the two laser sources to have different wavelengths, by which, advantageously, the longest wavelength may be used again for the diffused blue light contribution to the output white light. The two blue wavelengths need to be far enough apart to enable application of a DBS with its low-pass cut-off wavelength in between. As the beams are collimated, this can be realized quite well, and the blue wavelengths would need to be (at least) 10 nm apart. Hence, this variant may apply a spinning phosphor and reflector wheel configuration with a first DBS and a combined PBS&DBS, using two blue wavelengths for pumping the phosphor while the longest wavelength blue is also used as contribution to the white output light. DBS1=Dichroic Beam Splitter (blue/blue and blue/yellow): >90% yellow reflectance, >90% long wavelength blue reflectance, >90% short wavelength blue transmittance; PBS=Polarizing Beam Splitter (blue); >90% s-pol. refl., >90% p-pol. transm. of the long wavelength blue light; DBS2=Dichroic Beam Splitter (blue/yellow); >90% yellow transmittance. Hence: 1 A first blue beam with a first (shortest) wavelength from a first laser (array) transmits through a first DBS to be projected onto a spinning wheel track comprising a luminescent material; 2 a second blue beam with a different, longer wavelength from a second laser (array) and that is substantially polarized is split via a birefringent rotator and a PBS into two polarizations, one of which (p-pol.) is transmitted through the blue PBS (and blue-yellow DBS) to a diffusing track on the spinning wheel, and the other (s-pol.) is reflected towards the first DBS (to be there reflected to the luminescent converter as well); 3 The rotator axis is set to achieve the required ratio of the two polarized beams from the second laser (array) by which the color point of the resulting (white) output light is finetuned; 4 The (p-pol.) Blue light transmitted through the PBS&DBS2 is converted by a λ/4 plate (into circularly pol. light); 5 The substantially pol. maintaining diffuser on the spinning wheel reflects the blue light; 6 The reflected (substantially circularly polarized) diffused blue light is converted by the λ/4 plate into substantially s-pol. Light; 7 The diffused blue light is now substantially reflected by the PBS&DBS2 to the output; 8 The non-diffused reflected (s-pol.) blue light is reflected by the first DBS towards the luminescent material track on the spinning wheel; 9 The blue light projected onto the luminescent material, comprising the short wavelength blue light from the first laser (array) and the (s-pol.) long wavelength blue light from the second laser (array), is substantially converted into luminescent light; 10 The luminescent light is reflected by DBS1; 11 Upon transmission of the luminescent light by the PBS&DBS2, it is combined with the diffused (long wavelength) blue light into (white) output light; 12 An optional integrator is used to further homogenize the white light beam.

In a further embodiment, which is a variant on the embodiment schematically depicted in FIG. 6f, the system efficiency may be improved somewhat further at the cost of the maximum color point tuning range by using a partially polarizing beam splitter functionality in PBS2&DBS2: PBS2a=Partial Polarizing Beam Splitter (blue); >90% s-pol. refl. of the long wavelength blue light, >30% p-pol. transm. of the long wavelength blue light (preferably ca 50%), <70% p-pol. refl. of the long wavelength blue light (preferably ca 50%); and DBS2a=Dichroic Beam Splitter (blue/yellow); >90% yellow transmittance.

In yet a further variant on the variant on FIG. 6f, the short wavelength blue beam is created by combining two short wavelength laser (array) beams with complementary polarizations via a PBS which is now possible thanks to the dichroic mixing of the short and long wavelength blue light that is used for luminescent conversion. This enables a further increase of the output luminance and flux. However, instead of a single type of light generating device, in the branch including the dichroic beam splitter 515, more than one light generating device (of essentially the same type) may be used upstream of this dichroic beam splitter 515, of which the device light is first combined via a polarizing beam splitter (“PBS1”; see also below), configured upstream of that dichroic beam splitter. Hence, two or more light generating devices may be applied of which at least two provide device light having different polarizations (see also FIG. 6a). Hence, herein a spinning phosphor and reflector wheel configuration with a first DBS and a combined PBS&DBS, using two blue wavelengths for pumping the phosphor, where the longest wavelength blue is also used as contribution to the white output light and the shortest wavelength blue is composed of the output of two laser sources with complementary polarization may be applied. Hence: PBS1=Polarizing Beam Splitter (blue): ); >90% s-pol. refl., >90% p-pol. transm. of the short wavelength blue light; DBS1=Dichroic Beam Splitter (blue/blue and blue/yellow): >90% yellow reflectance, >90% long wavelength blue reflectance, >90% short wavelength blue transmittance; PBS2=Polarizing Beam Splitter (blue); >90% s-pol. refl., >90% p-pol. transm. of the long wavelength blue light; DBS2=Dichroic Beam Splitter (blue/yellow); >90% yellow transmittance.

In a variant on FIG. 2a (and 2b), a single and only partially polarizing beam splitter is used in the light engine for splitting and combining of optical beams. Referring to FIG. 2a (and 2b), a rotating wheel system with concentric rings and a single PBS&DBS as partially polarizing splitter is applied. PBS=Polarizing Beam Splitter (blue); >90% s-pol. reflectance, 50-85% p-pol. reflectance, 15-40% p-pol. transmittance; DBS=Dichroic Beam Splitter (blue-yellow); >90% yellow transmittance.

Hence: 1. Blue light projected on more than one spot on a spinning wheel, from which at least one provides (partial) light conversion, enabling further miniaturization of the light engine; 2. With setting the optical axis of an (optional) birefringent rotator relative to the (main) polarization axis of the blue light the ratio of blue in the different branches is set, enabling fine-tuning of the resulting (white) output color point; 3. Now the blue PBS and blue-yellow DBS component does not fully split the two polarizations of the incoming blue beam, but reflects one of them (almost) completely (or at least substantially (>60%)) and reflects the other of them substantially (>60%), so as to transmit a smaller fraction (<40%) of the incoming blue beam; 4. The reflected blue light is projected onto the luminescent material ring on the spinning wheel; 5. The luminescent light is collected and transmitted through the (blue PBS and) yellow-blue DBS to the output; 6. The transmitted blue (p-pol.) light is passing an (optional) λ/4 plate and projected onto a preferably polarization maintaining diffusing ring on the spinning wheel; 7. The diffused blue light is collected and passes again the (optional) λ/4 plate (in which case it becomes s-pol. light), which is predominantly reflected at the blue PBS (and blue-yellow DBS) (i.e., the diffused s-pol. light is (almost) completely or at least substantially reflected, and the diffused p-pol. Light is substantially reflected), upon which this diffused blue light is combined with the luminescent light into (white) output light; 8. An optional integrator is used to further homogenize the white light beam.

In a variant on FIG. 6a, the blue input beam is not (substantially) polarized anymore due to the combination of two laser beams via a PBS, and hence the color point tuning is realized via adjustment of the power ratio of the two laser sources. Referring to FIG. 6a, a system with a partially polarizing BS to split an incoming unpolarized blue beam is schematically depicted. The latter is realized by superposition of two blue laser beams via a first PBS. PBS1=Polarizing Beam Splitter (blue); >90% s-pol. refl., >90% p-pol. transm.; PBS2=Polarizing Beam Splitter (blue); >90% s-pol. reflectance, 40-70% p-pol. reflectance, 30-60% p-pol. transmittance; DBS=Dichroic Beam Splitter (blue-yellow); >90% yellow transmittance.

Hence: 1. Blue light projected on more than one spot on a spinning wheel, from which at least one provides (partial) light conversion, enabling further miniaturization of the light engine; 2. The light beams of two blue lasers or laser arrays with opposite polarization are combined via a first blue PBS; 3. The required ratio of hor. and vert. polarization (or left- vs right-handed polarization; in that case for each laser(array) also a λ/4 plate is used) is set via the ratio of powers to the lasers (or laser arrays). With this ratio, the ratio of blue in the different branches is set, enabling fine-tuning of the resulting (white) output color point; 4. An integrator is applied to remove the hot spots and to homogenize the blue beam; 5. Now the blue PBS and blue-yellow DBS component does not fully split the two polarizations of the incoming blue beam, but reflects one of them (almost) completely (or at least substantially >80%)) and reflects the other of them substantially (>40%), so as to transmit a smaller fraction (<60%) of the incoming blue beam; 6. The reflected blue light is projected onto the luminescent material ring on the spinning wheel; 7. The luminescent light is collected and transmitted through the (blue PBS and) yellow-blue DBS to the output; 8. The transmitted blue (p-pol.) light is passing an (optional) λ/4 plate and projected onto a preferably polarization maintaining diffusing ring on the spinning wheel; 9. The diffused blue light is collected and passes again the (optional) λ/4 plate (in which case it becomes s-pol. light), which is predominantly reflected at the blue PBS (and blue-yellow DBS) (i.e., the diffused s-pol. light is (almost) completely or at least substantially reflected, and the diffused p-pol. light is substantially reflected), upon which this diffused blue light is combined with the luminescent light into (white) output light; and 10. An optional integrator is used to further homogenize the white light beam.

In a further embodiment, which may be a variant on FIG. 2a, the ring in the rotating wheel that comprises luminescent material is composed of various sections comprising different luminescent characteristics. Hence, in this embodiment the spinning wheel system comprising concentric rings with luminescent and diffuse reflecting material, where the luminescent ring is composed of multiple sections with different luminescent characteristics. PBS=Polarizing Beam Splitter (blue), >90% s-pol. reflectance, >90% p-pol. transmittance; DBS=Dichroic Beam Splitter (blue/yellow), >90% yellow transmittance.

Hence: 1. The working principles are the same as in the basic configuration, except for the luminescent converter; 2. The Luminescent converter comprises multiple segments emitting at least two different luminescent spectra; 3. The PBS/DBS component in this case needs to transmit all the different spectra from the various luminescent segments; 4. Various segments may comprise identical luminescent material, by which the repetition rate for emission of light with that particular spectrum in (i.e., contributing to) the output light is increased and therefore possible temporal artifacts can (almost arbitrarily much) be reduced.

In a further embodiment, which is also a variant on the embodiment of FIG. 2a, the diffuser ring on the spinning wheel may additionally comprise one or more luminescent materials that may be homogeneously distributed over the ring or that may be applied is segments. A specific configuration, where the diffuser ring is segmented comprising diffusing and luminescent segments, and where the luminescent ring is segmented as well, is illustrated in FIG. 5b. Here, the rotating wheel system may comprise segmented luminescent and combined diffusing and luminescent rings.

Hence: 1. The working principles beam splitting and combining are the same as in the basic configuration, but the diffuser ring has additional functionality; 2. The ring comprising the reflective diffuser in this embodiment also comprises a luminescent material, e.g. in one or more segments of the ring; 3. The luminescent part(s) of the ring may be partly luminescent converting, in which case also (a substantial) part of the incident blue light is (substantially) diffuse reflected, or may be (almost) fully converting the incident blue light into luminescent light; in case the luminescent material is present along the full ring it has to be partially converting to provide also the required diffusively reflected blue light; 4. The Luminescent converter comprised on the ring that also provides the diffused blue light has a spectral emission with a center wavelength that is preferably shorter than the center wavelength of the luminescent emission from the ring emitting only luminescent light; 5. The PBS/DBS component in this case needs to transmit quasi the full spectrum from the fully luminescent ring, while reflecting quasi the full spectrum of the luminescent emission from the ring that also provides the diffusively reflected blue light to the white output light of the engine; 6. Different segments of the ring that also provides the diffused blue light may provide different luminescent emission or different diffusively reflected blue light; 7. Various segments may comprise identical luminescent material, by which the repetition rate for emission of light with that particular spectrum in the output light is increased and therefore possible temporal artifacts can (almost arbitrarily much) be reduced; 8. The ring that contributes to the output light only with luminescent light also may comprise one or more luminescent materials in one or more segments; 9. With the luminescent material on the ring that provides also diffused blue light emitting at a wavelength (typically in the cyan-green spectral range) that is shorter than the luminescent material at the fully luminescent ring (typically in the green/yellow-red spectral range) and provided in the right amount, the color point of the output light can be varied along a line that is substantially parallel to the BBL in a color temperature range of primary interest (e.g. 4000-7000 K); 10. To minimize visibility or detectability of temporal artifacts, in particular chromatic temporal contrasts, the layout of the rings is preferably such that the color point variation in time is minimized, e.g. by always combining yellow with blue light or cyan with red light rather than at some moment combining blue with cyan light and at another moment yellow with red light.

Cyan emitting phosphors that can be excited with blue light with a small Stokes shift have been and are being investigated e.g. to enable realization of a full spectrum or improved color quality white light emitting LED. Various luminescent materials may be applicable. For example, Na_{0.5}K_{0.5}Li₃SiO₄:Eu²⁺ (NKLSO:Eu²⁺) phosphor was developed with impressive properties, providing blue-excited cyan emission at 486 nm with a narrow full width at half maximum (FWHM) of only 20.7 nm, and good thermal stability with an integrated emission loss of only 7% at 150° C. [Zhao, M., Liao, H., Molokeev, M. S. et al. Emerging ultra-narrow-band cyan-emitting phosphor for white LEDs with enhanced color rendition. Light Sci Appl 8, 38 (2019). https://doi.org/10.1038/s41377-019-0148-8]. The PL (photoluminescent) spectrum of the NKLSO:8% Eu2+ phosphor consists of a dominant asymmetric narrow-band peak at 486 nm (FWHM=20 nm). An embodiment of a cyan phosphor is also BaSi₂ON₂:Eu²⁺, which possesses an emission band with the peak at ~495 nm (FWHM=~32 nm). In addition, there are cyan emitting aluminate phosphors, as well as a narrow-band cyan-emitting oxonitridoberyllate phosphor Sr[Be₆ON₄]:Eu²⁺ (λₑₘ=495 nm, FWHM=35 nm).

Spectral modeling was performed for a relatively broad band, short wavelength garnet emission, pumped by a 445 nm laser beam, to provide, in combination with a dichroic filter with cut-off wavelength of either 510 nm or 520 nm, the cyan spectrum. This results in the first color primary of the light engine, comprising blue light in combination with cyan light. A longer wavelength garnet phosphor (Gd-YAG:Ce), pumped by blue laser light may provide the second, yellow-orange color primary, that may be combined via the dichroic filter with the blue-cyan contribution into white output light. In this modelling, the ratio of yellow-orange to blue-cyan was varied, resulting in color points along a line connecting both color primaries. The resulting spectra are plotted in FIG. 3. In this figure “white” light output spectra for varying contributions (ranging from 0 to 100% of the output light) of yellow-orange and blue-cyan light, using a dichroic cut-off wavelength of 510 nm and a blue pump wavelength of 445 nm are depicted. Note that the first luminescent material 210 and the second luminescent material may thus have an excitation band (especially in the blue wavelength range), at least partly overlapping with a device light (emission band) 101. Referring to FIG. 3, in embodiments about λ_{c2}≤(λ_{c1}−50 nm). Further, (λ_{cd}+20 nm)≤_{c2}, may apply. Especially, (a) the centroid wavelength and/or peak wavelength of the device light, and the centroid wavelength of the second luminescent material light and (b) the centroid wavelength of the first luminescent material may be selected such that the peak wavelength and/or centroid wavelength of the device light and the centroid wavelength of the second luminescent material light on the one hand and the centroid wavelength of the first luminescent material light on the other hand are spectrally positioned at two opposite sides of a cut-on/cut-off wavelength of a dichroic filter comprised by the central optics. For instance, such cut-on/cut-off wavelength may ideally be chosen at the dashed line at about 505 nm in FIG. 3, for the chosen luminescent materials (and light generating device).

While for the combination of blue light with garnet luminescent emission the CRI is generally around 70, with the dichroic addition of cyan the CRI can be increased to just above 80 in the color temperature range of ca 4500-6000 K.

In a further embodiment, which is a variant on the embodiment of FIG. 6b, the input blue laser beam is composed of two wavelengths to enable a longest blue wavelength to contribute to the white output light while the input beam is realized via a PBS. The output white color point is adjustable via the power ratio of the two laser sources, as the shortest wavelength blue is fully used for luminescent conversion and the longest wavelength blue contributes to both the white output light and luminescent conversion. For best performance, a partially polarizing beam splitter is used in the combined PBS&DBS that combines the blue and the luminescent light beams. In this embodiment, a system with input blue beam comprising two wavelengths with complementary polarization is applied. PBS1=Polarizing Beam Splitter (blue); >90% s-pol. reflectance, >90% p-pol. transmittance; PBS2=Polarizing Beam Splitter (blue); >90% s-pol. reflectance, 40-70% p-pol. reflectance, 30-60% p-pol. transmittance; DBS=Dichroic Beam Splitter (blue-yellow); >90% yellow transmittance.

Hence: 1. The light beams of two blue lasers or laser arrays with opposite (or complementary) polarization and different wavelength (center wavelengths at least 10 nm different) are combined via a first PBS; 2. The required ratio of p-polarized and s-polarized light in the combined blue beam incoming on the combined PBS/DBS is set via the ratio of powers to the lasers (or laser arrays); 3. Preferably the shortest wavelength blue light is s-polarized and the longest wavelength blue light is p-polarized, by which the longest wavelength blue light will be used substantially more than the shortest wavelength blue light as blue contribution to the output light, which is preferred for both an increased color quality (CRI) and for a color point variation, upon changing the s/p pol ratio of the blue input light, that is more parallel to the BBL in the targeted color temperature range of primary interest; 4. An integrator is applied to remove the hot spots and to homogenize the blue beam; 5. The PBS in the combined PBS/DBS plate reflects (almost) all s-pol. (shortest wavelength) blue light and: transmits (almost) all p-pol. (longest wavelength) blue light (not preferred), or transmits a substantial part of p-pol. (longest wavelength) blue light and also reflects a substantial part of p-pol. (longest wavelength) blue light (preferred). Thanks to the partial reflection of p-pol. blue light in addition to the almost) complete reflection of s-pol. blue light, a larger fraction of blue light can be used to excite luminescent material and a smaller fraction of blue light can be used as blue contribution to the white output light as generally required for the color points of interest (e.g. 4000-7000 K) while using two laser sources with comparable output powers; 6. The transmitted p-pol. Blue light is (preferably) converted into circular polarized light by a λ/4 plate; 7. A (preferably) polarization maintaining diffuser reflects the transmitted blue light; 8. The reflected diffused blue light is (preferably) converted into linear (s-) pol. light by the λ/4 plate; 9. The diffused blue light is substantially reflected by the PBS/DBS; 10. The non-diffused reflected s-pol. blue light as well as the (non-diffused) reflected p-pol. blue light if present are converted by the luminescent material into luminescent light; 11. The luminescent light is transmitted by the PBS/DBS and with that combined with the diffused blue light into white output light; and 12. An optional integrator is used to further homogenize the white light beam.

In a further embodiment, the color point tunability of a system comprising a dual wavelength blue input beam may further be increased by incorporation of a birefringent rotator in the longest wavelength blue beam. This embodiment may be described as a variant of FIG. 6B, where the location of the rotator 600 (especially half-wave plate) is changed and now acts only on one of the two device light sources, but as a consequence also the tunability and/or the partial PBS characteristics are different. The system configuration may (thus) be based on a dual wavelength blue input beam with improved output white light color point tunability. Hence: 1. The light beams of two polarized blue lasers or laser arrays with different wavelength (center wavelengths at least 10 nm different) and preferably different polarization are combined via a first DBS; 2. The polarization of the short wavelength blue is preferably s-type incident on the PBS/DBS2; 3. The required ratio of p-polarized and s-polarized light in the combined blue beam incoming on the combined PBS/DBS2 is set via one or more of a) the orientation of the polarization rotator and b) the ratio of powers to the lasers (or laser arrays); 4. Preferably the shortest wavelength blue light is s-polarized and the longest wavelength blue light is p-polarized, by which the longest wavelength blue light will be used substantially more than the shortest wavelength blue light as blue contribution to the output light, which is preferred for both an increased color quality (CRI) and for a color point variation, upon changing the s/p polarization ratio of the blue input light, that is more parallel to the BBL in the targeted color temperature range of primary interest; 5. An integrator is applied to remove the hot spots and to homogenize the blue beam; 6. The PBS in the combined PBS/DBS plate reflects (almost) all s-pol. (shortest wavelength) blue light and transmits (almost) all p-pol. (longest wavelength) blue light (not preferred), or transmits a substantial part of p-pol. (longest wavelength) blue light and also reflects a substantial part of p-pol. (longest wavelength) blue light (preferred); Thanks to the partial reflection of p-pol. blue light in addition to the almost) complete reflection of s-pol. blue light, a larger fraction of blue light can be used to excite luminescent material and a smaller fraction of blue light can be used as blue contribution to the white output light as generally required for the color points of interest (e.g. 4000-7000 K) while using two laser sources with comparable output powers; 7. The transmitted p-pol. Blue light is (preferably) converted into circular polarized light by a λ/4 plate; 8. A (preferably) polarization maintaining diffuser reflects the transmitted blue light; 9. The reflected diffused blue light is (preferably) converted into linear (s-) pol. light by the λ/4 plate; 10. The diffused blue light is substantially reflected by the PBS/DBS; 11. The non-diffused reflected s-pol. blue light as well as the (non-diffused) reflected p-pol. blue light if present are converted by the luminescent material into luminescent light; 12. The luminescent light is transmitted by the PBS/DBS and with that combined with the diffused blue light into white output light; 13. An optional integrator is used to further homogenize the white light beam.

In a further embodiments, the diameters of the cylindrical tracks of the spinning rod configuration may be different. This enables further space optimization, as the track that shows the highest sensitivity for the irradiance level may be realized with the largest diameter, and the track with the least sensitivity to the irradiance may be realized with the smallest diameter. The spinning rod based light engine may thus use a rod comprising sections with different diameter to realize (cylindrical) tracks on the rod with different diameters for performance optimization.

In further embodiments, more than two concentric rings on a spinning wheel or spinning rod and more than two projected laser spots on the wheel or rod are used. In embodiments, a spinning wheel comprising more than two rings of which at least two are comprising luminescent material and one ring at least comprises diffusively blue light reflecting material is herein provided. In this configuration the wheel comprises two different phosphor rings and one reflector ring. Indicated are as well example positions of the three laser spots and the three light condensing/collecting lenses. In case of more than 2 rings that do not have their centers on a single straight line (e.g. in a triangular configuration, which may be preferred to maximize the condenser/collection lens diameters applicable for a single spinning wheel), an additional dichroic mirror plus an additional (out of the plane positioned) mirror are needed to distribute the blue light over the three branches and combine the light from these three branches again. Note that for a system with a rotating rod, the mechanical boundary conditions are different as in this case the projected spots do not necessarily come from the same direction. In other words, the beams do not need to be parallel, as they may be rotated around the axis of the rod by any arbitrary angle. Or, alternatively, the beams are incident from opposite directions. Therefore, the traces may even be located directly adjacently.

For a rotating wheel configuration, in addition to the configurations described above, also the second side of the disk may be used for one or more of the circular traces. In principle this could even enable traces with the same diameter but applied to opposite sides of the wheel. However, as this does not seem to be favorable from a configuration point of view, such options have not been described in further detail.

For maximum system efficiency, generally the presence of a quarter lambda wave plate in the path of the (to be) diffused blue light has been indicated in combination with a preferably at least partly polarization maintaining diffuser. In such cases, if the homogenizers such as the fly-eye lens arrays or integrating rods would not sufficiently eliminate laser hot spots in the projected spots on the track, in particular the polarization maintaining diffuser may not be able to reduce such hot spots sufficiently. Then it may be advantageous to add a small-angle transmissive diffuser at sufficient optical path distance from the track. This is considered as a very general and well-known way to further homogenize light and has not been indicated further; it is assumed to be included in the covered configurations as well. In addition, the quarter wave plate may be left out, enabling the application of non-polarization maintaining diffuser materials, albeit at the cost of some more diffused blue light loss.

In further alternative embodiments, one or more transmissive (luminescent or non-luminescent) rings or segments may be used, which may be used together with or without other reflective (luminescent or non-luminescent) rings or segments. In case of a transmissive beam, it is preferred to apply a dichroic filter on the irradiated ring or segment of a ring facing the incoming laser beam, that transmits the incoming laser beam and reflects the converted (luminescent) beam.

In further embodiments according to this invention, as variants of any of the preceding embodiments, the laser source, or, in case of presence of two different laser sources, at least one of these source, may be high frequency and/or amplitude modulated to enable optical wireless communication (OWC).

As luminescent materials are generally far slower in their temporal response (i.e., in their decay rate) compared to the lasers, preferably the blue laser light is used for this OWC. In particular in those configurations where one laser source is used to provide s-polarized light and a second laser source is used to provide p-polarized blue light, it is advantageous to only modulate the source providing the p-polarized light because the s-polarized light is (almost) fully used for luminescent conversion.

FIG. 4 schematically depict embodiments of rotatable elements with different configuration of luminescent materials, e.g. with one or two luminescent materials, though more than two may be possible. Radial configurations may (thus) also be possible.

As indicated above, in FIGS. 5a-5b an embodiment of a rotating wheel that comprises both or more tracks, the track providing partly luminescent light and partly diffused blue light may be realized in the form of a ring on a spinning wheel that is concentric with a full conversion ring-shaped luminescent material track. A specific configuration, where both tracks have been partitioned in segments with different optical properties, is illustrated in FIG. 5. In this configuration the inner ring-shaped track may comprise blue light diffusing and blue light pumped luminescent segments, and the outer ring-shaped track comprises luminescent segments with different luminescent properties. Other configurations may also be possible.

The system according to the invention may—amongst others—be applied in stage lighting, shop lighting, home lighting, accent lighting, spot lighting, theater lighting, fiber optic lighting, display systems, warning lighting systems, decorative lighting applications, medical lighting applications, digital projection, automotive lighting, medical treatment applications, and/or personal care and skin treatment applications. However, the invention is not limited to the above mentioned applications.

Referring to e.g. FIG. 1, but also to embodiments comprising the central optics, the invention provides in embodiments an efficient white light producing phosphor wheel for laser-based high-brightness light sources. For most configurations it appears desirable to use a light diffusing reflector which does not change the polarization direction of linearly polarized light. For this purpose it is herein suggested to use a reflector with a faceted surface for spreading light falling onto it (diffusing light). Such facets may be curved but they may also be flat and the orientation of the facets may be distributed in way for obtaining a desired light distribution which can be referred to as reflective metallic beam shaping (RBS) diffusor.

In embodiments, it is herein also suggested placing the RBS between two phosphor tracks such that most of the blue light focused onto RBS may be at a normal incidence to this track. In this way, after reflection from RBS blue light remains circularly polarized and only the sense of the polarization is altered. In this way white light can be produced with high efficiency.

It is herein further suggest to optically and/or mechanically ways of slight shifting the position of the laser spot on the track for adjusting the color temperature of the light. The table below give some data (with x, y being CIE 1931 color coordinates.

| Blue power (%) | x | y | CCT | CRI |
|---|---|---|---|---|
| 10 | 0.4291 | 0.4325 | 3350 | 85.1 |
| 13 | 0.4146 | 0.4147 | 3490 | 86.9 |
| 19 | 0.3839 | 0.3769 | 3906 | 87.4 |
| 27 | 0.3511 | 0.3368 | 4691 | 79.4 |
| 32 | 0.3278 | 0.3081 | 5753 | 71.5 |
| 40 | 0.2988 | 0.2725 | 8762 | 58.4 |

It can be seen that the color point moves along a line all, but not fully following the BBL. In order to be able to (better) stay on (or close to) the BBL it is herein suggest using several tracks where different phosphor compositions, with the reflector in between, is used so that the color point is on the BBL. In order to changes in CCT slightly one can move the focal point slightly around a chosen point which is on the BBL. When it is necessary to go to another CCT then the laser spot needs to move to another track combination. Here again it is possible to slightly change the CCT by staying moving the spot slightly up and down. The table below give some data, wherein the color points are given when the focus of the laser beam would go from a first track 1 with a first phosphor composition to a fourth track with a fourth phosphor composition, wherein the arrangement is first phosphor composition/reflector/second phosphor composition/third phosphor composition/reflector/fourth phosphor composition.

| Blue power (%) | x | y | CCT | CRI |
|---|---|---|---|---|
| 10 | 0.4449 | 0.4067 | 2890 | 93.7 |
| 19 | 0.3839 | 0.3769 | 3906 | 87.4 |
| 25 | 0.3524 | 0.3581 | 4753 | 81.8 |
| 39 | 0.2962 | 0.3036 | 7950 | 71.1 |

It can be seen that in this way the color points can essentially be on the BBL.

Most of the drawings show embodiments wherein the diffusor (indicated as reflector 2510) and the luminescent material(s) are configured in the reflective mode. However, in alternative embodiments the reflector and/or the luminescent material(s) may be operated in the transmissive mode.

Referring to FIGS. 2a-2b, a single type of light generating device, in combination with a polarization control element 610 may be applied to control the spectral power distribution of the system light. Here below, an example is given:

| | Fraction of | | | | |
|---|---|---|---|---|---|
| | blue power to | Ts | Rs | Tp | Rp |
| | diffuser for | (transmittance | (reflectance | (transmittance | (reflectance |
| | requested | of s-pol blue | of s-pol blue | of p-pol blue | of p-pol blue |
| Case | tuning range | light) | light) | light) | light) |
| A | 15-30% | ≤10% | ≥90% | ≥30% | ≤70% |

Referring to FIGS. 6a-6f, different types of light generating devices are combined via a PBS and/or DBS, optionally in combination with a polarization control element 610, to control the spectral power distribution of the system light. Here below, some examples are given:

| | Fraction of | | | | |
|---|---|---|---|---|---|
| | blue power to | Ts | Rs | Tp | Rp |
| | diffuser for | (transmittance | (reflectance | (transmittance | (reflectance |
| | requested | of s-pol blue | of s-pol blue | of p-pol blue | of p-pol blue |
| Case | tuning range | light) | light) | light) | light) |
| B | 15-30% | ≤10% | ≥90% | ≥60% | ≤40% |
| D (e.g. | 15-30% | ≤10% | ≥90% | ≥30% | ≤70% |
| FIG. 6b) | | | | | |

Example B is essentially the same as example D, but then the polarization rotator is configured upstream of the dichroic beam splitter (whereas in FIG. 6B the polarization control element 610 is configured downstream of the dichroic beam splitter 515.

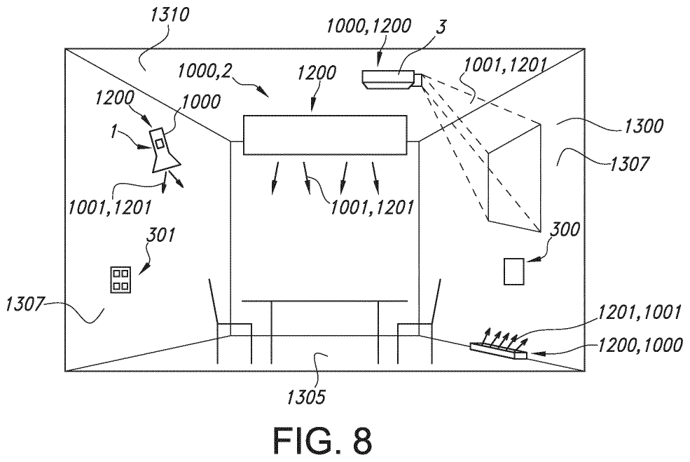

FIG. 8 schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 8 also schematically depicts an embodiment of lamp 1 comprising the light generating system 1000. Reference 3 indicates a projector device or projector system, which may be used to project images, such as at a wall, which may also comprise the light generating system 1000. Hence, FIG. 8 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1200 is indicated with reference 1201. Lighting device light 1201 may essentially consist of system light 1001, and may in specific embodiments thus be system light 1001. Reference 1300 refers to a space, such as a room. Reference 1305 refers to a floor and reference 1310 to a ceiling; reference 1307 refers to a wall.

The term “plurality” refers to two or more. The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. The term “comprise” also includes embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) may provide a software product, which, when running on a computer is capable of bringing about (one or more embodiments of) the method as described herein.

The invention also may provide a control system that may control the device, apparatus, or system, or that may execute the herein described method or process. Yet further, the invention also may provide a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising (i) one or more light generating devices, (ii) a first luminescent material, (iii) a reflector, (iv) a rotatable element, (v) a control system and (vi) central optics; wherein:
the one or more light generating devices are configured to generate device light; wherein the one or more light generating devices comprise one or more of a laser diode and a superluminescent diode;
the first luminescent material is configured to convert at least part of the device light received by the first luminescent material into first luminescent material light; the reflector is configured to reflect at least part of the device light received by the reflector into reflected device light;
the rotatable element comprises a first ring-shaped section, and a second a ring-shaped section; the first luminescent material is comprised by at least part of the first ring-shaped section; and the reflector is comprised by at least part of the second ring-shaped section;
the light generating system is configured such that (a) in an operational mode of the light generating system the rotatable element rotates, such that over time different parts of the first ring-shaped section and/or different parts of the second ring-shaped section are irradiated by the device light, and (b) a distribution of the device light over the first ring-shaped section and the second ring-shaped section is optically controllable; and wherein the light generating system is configured to generate system light comprising one or more of the first luminescent material light and the reflected device light;
the control system is configured to control a spectral power distribution of the system light by optically controlling the distribution of the device light over the first ring-shaped section and the second ring-shaped section;
the one or more light generating devices are configured to generate polarized device light having a controllable polarization;
the central optics comprises (i) a central optics polarizing beam splitter, and (ii) a central optics dichroic beam splitter; wherein:
the central optics polarizing beam splitter is configured to transmit and/or reflect at least part of the device light in dependence of its polarization;
the central optics dichroic beam splitter is configured to transmit and/or reflect at least part of the device light, at least part of the first luminescent material light, in dependence of their spectral power distributions;
the light generating system is configured such that (a) at least part of the device light, when having a first polarization, propagates from the one or more light generating devices via the central optics to the first ring-shaped section to provide the first luminescent material light, (b) at least part of the device light, when having a second polarization, different from the first polarization, propagates from the one or more light generating devices via the central optics to the second ring-shaped section to provide the reflected device light, and (c) at least part of the first luminescent material light generated by the first luminescent material and at least part of the reflected device light generated at the reflector, escape from the light generating system via the central optics;
the control system is configured to control the polarization of the device light; and
the light generating system is configured to generate system light comprising one or more of (i) the first luminescent material light and (ii) the reflected device light.

2. The light generating system according to claim 1, wherein the rotatable element comprises a disc-like shape or a cylindrical shape; and wherein the first ring-shaped section has a first width, wherein the second ring-shaped section has a second width, and wherein the first ring-shaped section and the second ring-shaped section have a mutual distance, wherein d3/d1≤0.5, and wherein d3/d2≤0.5, and wherein d3 is at minimum 0.5 mm.

3. The light generating system according to claim 1, wherein the control system is configured to control a correlated color temperature of the system light by controlling a relative intensity of the device light on the first ring-shaped section and on the second ring-shaped section.

4. The light generating system according to claim 1, wherein one or more of the following applies:
the light generating system comprises at least two different first luminescent materials, configured at different parts of the first ring-shaped section, wherein the at least two different first luminescent materials are configured to convert at least part of the device light received by the first luminescent material into first luminescent material light, wherein the first luminescent material light of the at least two different first luminescent materials have different spectral power distributions; and
the light generating system comprises a second luminescent material, wherein the second luminescent material and the reflector are configured in different parts of the second ring-shaped section; wherein the device light has a device light centroid wavelength λ_{cd}, the first luminescent material light has a first luminescent material light centroid wavelength λ_{c1}, and the second luminescent material light has a second luminescent material light centroid wavelength λ_{c2}, wherein (λ_{cd}+10 nm)≤λ_{c2}≤(λ_{c1}−10 nm); wherein device light centroid wavelength λ_{cd} is selected from the wavelength range of 400-480 nm, the first luminescent material light centroid wavelength λ_{c1} is selected from the wavelength range of 490-780 nm, the second luminescent material light centroid wavelength λ_{c2} is selected from the wavelength range of 450-520 nm.

5. The light generating system according to claim 4, wherein:
the central optics dichroic beam splitter is further configured to transmit and/or reflect at least part of the second luminescent material light, in dependence of its spectral power distribution;
the light generating system is configured such that at least part of the device light, when having a second polarization, different from the first polarization, propagates from the one or more light generating devices via the central optics to the second ring-shaped section to provide the reflected device light and second luminescent material light, and at least part of the second luminescent material light generated by the second luminescent material, escapes from the light generating system via the central optics; and
the light generating system is configured to generate system light comprising the second luminescent material light.

6. The light generating system according to claim 1, wherein the central optics is configured such that: (a) first light having a wavelength in a first wavelength range comprising the first polarization is reflected or transmitted; (b) second light having a second wavelength in the first wavelength range and comprising a second polarization is transmitted or reflected; (c) third light having a third wavelength in a second wavelength range is transmitted or reflected, like one of the first light and the second light, irrespective whether the third light comprises the first polarization or the second polarization; and wherein the central optics is configured to transmit at least part of the first luminescent material light.

7. The light generating system according to claim 6, wherein the reflector is configured to diffuse at least part of the device light received by the reflector thereby providing the diffused reflected device light while maintaining at least part of the polarization of the device light.

8. The light generating system according to claim 7, wherein the light generating system further comprises a polarization changing element configured in an optical path of the device light between the central optics and the reflector; wherein the polarization changing element comprises one or more of a λ/4 waveplate and a Faraday rotator.

9. The light generating system according to claim 7, wherein the light generating system further comprises a polarization control element, wherein the polarization control element is configured to control the polarization of the device light received by the polarization control element; and wherein the control system is configured to control the polarization control element; wherein the polarization control element is configured between at least one of the light generating devices and the central optics.

10. The light generating system according to claim 5, wherein the one or more light generating devices comprise two different types of light generating devices, differing in the type of polarization of the device light they generate; wherein the light generating system further comprises a first polarizing beam splitter, wherein the first polarizing beam splitter is configured downstream of the two different types of light generating devices and upstream of the central optics; and wherein the first polarizing beam splitter is configured to transmit s-polarized light or p-polarized light, and to reflect p-polarized light or s-polarized light; and wherein the control system, is configured to control the two different types of light generating devices.

11. The light generating system according to claim 5, wherein the one or more light generating devices comprise two different types of light generating devices, differing in a spectral power distribution of the device light they generate; wherein the light generating system further comprises a first dichroic beam splitter, wherein the first dichroic beam splitter is configured downstream of the two different types of light generating devices and upstream of the central optics; wherein the first dichroic beam splitter is configured (a) to transmit or reflect at least part of the device light of a first type, and (b) to reflect or transmit at least part of the device light of a second type; wherein the control system is configured to control the two different types of light generating devices.

12. The light generating system according to claim 5, wherein the central optics polarizing beam splitter is configured to (a) reflect at least 90% device light when having a first polarization, (b) reflect selected from the range of 20-80% device light when having a second polarization, and (c) transmit selected from the range of 80-20% device light when having the second polarization.

13. The light generating system according to claim 1, wherein the control system is configured to control one or more of color rendering index and correlated color temperature of the system light; wherein in a controlling mode of the light generating system the system light has one or more of a color rendering index of at least 80, and a correlated color temperature selected from the range of 3000-8500 K.

14. The light generating system according to claim 1, wherein the first luminescent material at least comprises a luminescent material of the type A₃B₅O₁₂:Ce, wherein A comprises one or more of Y, La, Gd, Tb and Lu, and wherein B comprises one or more of Al, Ga, In and Sc; the optional second luminescent material, at least comprises one or more of Na_{0.5}K_{0.5}Li₃SiO₄:Eu²⁺, MSi₂O₂N₂:Eu²⁺, wherein M comprises one or more of Ba, Sr, and Ca, Sr[Be₆ON₄]:Eu²⁺, and MAl₂O₄:Eu²⁺, wherein M comprises one or more of Ba, Sr, and Ca.

15. A lighting device selected from the group of a lamp, a luminaire, a projector device, a disinfection device, a photochemical reactor, an automotive lighting device, and an optical wireless communication device, comprising the light generating system according to claim 1.
